(19) United States
(12) Patent Application Publication
(10) Pub. No.: US 2015/0360156 A1
(43) Pub. Date: Dec. 17, 2015

(54) FILTER MEDIA AND ELEMENTS WITH FINE STAPLE FIBERS

(71) Applicant: Hollingsworth & Vose Company, East Walpole, MA (US)

(72) Inventor: Sneha Swaminathan, Merrimack, NH (US)

(73) Assignee: Hollingsworth & Vose Company, East Walpole, MA (US)

(21) Appl. No.: 14/744,857

(22) Filed: Jun. 19, 2015

Related U.S. Application Data
(63) Continuation-in-part of application No. 14/137,152, filed on Dec. 20, 2013.

(51) Int. Cl. B01D 39/14; B01D 39/20; B01D 35/00; B01D 39/16

(52) U.S. Cl. CPC B01D 39/14; B01D 39/163; B01D 39/2024; B01D 35/005

(57) ABSTRACT

Filter media, including those suitable for fuel and/or hydraulic applications, and related components, systems, and methods associated therewith are provided. In some embodiments, a filter media may include a non-woven layer comprising blend of glass fibers and polymeric staple fibers. The polymeric staple fibers may have a relatively small diameter. The non-woven layer comprising the fiber may have desirable properties such as one or more of a low micron rating for beta efficiency, high dust holding capacity, and/or a low resistance to fluid flow. In certain embodiments, the filter media may include two or more layers, at least one of the layers including a non-woven layer comprising the fiber blend. In some such cases, the filter media may include one or more layers that serve to enhance the overall properties of the filter media.

### CROSS REFERENCE TO RELATED APPLICATIONS

The present application is a continuation-in-part of U.S. patent application Ser. No. 14/137,152, filed on Dec. 20, 2013 and entitled “Filter Media With Fine Staple Fibers”, which is hereby incorporated by reference in its entirety for all purposes.

### FIELD OF INVENTION

The present invention relates generally to filter media which may be used in a variety of applications, including fuel and/or hydraulic applications, and, more particularly, to multilayered filter media which have desirable performance characteristics.

### BACKGROUND

Filter media can be used to remove contamination in a variety of applications. Depending on the application, the filter media may be designed to have different performance characteristics. For example, filter media may be designed to have performance characteristics suitable for fuel and/or hydraulic applications which involve filtering contamination in pressurized fluids.

In general, filter media can be formed of a web of fibers. For example, the web may include microglass fibers amongst other components. The fiber web provides a porous structure that permits fluid (e.g., fuel, hydraulic fluid) to flow through the filter media. Contaminant particles contained within the fluid may be trapped on the fibrous web. Filter media characteristics, such as fiber diameter and basis weight, affect filter performance including filter efficiency, dust holding capacity (i.e., dirt holding capacity) and resistance to fluid flow through the filter.

There is a need for filter media that can be used in a variety of applications, including fuel and/or hydraulic applications, which has a desirable balance of properties including a high dust holding capacity and a low resistance to fluid flow (high permeability) across the filter media.

### SUMMARY OF THE INVENTION

Filter media, including those suitable for fuel, hydraulic, and/or other applications, and related components, systems, and methods associated therewith are provided.

In one set of embodiments, a series of filter media are provided. In one embodiment, a filter media comprises a first layer and second layer. The second layer comprises glass fibers and polymeric staple fibers, wherein the polymeric staple fibers have an average fiber diameter of less than or equal to about 10 microns. The glass fibers are present in the second layer in an amount of at least about 0.5 wt % to about 99.5 wt % of the fibers in the second layer. The polymeric staple fibers are present in the second layer in an amount of at least about 0.5 wt % to about 99.5 wt % of the fibers in the second layer. The first layer has a mean flow pore size greater than a mean flow pore size of the second layer. The filter media also includes a third layer having a mean flow pore size that is less than a mean flow pore size of the second layer.

In another embodiment, a filter media comprises a non-woven layer comprising a blend of glass fibers and polymeric staple fibers, wherein the polymeric staple fibers have an average fiber diameter of less than or equal to about 6 microns. The filter media also includes a layer having a mean flow pore size that is less than a mean flow pore size of the non-woven layer.

In another embodiment, a filter media comprises a non-woven layer comprising a blend of glass fibers and polymeric staple fibers, wherein the polymeric staple fibers have an average fiber diameter of less than or equal to about 10 microns, and wherein the polymeric staple fibers are present in an amount of greater than or equal to about 10 wt % of the fibers in the non-woven layer. The filter media also includes a layer having a mean flow pore size that is less than a mean flow pore size of the non-woven layer.

In one set of embodiments, methods are provided. A method of filtering a liquid comprising passing a liquid including particulates through a filter media. The filter media can include one of the filter media described above and/or herein.

In other embodiments, a filter element including one of the filter media described above and/or herein is provided.

Other aspects, embodiments, advantages and features of the invention will become apparent from the following detailed description.

### BRIEF DESCRIPTION OF THE DRAWINGS

Non-limiting embodiments of the present invention will be described by way of example with reference to the accompanying figures, which are schematic and are not intended to be drawn to scale. In the figures, each identical or nearly identical component illustrated is typically represented by a single numeral. For purposes of clarity, not every component is labeled in every figure, nor is every component of each embodiment of the invention shown where illustration is not necessary to allow those of ordinary skill in the art to understand the invention. In the figures:

FIG. 1 shows an example of a filter media having multiple layers according to one set of embodiments; and

FIG. 2 shows an example of a filter media having multiple layers according to one set of embodiments.

### DETAILED DESCRIPTION

Filter media, including those suitable for fuel and/or hydraulic applications, and related components, systems, and methods associated therewith are provided. In some embodiments, a filter media described herein may include a layer (e.g., a non-woven layer) comprising a blend of glass fibers and polymeric staple fibers. The polymeric staple fibers may have a relatively small diameter (e.g., less than or equal to about 10 microns). In some embodiments, the layer comprising the fiber blend may have desirable properties including one or more of a high dust holding capacity, a high efficiency, e.g., a low micron rating for beta efficiency, and/or a low resistance to fluid flow. In certain embodiments, the filter media may include two or more layers, at least one of the layers comprising a blend of glass fibers and polymeric staple fibers. In some such cases, the filter media may include one or more layers (e.g., a pre-filter layer, third layer) that serve to enhance the overall properties of the filter media (e.g., dust holding capacity, mechanical properties).

In certain embodiments, the filter media may include at least one layer having a relatively high percentage of glass (e.g., microglass) fibers. The layer having a relatively high percentage of glass fibers may be part of a multi-layer media, such a dual-layer pre-filter or a main filter layer, in some embodiments. In certain embodiments, at least one layer (e.g., pre-filter layer, main filter layer) comprises a fiber (e.g., glass fibers) that has the potential to migrate or dislodge from the layer during filtration. In some such embodiments, the filter media may comprise a layer that has a relatively small mean flow pore size downstream of the layer(s) comprising a fiber that has the potential to migrate or dislodge during filtration. The downstream layer may reduce and/or inhibit a fiber (e.g., glass fiber) from migrating downstream of the layer during filtration. In certain embodiments, a downstream layer may have a lower mean flow pore size and/or a higher efficiency than the mean flow pore size and/or efficiency, respectively, of the one or more upstream layers (e.g., first layer, second layer) comprising a fiber that has the potential to migrate during filtration. Filter media and arrangements that comprise such a downstream layer may be advantageous for certain applications, such as fuel applications (e.g., fuel-water separation, particulate separation in fuel systems). For example, the downstream layer may reduce or prevent the migration of glass fibers that may otherwise lead to the blockage and/or corrosion of certain fuel filter elements (e.g., fuel injectors). Other applications of such filter media are also possible.

In other embodiments, a multi-layer media may include a layer having a relatively low percentage of glass fibers, and instead may include a relatively high percentage of polymeric fibers (e.g., synthetic polymer fibers).

Certain filter media described herein may have desirable properties including high dust holding capacity, high efficiency (e.g., a low micron rating for beta efficiency), and low resistance to fluid flow. The media may be incorporated into a variety of filter element products including fuel and/or hydraulic filters.

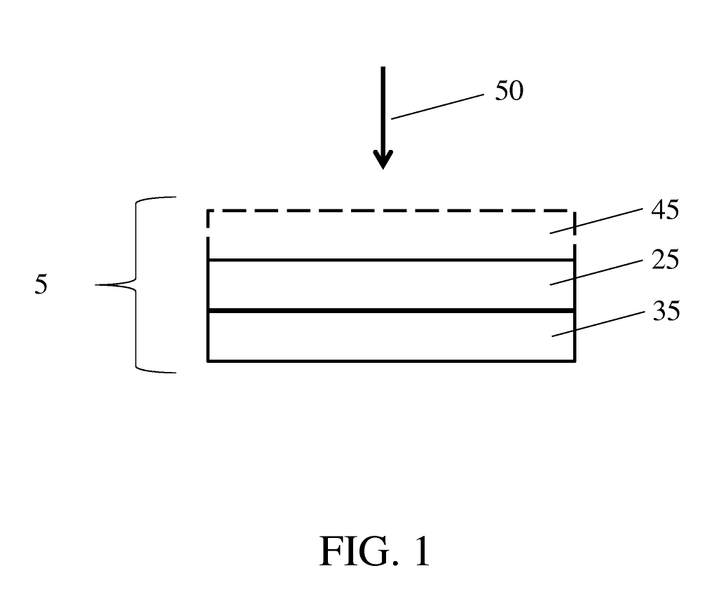

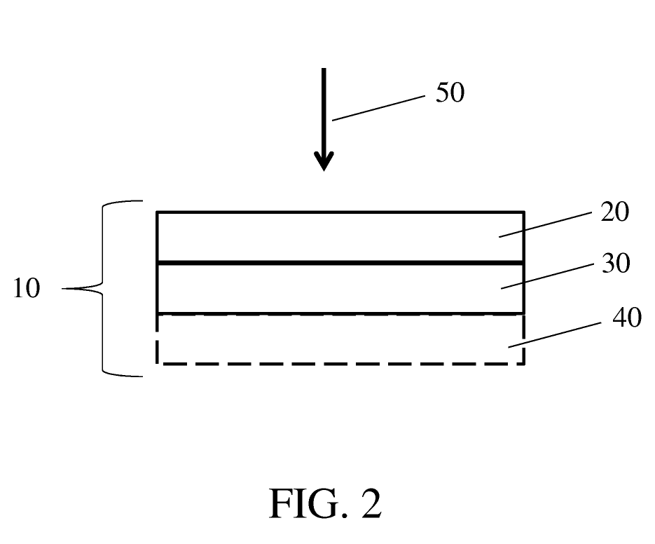

Non-limiting examples of filter media described herein are shown illustratively in FIGS. 1 and 2. As shown in the embodiment illustrated in FIG. 1, a filter media 5 includes a first layer 25 adjacent a second layer 35. Optionally, filter media 5 can include a third layer 45 adjacent the first layer. In some embodiments, as illustrated in FIG. 2, a filter media 10 includes a first layer 20 adjacent a second layer 30 and optionally, a third layer 40 adjacent the second layer. Additional layers, e.g., fourth, fifth, or sixth layers (e.g., up to 10 layers), may also be included in some cases. The orientation of filter media 5 or 10 relative to fluid flow through the media can generally be selected as desired. As shown illustratively in FIGS. 1 and 2, the first layer is upstream of the second layer in the direction of fluid flow indicated by arrow 50. In other embodiments, however, the first layer is downstream of the second layer in the direction of fluid flow through the filter media.

As used herein, when a layer is referred to as being “adjacent” another layer, it can be directly adjacent the layer, or an intervening layer also may be present. A layer that is “directly adjacent” or “in contact with” another layer means that no intervening layer is present.

In some cases, each of the layers of the filter media has different characteristics and filtration properties that, when combined, result in desirable overall filtration performance, for example, as compared to a filter media having a single-layer structure. For example, in one set of embodiments, the first layer (e.g., layer 20, layer 25) is a pre-filter layer (also known as a “loading layer”) and the second layer (e.g., layer 30, layer 35) is a main filter layer (also known as an “efficiency layer”). Generally, a pre-filter layer is formed using coarser fibers, and therefore has a lower resistance to fluid flow, than that of a main filter layer. The one or more main filter layers may include finer fibers (e.g., small diameter polymeric staple fibers, glass fibers) and may have a higher resistance to fluid flow and/or a smaller mean flow pore size than that of a pre-filter layer. As such, a main filter layer can generally trap particles of smaller size compared to the pre-filter layer. In one example, filter media 5 of FIG. 1 includes one or more pre-filter layers (e.g., layers 25 and/or 45) and a main filter layer (e.g., layer 35) comprising a blend of glass fibers and polymeric staple fibers having a relatively small diameter (e.g., less than or equal to about 10 microns, less than or equal to about 6 microns, or less than or equal to about 1 micron). The main filter layer may be formed of fibers having a smaller average fiber diameter than that of the one or more pre-filter layers.

In another example, filter media 10 of FIG. 2 includes one or more pre-filter layers (e.g., layer 20) and a main filter layer (e.g., layer 30) comprising glass fibers. The main filter layer may comprise or be formed of fibers (e.g., glass fibers) having a smaller average fiber diameter than the average fiber diameter of the one or more pre-filter layers. In some embodiments, a filter media having a one or more layers including glass fibers (e.g., pre-filter layer, main filter layer) may include an additional, downstream layer, such as third layer 40 in FIG. 2, that catches any glass fibers dislodged from the glass-containing layer(s). In some embodiments, third layer 40 may have one or more properties that differ from second layer 30 (e.g., main filter layer) and/or the pre-filter layer(s). For instance, the third layer may have a lower mean flow pore size and/or a higher efficiency than the main filter layer. In some such cases, the third layer may serve to reduce or eliminate the migration of any fibers (e.g., glass fibers) during filtration, such as fibers from an upstream layer (e.g., layer 30 (a main filter layer), layer 20 (a pre-filter layer)) and/or to improve the efficiency of the filter media. In some cases, the third layer may act as a structural support for the filter media by adding strength and/or pleatability to the media. Other functions of the third layer are also possible as described herein.

In some instances, the mean flow pore size of third layer 40 may be smaller than the mean flow pore size of layer 30. As described herein, the relatively small mean flow pore size of the third layer may aid in inhibiting fiber migration downstream of the third layer during filtration, in some cases. In some embodiments, the third layer may have a higher efficiency than efficiency of the main filter layer or the pre-filter layer(s).

In some embodiments, the third layer may have a different wettability than the wettability of a second layer (e.g., main filter layer) and/or a first layer (e.g., pre-filter layer(s)). For instance, in some embodiments, the second layer (e.g., main filter layer) may have a greater hydrophobicity (e.g., larger contact angle) than that of the third layer. In some such embodiments, the second layer (e.g., main filter layer) may be hydrophobic and the third layer may be hydrophilic. In other embodiments, the wettability of the second layer (e.g., main filter layer) and the third layer may be similar. In certain cases, the third layer may have a greater hydrophobicity than the second layer (e.g., main filter layer). In some embodiments, the difference in wettability between layers 30 and 40 may enhance the fluid separation efficiency of the filter media.

In certain embodiments, layer 30 and 40 may be directly adjacent to one another as shown illustratively in FIG. 2. In other embodiments, an intervening layer may be positioned between layers 30 and 40. In some embodiments, filter media 10 may comprise one or more optional layers positioned upstream and/or downstream of layers 20, 30 and/or 40. The one or more optional layers may be any suitable layer. For instance, in some embodiments, one or more optional layers may be layer 25 in FIG. 1, a spacer layer, a scrim, mesh, a substrate layer, an efficiency layer, a drainage layer, and/or a capacity layer.

In other embodiments, where a third layer is present, e.g., as illustrated in FIG. 1, the third layer may be an additional pre-filter layer that has the same or different properties as first layer 25. For example, the third layer may have even coarser fibers and a lower resistance to fluid flow than that of first layer 25. In certain embodiments, where third layer 40 is present as illustrated in FIG. 2, the third layer may be an additional main filter layer that has the same or different properties as second layer 30. For example, the third layer may have even finer fibers and a higher resistance to fluid flow than that of second layer 30. In some embodiments, the third layer comprises a blend of glass fibers and synthetic polymer fibers as described in more detail below.

The filter media can also have other configurations of first, second, and optionally third or more layers. For instance, in some cases filter media 10 or 5 does not include a pre-filter layer. In some such embodiments, the first layer (e.g., layer 20, layer 25) is an upstream main filter layer and second layer (e.g., layer 30, layer 35) is a downstream layer having a relatively small mean flow pore size compared to the first layer. Optionally, the filter media can include a third layer 40 positioned downstream of the second layer or a third layer 45 (e.g., another main filter layer) positioned upstream of the first layer. In some embodiments, an upstream layer may have coarser fibers, and therefore a lower resistance to fluid flow, than that of a layer downstream of that layer. In some cases, the resistance of each layer increases successively from the furthest upstream layer to the furthest downstream layer.

In some embodiments, a layer having relatively coarse fibers may be positioned between two layers having relatively finer fibers. Other configurations are also possible. Additionally, a filter media may include any suitable number of layers, e.g., at least 2, 3, 4, 5, 6, 7, 8, or 9 layers (e.g., up to 10 layers), depending on the particular application and performance characteristics desired. For instance, in some cases, a filter media may have two or more pre-filter layers (e.g., first layers, second layers). In certain embodiments, a filter media may have two or more main filter layers (e.g., first layers, second layers). In some instances, a filter media may have two or more third layers. Combinations of more than two pre-filter layers (e.g., first layers, second layers), two or more main filter layers (e.g., first layers, second layers), and/or two or more third layers are also possible.

As noted above, each of the layers of the filter media can have different properties. For instance, the first and second layers can include fibers having different characteristics (e.g., fiber diameters, fiber compositions, and/or fiber lengths). Fibers with different characteristics can be made from one material (e.g., by using different process conditions) or different materials (e.g., glass fibers, synthetic fibers (e.g., organic polymer fibers), and combinations thereof). Without wishing to be bound by theory, it is believed that a filter media having a multilayered structure with layers including different characteristics exhibits significantly improved performance properties such as fuel water separation, dirt holding capacity and/or efficiency compared to a filter media having a single-layered structure.

In some embodiments, a filter media described herein may comprise a pre-filter including one or more layers (e.g., a first layer and/or a third layer) and a main filtration layer (e.g., a second layer) comprising glass fibers and polymeric staple fibers. The main filtration layer and/or pre-filter layer(s) may optionally be formed on a scrim or supporting layer. The filter media may be arranged such that the main filtration layer (e.g., second layer) is positioned downstream of the one or more pre-filter layers. The one or more pre-filter layers may be wet-laid layer(s) (e.g., a layer formed by a wet laid process) or non-wet laid layer(s) (e.g., it may include meltblown fibers, meltspun fibers, centrifugal spun fibers, air-laid fibers, dry-laid fibers, or fibers formed by other non-wet laid processes). For instance, a pre-filter layer may comprise a layer of continuous fibers (e.g., meltblown fibers, meltspun fibers, centrifugal spun fibers). In some instances, the layer of continuous fibers may be manufactured and adhered to another layer (e.g., a scrim, a multi-layered filter media, a single phase layer, a multiphase layer) in any appropriate manner. A layer including continuous fibers may be positioned downstream or upstream with respect to the layer on which it is adhered.

In other embodiments, the pre-filter may comprise one or more (e.g., two) layers comprising glass fibers (e.g., at least about 80 wt % glass fibers). In some such embodiments, the main filtration layer may comprise one or more polymeric staple fibers having an average diameter of less than or equal to about 10 microns (e.g., less than or equal to about 6 microns, less than or equal to about 4 microns, less than or equal to about 3 microns, less than or equal to about 1 micron) and glass fibers having an average diameter of, for example, less or equal to about 11 microns. Other ranges of possible fiber diameters are provided herein. Other types of fibers can also be included in place of or in addition to the polymeric staple fibers and/or glass fibers.

In some embodiments, the main filtration layer (e.g., second layer) may comprise a significant amount of polymeric staple fibers. For instance, the polymeric staple fibers may be present in an amount of greater than or equal to about 10 wt % of the fibers in the main filtration layer (e.g., second layer). It should be appreciated, however, that other values are also possible. For instance, the polymeric staple fibers may be present in the main filtration layer (e.g., second layer) in an amount of at least about 0.5 wt % to about 99.5 wt % of the fibers in the main filtration layer. In some such embodiments, the glass fibers may be present in the main filtration layer in an amount of at least about 0.5 wt % to about 99.5 wt % of the fibers in the main filtration layer.

In some embodiments in which the filter media comprises a pre-filter including one or more layers and a main filtration layer comprising a blend of glass fibers and polymeric staple fibers, the filter media may have beneficial properties. For instance, the filter media may have a relatively high dust holding capacity (e.g., between about 5 gsm and about 300 gsm) for a given basis weight, a relatively low micron rating for beta 200 efficiency (e.g., less than or equal to about 30 microns, less than or equal to about 15 microns, less than or equal to about 10 microns, less than or equal to about 8 microns), a relatively low pressure drop (e.g., less than or equal to about 4.5 kPa), and/or a mean flow pore size between about 0.1 microns and about 10 microns. In some such cases, the mean flow pore size of the one or more pre-filter layers may greater than the mean flow pore size of the main filtration layer.

As described herein, a filter media (e.g., filter media 10) may comprise a third layer (e.g., third layer 40). In some embodiments, the third layer may reduce or prevent the migration of fibers from an upstream layer (e.g., glass fibers in one or more upstream layers) to a position downstream of that layer. In some such embodiments, the third layer may have a relatively low mean flow pore size, and yet may have a relatively low pressure drop.

In some instances, the third layer may have a mean flow pore size of less than or equal to about 200 microns, less than or equal to about 175 microns, less than or equal to about 150 microns, less than or equal to about 125 microns, less than or equal to about 100 microns, less than or equal to about 75 microns, less than or equal to about 50 microns, less than or equal to about 25 microns, less than or equal to about 10 microns or less than or equal to about 1 micron. In some embodiments, the third layer may have a mean flow pore size of greater than or equal to about 0.05 microns, greater than or equal to about 0.1 microns, greater than or equal to about 0.15 microns, greater than or equal to about 0.2 microns, greater than or equal to about 0.5 microns, greater than or equal to about 1 micron, greater than or equal to about 10 microns, greater than or equal to about 25 microns, greater than or equal to about 50 microns greater than or equal to about 75 microns, greater than or equal to about 100 microns, greater than or equal to about 125 microns, greater than or equal to about 150 microns, or greater than or equal to about 175 microns. Combinations of the above-referenced ranges are also possible (e.g., greater than or equal to about 0.05 microns and less than or equal to about 150 microns, greater than or equal to about 0.1 microns and less than or equal to about 150 microns). Other values of mean flow pore size are also possible. The mean flow pore size may be determined according to the standard ASTM F316 (2003).

In some embodiments, the mean flow pore size of a layer (e.g., a second layer or a first layer) may be at least 1% greater, at least 2% greater, at least 5% greater, at least 10% greater, at least 15% greater, at least 20% greater, at least 25% greater, at least 30% greater, at least 35% greater, at least 40% greater, at least 50% greater, at least 55% greater, at least 60% greater, at least 70% greater, at least 80% greater, or at least 90% greater than a mean flow pore size of the third layer. In some instances, the mean flow pore size of a layer (e.g., a second layer or a first layer) may be less than or equal to 100% greater, less than or equal to 90% greater, less than or equal to 80% greater, less than or equal to 70% greater, less than or equal to 60% greater, less than or equal to 50% greater, less than or equal to 40% greater, less than or equal to 30% greater, less than or equal to 20% greater, or less than or equal to 10% greater than a mean flow pore size of the third layer. Combinations of the above-referenced ranges are also possible (e.g., a mean flow pore size of at least 1% greater and less than or equal to 50% greater than a mean flow pore size of the third layer). Other ranges are also possible.

In some embodiments, the pressure drop across the third layer (e.g., third layer 45, third layer 40) may be relatively low. For instance, in some embodiments, the pressure drop across the third layer may less than or equal to about 80 kPa, less than or equal to about 70 kPa, less than or equal to about 60 kPa, less than or equal to about 50 kPa, less than or equal to about 40 kPa, less than or equal to about 30 kPa, less than or equal to about 20 kPa, less than or equal to about 10 kPa, less than or equal to about 5 kPa, less than or equal to about 1 kPa, or less than or equal to about 0.5 kPa. In some instances, the third layer may have a pressure drop of greater than or equal to about 0.01 kPa, greater than or equal to about 0.02 kPa, greater than or equal to about 0.05 kPa, greater than or equal to about 0.1 kPa, greater than or equal to about 0.5 kPa, greater than or equal to 1 kPa, greater than or equal to about 5 kPa, greater than or equal to about 10 kPa, greater than or equal to about 20 kPa, greater than or equal to about 30 kPa, greater than or equal to about 40 kPa, greater than or equal to about 50 kPa, greater than or equal to about 60 kPa, or greater than or equal to about 70 kPa. Combinations of the above-referenced ranges are also possible (e.g., greater than or equal to about 0.05 kPa and less than or equal to about 80 kPa, greater than or equal to about 0.1 kPa and less than or equal to about 50 kPa). Other values of pressure drop are also possible. Pressure drop, as used herein, can be measured using the ISO 3968 (2001) protocol. The pressure drop value can be measured when clean hydraulic fluid at 15 cSt with a face velocity of 0.67 cm/s is passed through the flatsheet filter media.

In some embodiments, the third layer may be relatively thin. In some embodiments, the thickness of the third layer may be less than or equal to about 1 mm, less than or equal to about 0.9 mm, less than about 0.8 mm, less than or equal to about 0.7 mm, less than or equal to about 0.6 mm, less than or equal to about 0.5 mm, less than or equal to about 0.4 mm, less than or equal to about 0.3 mm, less than or equal to about 0.2 mm, less than or equal to about 0.1 mm, less than or equal to about 0.09 mm, or less than or equal to about 0.08 mm. In some instances, the thickness of the third layer may be greater than or equal to about 0.03 mm, greater than or equal to about 0.04 mm, greater than or equal to about 0.05 mm, greater than or equal to about 0.06 mm, greater than or equal to about 0.07 mm, greater than or equal to about 0.08 mm, greater than or equal to about 0.09 mm, greater than or equal to about 0.1 mm, greater than or equal to about 0.2 mm, greater than or equal to about 0.3 mm, greater than or equal to about 0.4 mm, greater than or equal to about 0.5 mm, or greater than equal to 0.6 mm. Combinations of the above-referenced ranges are possible (e.g., greater than or equal to about 0.03 mm and less than or equal to about 1 mm, greater than or equal to about 0.05 mm and less than or equal to about 1 mm). Other values of thickness of the third layer are possible. The thickness may be determined according to the standard TAPPI T411.

In some embodiments, the third layer may have a relatively low basis weight. For instance, in some instances, the third layer may have a basis weight of less than or equal to about 200 g/m², less than or equal to about 180 g/m², less than or equal to about 160 g/m², less than or equal to about 140 g/m², less than or equal to about 120 g/m², less than or equal to about 100 g/m², less than or equal to about 90 g/m², less than or equal to about 80 g/m², less than or equal to about 70 g/m², less than or equal to about 60 g/m², less than or equal to about 50 g/m², less than or equal to about 40 g/m², less than or equal to about 30 g/m², or less than or equal to about 20 g/m². In some embodiments, the third layer may have a basis weight of greater than or equal to about 5 g/m², greater than or equal to about 10 g/m², greater than or equal to about 20 g/m², greater than or equal to about 30 g/m², greater than or equal to about 40 g/m², greater than or equal to about 50 g/m², greater than or equal to about 60 g/m², greater than or equal to about 70 g/m², greater than or equal to about 80 g/m², greater than or equal to about 90 g/m², greater than or equal to about 100 g/m², greater than or equal to about 120 g/m², greater than or equal to about 140 g/m², greater than or equal to about 160 g/m², or greater than or equal to about 180 g/m². Combinations of the above-referenced ranges are possible (e.g., greater than or equal to about 5 g/m² and less than or equal to about 200 g/m², greater than or equal to about 5 g/m² and less than or equal to about 100 g/m²). Other values of basis weight are possible. The basis weight may be determined according to the standard TAPPI T410.

In some embodiments, the third layer may also serve to enhance the structural stability of the filter media. For instance, the third layer may have certain enhanced mechanical properties, such as tensile strength and Mullen burst strength. In some such embodiments, the third layer may be relatively strong and may facilitate pleating or corrugation of the filter media. For instance, the third layer may provide sufficient stiffness such that the filter media can be pleated to include sharp, well-defined peaks which can be maintained in a stable configuration during use. In some instances, the third layer may reduce or prevent the shedding of certain fibers (e.g., glass fibers) during processing of the filter media (e.g., during pleating).

In some embodiments, the third layer may have a relatively high tensile strength. In some embodiments, the third layer may have a tensile strength in the machine direction (MD) of greater than or equal to about 2 lb/in, greater than or equal to about 4 lb/in, greater than or equal to about 5 lb/in, greater than or equal to about 10 lb/in, greater than or equal to about 15 lb/in, greater than or equal to about 20 lb/in, greater than or equal to about 30 lb/in, greater than or equal to about 40 lb/in, greater than or equal to about 50 lb/in, or greater than or equal to about 60 lb/in. In some instances, the tensile strength in the machine direction may be less than or equal to about 70 lb/in, less than or equal to about 60 lb/in, less than or equal to about 50 lb/in, less than or equal to about 40 lb/in, less than or equal to about 30 lb/in, less than or equal to about 20 lb/in, less than or equal to about 10 lb/in, or less than or equal to about 5 lb/in. Combinations of the above-referenced ranges are also possible (e.g., greater than or equal to about 2 lb/in and less than or equal to about 70 lb/in, greater than or equal to about 4 lb/in and less than or equal to about 60 lb/in). Other values of tensile strength in the machine direction are also possible. The tensile strength in the machine direction may be determined according to the standard T494 om-96 using a test span of 4 in and a jaw separation speed of 1 in/min.

In some embodiments, the third layer may have a tensile strength in the cross direction (CD) of greater than or equal to about 1 lb/in, greater than or equal to about 2 lb/in, greater than or equal to about 5 lb/in, greater than or equal to about 10 lb/in, greater than or equal to about 15 lb/in, greater than or equal to about lb/in, greater than or equal to about 20 lb/in, greater than or equal to about 30 lb/in, greater than or equal to about 40 lb/in, greater than or equal to about 50 lb/in, or greater than or equal to about 60 lb/in. In some instances, the tensile strength in the cross direction may be less than or equal to about 70 lb/in, less than or equal to about 60 lb/in, less than or equal to about 50 lb/in, less than or equal to about 40 lb/in, less than or equal to about 30 lb/in, less than or equal to about 20 lb/in, less than or equal to about 10 lb/in, or less than or equal to about 5 lb/in. Combinations of the above-referenced ranges are also possible (e.g., greater than or equal to about 1 lb/in and less than or equal to about 70 lb/in, greater than or equal to about 2 lb/in and less than or equal to about 40 lb/in). Other values of tensile strength in the cross direction are also possible. The tensile strength in the cross direction may be determined according to the standard T494 om-96 using a test span of 4 in and a jaw separation speed of 1 in/min.

In some embodiments, the third layer may have a relatively high Mullen burst strength. In some embodiments, the third layer may have a Mullen burst strength of greater than or equal to about 5 psi, greater than or equal to about 10 psi, greater than or equal to about 25 psi, greater than or equal to about 50 psi, greater than or equal to about 75 psi, greater than or equal to about 100 psi, greater than or equal to about 125 psi, greater than or equal to about 150 psi, greater than or equal to about 175 psi, greater than or equal to about 200 psi, greater than or equal to about 225 psi, greater than or equal to about 250 psi, or greater than or equal to about 275 psi. In some instances, the Mullen Burst strength may be less than or equal to about 300 psi, less than or equal to about 275 psi, less than or equal to about 250 psi, less than or equal to about 225 psi, less than or equal to about 200 psi, less than or equal to about 175 psi, less than or equal to about 150 psi, less than or equal to about 125 psi, less than or equal to about 100 psi, less than or equal to about 75 psi, less than or equal to about 50 psi, or less than or equal to about 25 psi. Combinations of the above-referenced ranges are also possible (e.g., greater than or equal to about 5 psi and less than or equal to about 300 psi, greater than or equal to about 10 psi and less than or equal to about 200 psi). Other values of Mullen burst strength are also possible. The Mullen burst strength may be determined according to the standard T403 om-91.

In general, the third layer may be formed by any suitable process (e.g., wet laid dry laid, meltblowing, centrifugal spinning, electrospinning) and may comprise any suitable fiber type (e.g., synthetic fibers, cellulose fibers). In some embodiments, the third layer may include a relatively low percentage of or no glass fibers.

In some embodiments, one or more layer in the filter media may be used to impart high fluid separation (e.g., fuel:water separation) efficiency to the filter media. In certain embodiments, a layer (e.g., a second layer, a main filter layer) may be designed to have a specific wettability and/or a wettability that differs from one or more other layers in the filter media (e.g., a third layer). In some embodiments, the second layer and/or third layer may be modified such that the wettability of at least one surface of the second layer and/or third layer is altered and/or enhanced with respect to a particular fluid (e.g., water). For instance, in some embodiments, surface modification may alter and/or enhance the hydrophilicity of at least one surface of a layer (e.g., the second layer). In one example, a surface of a relatively hydrophilic second layer may be modified with a hydrophobic material (e.g., charged material, non-charged hydrophobic material, organic hydrophobic material), such that the modified surface is hydrophobic. In some such cases, the second layer may have a modified hydrophobic surface (e.g., upstream surface) and an unmodified hydrophilic surface (e.g., downstream surface). In other cases, the upstream and downstream surfaces of the second layer may be modified to be hydrophobic. As another example, in certain embodiments, a surface of a relatively hydrophobic or hydrophilic third layer may be modified with a material, such that the modified surface is hydrophilic or hydrophobic, respectively.

In certain embodiments, both the upstream and the downstream surfaces of a layer (e.g., a second layer, a third layer) are modified. In other embodiments, an entire layer (e.g., second layer, third layer, first layer) is modified. Although other surface modification techniques can be used, in certain embodiments, a layer is modified using chemical vapor deposition. For instance, the layer (e.g., second layer, a third layer) may comprises a chemical vapor deposition coating.

Regardless of whether a surface is modified to be hydrophilic or hydrophobic, in general, at least one surface of a layer may be modified to be wetting toward the fluid to be separated. In some embodiments, at least one surface of the layer may be modified to enhance its wettability with respect to a particular fluid (e.g., water). For example, a hydrophilic surface having a water contact angle of 60° may be modified to have a water contact angle of 15°. In another example, a hydrophobic surface having a water contact angle of 100° may be modified to have a water contact angle of 150°. Different ranges of contact angle are provided below.

In some embodiments, a filter media may include a first layer, a second layer, and a material (e.g., hydrophilic material, hydrophobic material) on a surface of the second layer and/or a third layer. The filter media may also include one or more of the optional layers described herein.

In some embodiments, the one or more layers (e.g., first layer, second layer, third layer), as described herein, may be particularly well suited for removing droplets having a relatively low interfacial tension. In certain embodiments, the one or more layers may be particularly well suited for removing droplets having relatively small diameters from a filtration fluid. In certain embodiments, the filter media or filter element described herein do not require separate stages of filter media, wherein each stage serves a different purpose such as particle separation, coalescence, and/or shedding. For example, a single filter media can include one or more layers that have two or more of these functions (particle separation, coalescence, and/or shedding). However, in other embodiments, different stages of media may be included.

As used herein, the terms “wet” and “wetting” may refer to the ability of a fluid to interact with a surface such that the contact angle of the fluid with respect to the surface is less than 90 degrees. Accordingly the terms “repel” and “repelling” may refer to the ability of a fluid to interact with a surface such that the contact angle of the fluid with respect to the surface is greater than or equal to 90 degrees.

In general, the wettability of a layer (e.g., main filter layer) may be selected to allow the layer to repel or coalesce the fluid to be separated (e.g., water, oil) from the filtration fluid (e.g., fuel, hydraulic fluid, water, air). In some instances, the surface of the layer may repel or coalesce the fluid to be separated. In other instances, repelling and coalescing may occur in the interior of the layer (e.g., main filter layer). In some embodiments, the layer (e.g., main filter layer) may be designed to repel the fluid to be separated. In such cases, the layer may substantially block the transport of droplets of the fluid to be separated, such that droplets of a certain size may be inhibited from flowing across such a repelling layer and are separated (e.g., shed) from the filtration fluid. In some embodiments, the layer (e.g., main filter layer) may be designed to be wetting toward and coalesce the fluid to be separated. In such cases, the layer may be used to cause at least a portion of droplets of the fluid to be separated to coalesce, such that the droplets have the requisite size for removal at a subsequent layer and/or such that the coalesced droplets are able to be separated (e.g., via gravity) at the layer (e.g., main filter layer).

In some embodiments, the filter media may comprise a coalescing or repelling layer (e.g., main filter layer), as described above, and another layer (e.g., third layer) having a different wettability with respect to a particular fluid than the layer (e.g., main filter layer). Such a media can be designed to both coalesce and repel droplets of the fluid to be separated. In certain embodiments, a layer (e.g., main filter layer) may repel, and another layer (e.g., third layer) may coalesce, the fluid to be separated. For example, a filter media designed to separate a hydrophilic fluid from a filtration fluid (e.g., a hydrophobic liquid) may comprise a hydrophobic main filter layer upstream of a hydrophilic third layer. The upstream hydrophobic main filter layer may serve to repel and remove hydrophilic droplets (e.g., via shedding) and the downstream hydrophilic third layer may serve to coalesce and remove (e.g., via gravity) at least a portion of remaining hydrophilic fluid in the filtration fluid. In some instances, the larger hydrophilic fluid droplets are shed upstream via the hydrophobic main filter layer and the remaining hydrophilic fluid droplets are coalesced at the hydrophilic third layer to form larger droplets that are removed via gravity.

In another example, a filter media designed to separate hydrophilic fluid from a filtration fluid (e.g., a hydrophobic liquid) may comprise a hydrophilic first layer upstream of a hydrophobic main filter layer. The upstream hydrophilic layer may serve to coalesce and remove (e.g., via gravity) hydrophilic droplets and the downstream hydrophobic main filter layer may serve to remove at least a portion of remaining hydrophilic fluid in the filtration fluid. In some instances, hydrophilic fluid droplets coalesce at the hydrophilic first layer to form larger droplets that are removed via gravity or downstream via the hydrophobic main filter layer. In other embodiments, the main filter layer may coalesce and the first layer may repel the fluid to be separated. In some such embodiments, the main filter layer is the hydrophilic layer in the examples described above and the first layer is the hydrophobic layer in the examples described above.

In some embodiments, the filter media may comprise a main filter layer and another layer that has a similar or substantially the same wettability as the main filter layer with respect to a particular fluid. In some such embodiments, the filter media may repel or coalesce the fluid to be separated. For example, a filter media designed to remove a hydrophilic fluid from a filtration fluid may comprise a hydrophobic main filter layer and another hydrophobic layer (e.g., first layer, third layer). The hydrophobic main filter layer may be upstream or downstream of the other hydrophobic layer. In certain embodiments, the downstream layer may serve to repel and shed fluid droplets that are not repelled and/or removed by the upstream layer. For example, the upstream layer may be designed to repel and/or remove relatively large droplets and the downstream layer may be designed to repel and shed smaller droplets that bypass the upstream layer. In another example, a filter media designed to remove a hydrophilic fluid from a filtration fluid may comprise a hydrophilic layer main filter layer and another hydrophilic layer (e.g., first layer, third layer). The hydrophilic main filter layer may be upstream or downstream of the other hydrophilic layer. In certain embodiments, the downstream layer may serve to coalesce and/or remove fluid droplets that are not coalesced and/or removed by the upstream layer. For example, the upstream layer may be designed to coalesce and/or remove relatively large droplets and the downstream layer may be designed to coalesce and/or remove smaller droplets that bypass the upstream layer.

As noted above, in some embodiments, the main filter layer may be more hydrophobic than a third layer in the filter media. In some such embodiments, the water contact angle on the surface of the main filter layer may be greater than or equal to about 30 degrees and less than or equal to about 165 degrees (e.g., greater than or equal to about 35 degrees and less than or equal to about 165, or other ranges described herein). The water contact angle on the surface of the third layer may be greater than or equal to about 0 degrees and less than or equal to about 125 degrees (or other ranges described herein), provided that the water contact angle of the main filter layer is greater than the water contact angle of the third layer.

In general, the contact angle of the main filter layer may be selected as desired. In some embodiments, the water contact angle on the surface of the main filter layer may be greater than or equal to about 30 degrees, greater than or equal to about 35 degrees, greater than or equal to about 40 degrees, greater than or equal to about 50 degrees, greater than or equal to about 60 degrees, greater than or equal to about 70 degrees, greater than or equal to about 80 degrees, greater than 90 degrees, greater than or equal to 100 degrees, greater than or equal to 105 degrees, greater than or equal to 110 degrees, greater than or equal to 115 degrees, greater than or equal to 120 degrees, greater than or equal to 125 degrees, greater than or equal to 130 degrees, greater than or equal to 135 degrees, greater than or equal to 145 degrees, greater than or equal to 150 degrees, greater than or equal to 155 degrees, or greater than or equal to 160 degrees. In some instances, the water contact angle of the main filter layer is less than or equal to about 165 degrees, less than or equal to about 160 degrees, less than or equal to about 150 degrees, less than or equal to about 140 degrees, less than or equal to about 130 degrees, less than or equal to about 120 degrees, less than or equal to about 110 degrees, less than or equal to about 100 degrees, less than or equal to about 90 degrees, less than or equal to about 80 degrees, less than or equal to about 70 degrees, less than or equal to about 60 degrees, less than or equal to about 50 degrees, less than or equal to about 40 degrees, or less than or equal to about 35 degrees. Combinations of the above-referenced ranges are also possible (e.g., greater than or equal to about 30 degrees and less than or equal to about 165 degrees). The water contact angle may be measured using standard ASTM D5946 (2009). The contact angle is the angle between the substrate surface and the tangent line drawn to the water droplet surface at the three-phase point, when a liquid drop is resting on the substrate surface. A contact angle meter or goniometer can be used for this determination.

In some embodiments, the water contact angle on the surface of another layer (e.g., a third layer) is less than or equal to about 125 degrees, less than or equal to about 120 degrees, less than or equal to about 110 degrees, less than 100 degrees, less than or equal to about 90 degrees, less than or equal to about 80 degrees, less than or equal to about 70 degrees, less than or equal to about 60 degrees, less than or equal to about 50 degrees, less than or equal to about 40 degrees, less than or equal to about 30 degrees, less than or equal to about 25 degrees, less than or equal to about 20 degrees, or less than or equal to about 15 degrees. In some instances, the water contact angle of another layer (e.g., a third layer) is greater than or equal to about 0 degrees, greater than or equal to about 5 degrees, greater than or equal to about 10 degrees, greater than or equal to about 20 degrees, greater than or equal to about 30 degrees, greater than or equal to about 40 degrees, greater than or equal to about 50 degrees, greater than or equal to about 60 degrees, greater than or equal to about 70 degrees, greater than 80 degrees, greater than or equal to 90 degrees, greater than or equal to 100 degrees, greater than or equal to 110 degrees, greater than or equal to 115 degrees, or greater than or equal to 120 degrees. Combinations of the above-referenced ranges are also possible.

In certain embodiments, a fiber (e.g., a polymeric staple fiber) present in a layer (e.g., first layer, second layer) is formed of a material having a contact angle (e.g., a water contact angle) within one or more ranges. As used herein, a contact angle of a material is determined by measuring contact angle, according to standard ASTM D5946 (2009), on a flatsheet produced exclusively of fibers formed of the material, the fibers having an average fiber diameter of 0.8±0.5 microns, and the flatsheet having a basis weight of 50 g/m² and a MFP of 1.5-6.5 microns.

In some embodiments, the water contact angle of a material described herein (e.g., the water contact angle of a material used to form polymeric staple fibers, such as a first and/or a second plurality of polymeric staple fibers) may be greater than or equal to about 30 degrees, greater than or equal to about 35 degrees, greater than or equal to about 40 degrees, greater than or equal to about 50 degrees, greater than or equal to about 60 degrees, greater than or equal to about 70 degrees, greater than or equal to about 80 degrees, greater than 90 degrees, greater than or equal to 100 degrees, greater than or equal to 105 degrees, greater than or equal to 110 degrees, greater than or equal to 115 degrees, greater than or equal to 120 degrees, greater than or equal to 125 degrees, greater than or equal to 130 degrees, greater than or equal to 135 degrees, greater than or equal to 145 degrees, greater than or equal to 150 degrees, greater than or equal to 155 degrees, or greater than or equal to 160 degrees. In some instances, the water contact angle is less than or equal to about 165 degrees, less than or equal to about 160 degrees, less than or equal to about 150 degrees, less than or equal to about 140 degrees, less than or equal to about 130 degrees, less than or equal to about 120 degrees, less than or equal to about 110 degrees, less than or equal to about 100 degrees, less than or equal to about 90 degrees, less than or equal to about 80 degrees, less than or equal to about 70 degrees, less than or equal to about 60 degrees, less than or equal to about 50 degrees, less than or equal to about 40 degrees, or less than or equal to about 35 degrees. Combinations of the above-referenced ranges are also possible (e.g., greater than or equal to about 30 degrees and less than or equal to about 165 degrees).

As described herein, in some embodiments, a layer may be hydrophilic. As used herein, the term “hydrophilic” refers to material that has a water contact angle of less than 90 degrees. Accordingly, a “hydrophilic layer” may refer to a layer that has a water contact angle of less than 90 degrees on the surface of the layer. In some embodiments, the layer may be hydrophilic such that the water contact angle is less than 90 degrees, less than or equal to about 80 degrees, less than or equal to about 75 degrees, less than or equal to about 70 degrees, less than or equal to about 65 degrees, less than or equal to about 60 degrees, less than or equal to about 55 degrees, less than or equal to about 50 degrees, less than or equal to about 45 degrees, less than or equal to about 40 degrees, less than or equal to about 35 degrees, less than or equal to about 30 degrees, less than or equal to about 25 degrees, less than or equal to about 20 degrees, or less than or equal to about 15 degrees. In some embodiments, the water contact angle is greater than or equal to about 0 degrees, greater than or equal to about 5 degrees, greater than or equal to about 10 degrees, greater than or equal to about 15 degrees, greater than or equal to about 20 degrees, greater than or equal to about 25 degrees, greater than or equal to about 35 degrees, greater than or equal to about 45 degrees, or greater than or equal to about 60 degrees. Combinations of the above-referenced ranges are also possible (e.g., greater than or equal to about 0 degrees and less than 90 degrees, greater than or equal to about 0 degrees and less than about 60 degrees).

As described herein, in some embodiments, a layer may be hydrophobic. As used herein, the term “hydrophobic” refers to material that has a water contact angle of greater than or equal to 90 degrees (e.g., greater than or equal to 120 degrees, greater than or equal to 150 degrees). Accordingly, a “hydrophobic layer” may refer to a layer that has a water contact angle of greater than or equal to 90 degrees on the surface of the layer. In some embodiments, the surface may be modified to be hydrophobic such that the water contact angle is greater than or equal to 90 degrees, greater than or equal to 100 degrees, greater than or equal to 105 degrees, greater than or equal to 110 degrees, greater than or equal to 115 degrees, greater than or equal to 120 degrees, greater than or equal to 125 degrees, greater than or equal to 130 degrees, greater than or equal to 135 degrees, greater than or equal to 145 degrees, greater than or equal to 150 degrees, greater than or equal to 155 degrees, or greater than or equal to 160 degrees. In some such embodiments, the surface may have a contact angle greater than or equal to about 150 degrees. In some instances, the water contact angle is less than or equal to about 180 degrees, less than or equal to about 175 degrees, less than or equal to about 165 degrees, less than or equal to about 150 degrees, less than or equal to about 135 degrees, less than or equal to about 120 degrees, or less than or equal to about 105 degrees. Combinations of the above-referenced ranges are also possible (e.g., greater than or equal to 90 degrees and less than about 180 degrees, greater than or equal to about 105 degrees and less than about 180 degrees).

As noted above, the filter media may include one or more layers (e.g., second layer 30, third layer) having at least one modified surface. The material used to modify at least one surface of a layer (e.g., second layer 30) may be applied on any suitable portion of the fiber web forming the layer. In some embodiments, the material may be applied such that one or more surfaces of a layer (e.g., second layer, third layer) are modified without substantially modifying the interior of the layer. In some instances, a single surface of the layer may be modified. For example, the upstream surface of a layer may be coated. In other instances, more than one surface of a layer may be coated (e.g., the upstream and downstream surfaces). In other embodiments, at least a portion of the interior of the fiber web of a layer may be modified along with at least one surface of the layer. In some embodiments, the entire fiber web of the layer is modified with the material.

In general, any suitable method for modifying the surface chemistry of at least one surface of a layer may be used. In some embodiments, the surface chemistry of a layer may be modified by coating at least a portion of the surface, using melt-additives, and/or altering the roughness of the surface.

In some embodiments, the surface modification may be a coating. In certain embodiments, a coating process involves introducing resin or a material (e.g., hydrophobic material, hydrophilic material) dispersed in a solvent or solvent mixture onto a pre-formed fiber layer (e.g., a pre-formed fiber web formed by a meltblown, a meltspun, a melt electrospinning, a solvent electrospinning, or centrifugal spinning process). Non-limiting examples of coating methods include the use of chemical vapor deposition, a slot die coater, gravure coating, screen coating, size press coating (e.g., a two roll-type or a metering blade type size press coater), film press coating, blade coating, roll-blade coating, air knife coating, roll coating, foam application, reverse roll coating, bar coating, curtain coating, champlex coating, brush coating, Bill-blade coating, short dwell-blade coating, lip coating, gate roll coating, gate roll size press coating, laboratory size press coating, melt coating, dip coating, knife roll coating, spin coating, spray coating, gapped roll coating, roll transfer coating, padding saturant coating, and saturation impregnation. Other coating methods are also possible. In some embodiments, the hydrophilic or hydrophobic material may be applied to the fiber web using a non-compressive coating technique. The non-compressive coating technique may coat the fiber web, while not substantially decreasing the thickness of the web. In other embodiments, the resin may be applied to the fiber web using a compressive coating technique.

In one set of embodiments, a surface described herein is modified using chemical vapor deposition. In chemical vapor deposition, the fiber web is exposed to gaseous reactants from gas or liquid vapor that are deposited onto the fiber web under high energy level excitation such as thermal, microwave, UV, electron beam or plasma. Optionally, a carrier gas such as oxygen, helium, argon and/or nitrogen may be used.

Other vapor deposition methods include atmospheric pressure chemical vapor deposition (APCVD), low pressure chemical vapor deposition (LPCVD), metal-organic chemical vapor deposition (MOCVD), plasma assisted chemical vapor deposition (PACVD) or plasma enhanced chemical vapor deposition (PECVD), laser chemical vapor deposition (LCVD), photochemical vapor deposition (PCVD), chemical vapor infiltration (CVI) and chemical beam epitaxy (CBE).

In physical vapor deposition (PVD) thin films are deposited by the condensation of a vaporized form of the desired film material onto substrate. This method involves physical processes such as high-temperature vacuum evaporation with subsequent condensation, or plasma sputter bombardment rather than a chemical reaction.

After applying the coating to the fiber web, the coating may be dried by any suitable method. Non-limiting examples of drying methods include the use of a photo dryer, infrared dryer, hot air oven, steam-heated cylinder, or any suitable type of dryer familiar to those of ordinary skill in the art.

In some embodiments, at least a portion of the fibers of a layer may be coated without substantially blocking the pores of the fiber web. In some instances, substantially all of the fibers may be coated without substantially blocking the pores. In some embodiments, the fiber web may be coated with a relatively high weight percentage of resin or material without blocking the pores of the layer using the methods described herein (e.g., by dissolving and/or suspending one or more material in a solvent to form the resin).

In some embodiments, the surface may be modified using melt additives. Melt-additives are functional chemicals that are added to thermoplastics fibers during an extrusion process that may render different physical and chemical properties at the surface from those of the thermoplastic itself after formation.

In some embodiments, the material may undergo a chemical reaction (e.g., polymerization) after being applied to the layer. For example, a surface of the layer may be coated with one or more monomers that can be polymerized after coating. In another example, a surface of the layer may include monomers, as a result of the melt additive, that are polymerized after formation of the fiber web. In some such embodiments, an in-line polymerization may be used. In-line polymerization (e.g., in -line ultraviolet polymerization) is a process to cure a monomer or liquid polymer solution onto a substrate under conditions sufficient to induce polymerization (e.g., under UV irradiation).

In general, any suitable material may be used to alter the surface chemistry, and accordingly the wettability, of a layer. In some embodiments, the material may be charged. In some such embodiments, as described in more detail herein, the surface charge of the a layer may further facilitate coalescence and/or increase the water separation efficiency. For instance, in certain embodiments, a layer having a charged, hydrophilic modified surface may have a greater fuel-water separation efficiency and/or produce larger coalesced droplets than a layer having a hydrophilic modified surface or a non-modified surface. In other embodiments, the surface charge of the layer render the surface hydrophilic, but may not otherwise facilitate coalescence and/or increase the water separation efficiency.

In general, the net charge of the modified surface may be negative, positive, or neutral. In some instances, the modified surface may comprise a negatively charged material and/or a positively charged material. In some embodiments, the surface may be modified with an electrostatically neutral material. Non-limiting examples of materials that may be used to modify the surface include polyelectrolytes (e.g., anionic, cationic), oligomers, polymers (e.g., perfluoroalkyl ethyl methacrylate, polycaprolactone, poly[bis(trifluoroethoxy)phosphazene], polymers having carboxylic acid moieties, polymers having amine moieties, polyol), small molecules (e.g., carboxylate containing monomers, amine containing monomers, polyol), ionic liquids, monomer precursors, metals (e.g., gold, copper, tin, zinc, silicon, indium, tungsten), and gases, and combinations thereof.

In some embodiments, anionic polyelectrolytes may be used to modify the surface of a layer. For example, one or more anionic polyelectrolytes may be spray or dip coated onto at least one surface of a layer. Non-limiting examples of anionic polyelectrolytes that may be used to modify a surface include poly(2-acrylamido-2-methyl-1-propanesulfonic acid), poly(2-acrylamido-2-methyl-1-propanesulfonic acid-co-acrylonitrile), poly(acrylic acid), polyanetholesulfonic, poly(sodium 4-styrenesulfonate), poly(4-styrenesulfonic acid), poly(4-styrenesulfonic acid), poly(4-styrenesulfonic acid-co-maleic acid), poly(vinyl sulfate), and poly(vinylsulfonic acid, sodium), and combinations thereof.

In some embodiments, cationic polyelectrolytes may be used to modify the surface of a layer. Non-limiting examples of cationic polyelectrolytes that may be used to modify a surface include polydiallyldimethylammonium (PDDA), polyallyamine, poly(acrylamide-co-dimethylaminoethylacrylate-methyl), poly(acrylamide-co-diallyldimethylammonium), poly(4-vinyl pyridine), and amphiphilic polyelectrolytes of ionene type with ionized backbones, and combinations thereof.

In some embodiments, small molecules (e.g., monomers, polyol) may be used to modify at least one surface of a layer. For example, the polyol (e.g., glycerin, pentaerythritol, ethylene glycol, propylene glycol, sucrose) monobasic carboxylic acids, unsaturated dicarboxylic acids, and/or amine containing small molecules may be used to modify at least one surface of a layer. In certain embodiments, small molecules may be used as melt-additives. In another example, small molecules may be deposited on at least one surface of a layer via coating (e.g., chemical vapor deposition). Regardless of the modification method, the small molecules on a surface of a layer may be polymerized after deposition in some embodiments.

In certain embodiments, the small molecules, such as monobasic carboxylic acids and/or unsaturated dicarboxylic (dibasic) acids, may be used to modify at least one surface of a layer. For example, in some instances, monobasic carboxylic acids and/or unsaturated dicarboxylic (dibasic) acids may be polymerized after deposition using in-line ultraviolet polymerization. Non-limiting example of monobasic carboxylic acids that may be used to modify at least one surface of a layer include acrylic acid, methacrylic acid, crotonic acid, angelic acid, cytronellic acid, ricin acid, palmitooleic acid, erucic acid, 4-vinylbenzoic acid, sorbic acid, geranic acid, linolenic acid, and dehydrogeranic acid, and combinations thereof. Non-limiting example of unsaturated dicarboxylic (dibasic) acids that may be used to modify at least one surface of a layer include maleic acid, itaconic acid, acetylendicarboxylic acid, and maleic acid monoamide acid, and combinations thereof.

In certain embodiments, the small molecules may be amine containing small molecules. The amine containing small molecules may be primary, secondary, or tertiary amines. In some such cases, the amine containing small molecule may be a monomer. Non-limiting examples of amine containing small molecules (e.g., amine containing monomers) that may be used to modify at least one surface of a layer include allylamine, 2-aminophenyl disulfide, 4-aminophenyl propargyl ether, 1,2,4,5-benzenetetracarboxamide, 1,2,4,5-benzenetetramine, 4,4′-(1,1′-biphenyl-4,4′-diyldioxy)dianiline, 2,2-bis(aminoethoxy)propane, 6-chloro-3,5-diamino-2-pyrazinecarboxamide, 4-chloro-o-phenylenediamine, 1,3-cyclohexanebis(methylamine), 1,3-diaminoacetone, 1,4-diaminoanthraquinone, 4,4′-diaminobenzanilide, 3,4-diaminobenzophenone, 4,4′-diaminobenzophenone, 2,6-diamino-4-chloropyrimidine 1-oxide, 1,5-diamino-2-methylpentane, 1,9-diaminononane, 4,4′-diaminooctafluorobiphenyl, 2,6-diaminopurine, 2,4-diaminotoluene, 2,6-diaminotoluene, 2,5-dichloro-p-phenylenediamine, 2,5-dimethyl-1,4-phenylenediamine, 2-dimethyl-1,3-propanediamine, 4,9-dioxa-1,12-dodecanediamine, 1,3-diaminopentane, 2,2′-(ethylenedioxy)bis(ethylamine), 4,4′-(hexafluoroisopropylidene)bis(p-phenyleneoxy)dianiline, 4,4′-(hexafluoroisopropylidene)dianiline, 5,5′-(hexafluoroisopropylidene)di-o-toluidine, 4,4′-(4,4′-isopropylidenediphenyl-1,1′-diyldioxy)dianiline, 4,4′-methylene-bis(2-chloroaniline), 4,4′-methylenebis(cyclohexylamine), 4,4′-methylenebis(2,6-diethylaniline), 4,4′-methylenebis(2,6-dimethylaniline), 3,3′-methylenedianiline, 3,4′-oxydianiline, 4,4′-(1,3-phenylenediisopropylidene)bisaniline, 4,4′-(1,4-phenylenediisopropylidene)bisaniline, 4,4′-(1,3-phenylenedioxy)dianiline, (1,4-butanediol)bis(4-aminobenzoate) oligomer, 2,3,5,6-tetramethyl-p-phenylenediamine, 2,4,6-trimethyl-m-phenylenediamine, 4,7,10-trioxa-1,13-tridecanediamine, tris(2-aminoethyl)amine, p-xylylenediamine, cyclen, N,N′-diethyl-2-butene-1,4-diamine, N,N′-diisopropylethylenediamine, N,N′-diisopropyl-1,3-propanediamine, N,N′-dimethyl-1,3-propanediamine, N,N′-diphenyl-p-phenylenediamine, 2-(penta-4-ynyl)-2-oxazoline, 1,4,8,12-tetraazacyclopentadecane, 1,4,8,11-tetraazacyclotetradecane-5,7-dione, 1-[bis[3-(dimethylamino)propyl]amino]-2-propanol, 1,4-diazabicyclo[2.2.2]octane, 1,6-diaminohexane-N,N,N′,N′-tetraacetic acid, 2-[2-(dimethylamino)ethoxy]ethanol, N,N,N′,N″,N″-pentamethyldiethylenetriamine, N,N,N′,N′-tetraethyl-1,3-propanediamine, N,N,N′,N′-tetramethyl-1,4-butanediamine, N,N,N′,N′-tetramethyl-2-butene-1,4-diamine, N,N,N′,N′-tetramethyl-1,6-hexanediamine, 1,4,8,11-Tetramethyl-1,4,8,11-tetraazacyclotetradecane, and 1,3,5-Trimethylhexahydro-1,3,5-triazine, and combinations thereof. In certain embodiments, an amine containing monomer may be a derivative of one or more of the above-referenced amine containing small molecules (e.g., acrylamide) that has one or more functional groups (e.g., unsaturated carbon-carbon bond) capable of reacting with other molecules to form a polymer.

In some embodiments, the small molecule may be an inorganic or organic hydrophobic molecule. Non-limiting examples include hydrocarbons (e.g., CH4, C2H2, C2H4, C6H6), fluorocarbons (e.g., CF₄, C₂F₄, C₃F₆, C₃F₈, C₄H₈, C₅H₁₂, C₆F₆), silanes (e.g., SiH₄, Si₂H₆, Si₃H₈, Si₄H₁₀), organosilanes (e.g., methylsilane, dimethylsilane, triethylsilane), siloxanes (e.g., dimethylsiloxane, hexamethyldisiloxane), ZnS, CuSe, InS, CdS, tungsten, silicon carbide, silicon nitride, silicon oxynitride, titanium nitride, carbon, silicon-germanium, and hydrophobic acrylic monomers terminating with alkyl groups and their halogenated derivatives (e.g., ethyl 2-ethylacrylate, methyl methacrylate; acrylonitrile). In certain embodiments, suitable hydrocarbons for modifying a surface of a layer may have the formula CxHy, where x is an integer from 1 to 10 and y is an integer from 2 to 22. In certain embodiments, suitable silanes for modifying a surface of a layer may have the formula SinH2n+2 where any hydrogen may be substituted for a halogen (e.g., Cl, F, Br, I), where n is an integer from 1 to 10.

As used herein, “small molecules” refers to molecules, whether naturally-occurring or artificially created (e.g., via chemical synthesis) that have a relatively low molecular weight. Typically, a small molecule is an organic compound (i.e., it contains carbon). The small organic molecule may contain multiple carbon-carbon bonds, stereocenters, and other functional groups (e.g., amines, hydroxyl, carbonyls, and heterocyclic rings, etc.). In certain embodiments, the molecular weight of a small molecule is at most about 1,000 g/mol, at most about 900 g/mol, at most about 800 g/mol, at most about 700 g/mol, at most about 600 g/mol, at most about 500 g/mol, at most about 400 g/mol, at most about 300 g/mol, at most about 200 g/mol, or at most about 100 g/mol. In certain embodiments, the molecular weight of a small molecule is at least about 100 g/mol, at least about 200 g/mol, at least about 300 g/mol, at least about 400 g/mol, at least about 500 g/mol, at least about 600 g/mol, at least about 700 g/mol, at least about 800 g/mol, or at least about 900 g/mol, or at least about 1,000 g/mol. Combinations of the above ranges (e.g., at least about 200 g/mol and at most about 500 g/mol) are also possible.

In some embodiments, polymers may be used to modify at least one surface of a layer. For example, one or more polymer may be applied to at least a portion of a surface of a layer via a coating technique. In certain embodiments, the polymer may be formed from monobasic carboxylic acids and/or unsaturated dicarboxylic (dibasic) acids. In certain embodiments, the polymer may be a graft copolymer and may be formed by grafting polymers or oligomers to polymers in the fibers and/or fiber web (e.g., resin polymer). The graft polymer or oligomer may comprise carboxyl moieties that can be used to form a chemical bond between the graft and polymers in the fibers and/or fiber web. Non-limiting examples of polymers in the fibers and/or fiber web that can be used to form a graft copolymer include polyethylene, polypropylene, polycarbonate, polyvinyl chloride, polytetrafluoroethylene, polystyrene, cellulose, polyethylene terephthalate, polybutylene terephthalate, and nylon, and combinations thereof. Graft polymerization can be initiated through chemical and/or radiochemical (e.g., electron beam, plasma, corona discharge, UV-irradiation) methods. In some embodiments, the polymer may be a polymer having a repeat unit that comprises an amine (e.g., polyallylamine, polyethyleneimine, polyoxazoline). In certain embodiments, the polymer may be a polyol.

In some embodiments, a gas may be used to modify at least one surface of a layer. In some such cases, the molecules in the gas may react with material (e.g., fibers, resin, additives) on the surface of a layer to form functional groups, such as charged moieties, and/or to increase the oxygen content on the surface of the layer. Non-limiting examples of functional groups include hydroxyl, carbonyl, ether, ketone, aldehyde, acid, amide, acetate, phosphate, sulfite, sulfate, amine, nitrile, and nitro groups. Non-limiting examples of gases that may be reacted with at least one surface of a layer includes CO₂, SO₂, SO₃, NH₃, N₂H₄, N₂, O₂, H₂, He, Ar, NO, air and combinations thereof.

As described herein, in some embodiments, the surface of a layer (e.g., a second layer) may be modified to be hydrophilic (e.g., to have a greater hydrophilicity compared to the layer prior to modification).

In certain embodiments, one or more layers of the filter media includes microglass fibers, chopped strand glass fibers, or a combination thereof. Microglass fibers and chopped strand glass fibers are known to those skilled in the art. One skilled in the art is able to determine whether a glass fiber is microglass or chopped strand by observation (e.g., optical microscopy, electron microscopy). Microglass fibers may also have chemical differences from chopped strand glass fibers. In some cases, though not required, chopped strand glass fibers may contain a greater content of calcium or sodium than microglass fibers. For example, chopped strand glass fibers may be close to alkali free with high calcium oxide and alumina content. Microglass fibers may contain 10-15% alkali (e.g., sodium, magnesium oxides) and have relatively lower melting and processing temperatures. The terms refer to the technique(s) used to manufacture the glass fibers. Such techniques impart the glass fibers with certain characteristics. In general, chopped strand glass fibers are drawn from bushing tips and cut into fibers in a process similar to textile production. Chopped strand glass fibers are produced in a more controlled manner than microglass fibers, and as a result, chopped strand glass fibers will generally have less variation in fiber diameter and length than microglass fibers. Microglass fibers are drawn from bushing tips and further subjected to flame blowing or rotary spinning processes. In some cases, fine microglass fibers may be made using a remelting process. In this respect, microglass fibers may be fine or coarse. As used herein, fine microglass fibers are less than 1 micron in diameter and coarse microglass fibers are greater than or equal to 1 micron in diameter.

The microglass fibers of one or more layers can have small diameters such as less than 10.0 microns. For example, the average diameter of the microglass fibers in a layer may be between 0.1 microns to about 9.0 microns; and, in some embodiments, between about 0.3 microns and about 6.5 microns, or between about 1.0 microns and 5.0 microns. In certain embodiments, the microglass fibers may have an average fiber diameter of less than or equal to about 7.0 microns, less than or equal to about 5.0 microns, less than or equal to about 3.0 microns, or less than or equal to about 1.0 microns. Average diameter distributions for microglass fibers are generally log-normal. However, it can be appreciated that microglass fibers may be provided in any other appropriate average diameter distribution (e.g., Gaussian distribution).

The microglass fibers may vary significantly in length as a result of process variations. The aspect ratios (length to diameter ratio) of the microglass fibers in a layer may be generally in the range of about 100 to 10,000. In some embodiments, the aspect ratio of the microglass fibers in a layer are in the range of about 200 to 2500; or, in the range of about 300 to 600. In some embodiments, the average aspect ratio of the microglass fibers in a layer may be about 1,000; or about 300. It should be appreciated that the above-noted dimensions are not limiting and that the microglass fibers may also have other dimensions.

Coarse microglass fibers, fine microglass fibers, or a combination of microglass fibers thereof may be included within a layer. In some embodiments, coarse microglass fibers make up between about 20% by weight and about 90% by weight of the glass fibers. In some cases, for example, coarse microglass fibers make up between about 30% by weight and about 60% by weight of the glass fibers, or between about 40% by weight and about 60% by weight of the glass fibers. For certain embodiments that include fine microglass fibers, the fine microglass fibers make up between about 0% and about 95% by weight of the glass fibers. In some cases, for example, fine microglass fibers make up between about 5% by weight and about 60% by weight of the glass fibers, between about 30% by weight and about 50% by weight of the glass fibers, or between about 60% by weight and about 95% by weight of the glass fibers.

The chopped strand glass fibers may have an average fiber diameter that is greater than the diameter of the microglass fibers. In some embodiments, the chopped strand glass fiber has a diameter of greater than about 5 microns. For example, the diameter range may be up to about 30 microns. In some embodiments, the chopped strand glass fibers may have a fiber diameter between about 5 microns and about 12 microns. In certain embodiments, the chopped strand fibers may have an average fiber diameter of less than or equal to about 10.0 microns, less than or equal to about 8.0 microns, less than or equal to about 6.0 microns. Average diameter distributions for chopped strand glass fibers are generally log-normal. Chopped strand diameters tend to follow a normal distribution. Though, it can be appreciated that chopped strand glass fibers may be provided in any appropriate average diameter distribution (e.g., Gaussian distribution). In some embodiments, chopped strand glass fibers may have a length in the range of between about 0.125 inches and about 1 inch (e.g., about 0.25 inches, or about 0.5 inches).

In some embodiments, regardless of whether the glass fibers in a layer (e.g., an upstream layer, a downstream layer, a first layer, a second layer, a third layer, etc.) are microglass fibers, chopped strand fibers, or combinations thereof, the average fiber diameter of glass fibers within a layer may be greater than or equal to about 0.1 microns, greater than or equal to about 0.2 microns, greater than or equal to about 0.3 microns, greater than or equal to about 0.5 microns, greater than or equal to about 1 micron, greater than or equal to about 2 microns, greater than or equal to about 4 microns, greater than or equal to about 6 microns, greater than or equal to about 8 microns, greater than or equal to about 10 microns, or greater than or equal to about 12 microns. In some instances, the average fiber diameter of glass fibers within a layer (e.g., an upstream layer, a downstream layer, a first layer, a second layer, a third layer, etc.) may be less than or equal to about 15 microns, less than or equal to about 13 microns, less than or equal to about 11 microns, less than or equal to about 8 microns, less than or equal to about 5 microns, less than or equal to about 3 microns, less than or equal to about 1 micron, or less than or equal to about 0.5 microns. Combinations of the above-referenced ranges are also possible (e.g., greater than or equal to about 0.1 microns and less than or equal to about 15 microns, greater than or equal to about 0.3 microns and less than or equal to about 11 microns).

It should be appreciated that the above-noted dimensions are not limiting and that the microglass and/or chopped strand fibers may also have other dimensions.

In certain embodiments, the ratio between the weight percentage of microglass fibers and chopped strand glass fibers provides for different characteristics in the filter media. Accordingly, in some embodiments, one or more layers of a filter media (e.g., an upstream layer, a downstream layer, a first layer, a second layer, a third layer, etc.) includes a relatively large percentage of microglass fibers in the layer. For example, at least 70 wt %, or at least 80 wt %, at least 90 wt %, at least 93 wt %, at least 95 wt %, at least 97 wt %, or at least 99 wt % of the fibers of a layer may be microglass fibers. In certain embodiments, all of the fibers of a layer are microglass fibers. In some embodiments, one or more layers of a filter media (e.g., an upstream layer, a downstream layer, a first layer, a second layer, a third layer, etc.) includes a relatively high percentage of chopped strand fibers in the layer. For example, at least 50 wt %, at least 60 wt %, at least 70 wt %, or at least 80 wt %, at least 90 wt %, at least 93 wt %, at least 95 wt %, at least 97 wt %, or at least 99 wt % of the fibers of a layer may be chopped strand fibers. Such percentages of chopped strand fibers may be particularly useful in certain embodiments for micron ratings greater than 15 microns for Beta₍ₓ₎=200. In certain embodiments, all of the fibers of a layer are chopped strand fibers.

In some embodiments, one or more layers of a filter media (e.g., an upstream layer, a downstream layer, a first layer, a second layer, a third layer, etc.) includes a relatively large percentage of microglass fiber in the layer with respect to all of the components used to form the layer. For example, one or more layers may include microglass fibers of at least about 40 wt %, at least about 50 wt %, at least about 60 wt %, at least about 70 wt %, or at least about 80 wt %, at least about 90 wt %, at least about 93 wt %, at least about 95 wt %, at least about 97 wt %, or at least about 99 wt % of the fibers in a layer. In one particular embodiment, one or more layers includes microglass fibers of between about 90 wt % and about 99 wt %, e.g., between about 90 wt % and about 95 wt % of the fibers in a layer. In another embodiment, one or more layers includes microglass fibers of between about 40 wt % to about 80 wt %, or between about 60 wt % to about 80 wt % of the fibers in a layer. It should be understood that, in certain embodiments, one or more layers of the filter media do not include microglass fibers within the above-noted ranges or at all.

Any suitable amount of chopped strand fibers can be used in one or more layers of a filter media. In some cases, one or more layers includes a relatively low percentage of chopped strand fibers. For example, one or more layers may include chopped strand fiber of less than 30 wt %, or less than 20 wt %, or less than 10 wt %, or less than 5 wt %, or less than 2 wt %, or less than 1 wt % of the fibers in a layer. In some cases, one or more layers of a filter media does not include any chopped strand fibers. It should be understood that, in certain embodiments, one or more layers of the filter media do not include chopped strand fibers within the above-noted ranges.

One or more layers of a filter media may also include microglass fibers having an average fiber diameter within a certain range and making up a certain range of weight percentage of the layer. For instance, one or more layers of a filter media may include microglass fibers having an average fiber diameter of less than 5 microns making up less than or equal to about 50%, less than or equal to about 40%, less than or equal to about 30%, less than or equal to about 20%, less than or equal to about 10%, or less than or equal to about 5% of the microglass fibers of the layer. In some cases, a layer includes 0% of microglass fibers having an average diameter of less than 5 microns. Additionally or alternatively, the one or more layers of the filter media may include microglass fibers having an average fiber diameter of greater than or equal to 5 microns making up greater than about 50%, greater than about 60%, greater than about 70%, greater than about 80%, greater than about 90%, greater than about 93%, or greater than about 97% of the microglass fibers of the layer. In some cases, more than one layer of a filter media includes such properties. It should be understood that, in certain instances, one or more layers of the filter media include microglass fibers within ranges different than those described above.

In other embodiments, one or more layers of a filter media includes relatively fine fibers. For instance, one or more layers of the filter media may include microglass fibers having an average fiber diameter of less than 5 microns making up greater than about 50%, greater than about 60%, greater than about 70%, greater than about 80%, greater than about 90%, greater than about 93%, or greater than about 97% of the microglass fibers of the layer. Additionally or alternatively, the one or more layers of the filter media may include microglass fibers having an average fiber diameter of greater than or equal to 5 microns making up less than or equal to about 50%, less than or equal to about 40%, less than or equal to about 30%, less than or equal to about 20%, less than or equal to about 10%, or less than or equal to about 5% of the microglass fibers of the layer. In some cases, a layer includes 0% of microglass fibers having an average diameter of greater than or equal to 5 microns. In some cases, more than one layer of a filter media includes such properties. It should be understood that, in certain instances, one or more layers of the filter media include microglass fibers within ranges different than those described above.

In certain embodiments, regardless of whether the glass fibers in a layer are microglass, chopped strand fibers, or combinations thereof, the weight percentage of glass fibers in one or more layers of the filter media (e.g., a non-woven layer comprising glass fibers and polymeric fibers) may be greater than or equal to about 1%, greater than or equal to about 2%, greater than or equal to about 4%, greater than or equal to about 8%, greater than or equal to about 10%, greater than or equal to about 15%, greater than or equal to about 20%, greater than or equal to about 25%, greater than or equal to about 30%, greater than or equal to about 35%, greater than or equal to about 40%, greater than or equal to about 45%, greater than or equal to about 50%, greater than or equal to about 60%, greater than or equal to about 70%, or greater than or equal to about 80% of the fibers in a layer. In some instances, the weight percentage of glass fibers in a layer may be less than or equal to about 99%, less than or equal to about 97%, less than or equal to about 95%, less than or equal to about 92%, less than or equal to about 90%, less than or equal to about 85%, less than or equal to about 80%, less than or equal to about 75%, less than or equal to about 70%, less than or equal to about 60%, less than or equal to about 55%, less than or equal to about 50%, less than or equal to about 45%, less than or equal to about 40%, less than or equal to about 35%, or less than or equal to about 30%, less than or equal to about 25%, less than or equal to about 20%, less than or equal to about 15%, less than or equal to about 10%, less than or equal to about 5%, less than or equal to about 3%, or less than or equal to about 2% of the fibers in the layer. Combinations of the above-referenced ranges are possible (e.g., a weight percentage of greater than or equal to about 1% and less than or equal to about 99% of the fibers in the layer, or greater than or equal to about 4% and less than or equal to about 95% of the fibers in the layer).

In certain embodiments, regardless of whether the glass fibers in a layer are microglass or chopped fibers, one or more layers of a filter media includes a large percentage of glass fiber (e.g., microglass fibers and/or chopped strand glass fibers). For example, one or more layers (e.g., the first and/or second layers) may comprise at least about 40 wt %, at least about 50 wt %, at least about 60 wt %, at least about 70 wt %, at least about 80 wt %, at least about 90 wt %, or at least about 95 wt % of glass fiber based on the total amount of fibers in the layer. In some cases, all of the fibers of a layer (e.g., the first and/or second layers) are formed of glass. It should be understood that, in certain embodiments, one or more layers of the filter media do not include glass fiber within the above-noted ranges or at all.

In some embodiments, regardless of whether the fibers in a layer are glass fibers (e.g., microglass or chopped fibers) and/or synthetic fibers, fibers having a fiber diameter less than or equal to 7 microns make up greater than about 60% by weight of the fibers, greater than about 70% by weight of the fibers, or greater than about 80% by weight of the fibers of a layer. In some cases, fibers having a fiber diameter less than or equal to 5 microns make up greater than about 60% by weight of the fibers, greater than about 70% by weight of the fibers, or greater than about 80% by weight of the fibers of a layer. In some cases, fibers having a fiber diameter less than or equal to 3 microns make up greater than about 50% by weight of the fibers, greater than about 60% by weight of the fibers, or greater than about 70% by weight of the fibers of a layer.

In one particular set of embodiments, regardless of whether the fibers in a layer are glass fibers (e.g., microglass or chopped fibers) and/or synthetic fibers, a filter media includes a first layer (e.g., a pre-filter layer) having an average fiber diameter of between about 1.0 microns and about 20.0 microns, e.g., about 1.0 microns and about 10.0 microns, between about 1.0 micron and about 8.0 microns. A second layer of the filter media (e.g., a main filter layer) may have an average fiber diameter of between about 1.0 micron and about 10.0 microns, e.g., between about 0.5 micron and about 6 microns. If the filter media includes a third layer (e.g., downstream of the second layer), the third layer may have an average fiber diameter of between about 0.1 microns and about 6.0 microns, e.g., between about 0.8 micron and about 5.0 microns, between about 0.5 micron and about 2.5 microns or between about 0.1 and about 1.5 microns. Other ranges are also possible. Additional layers are also possible.

As described herein, in some embodiments, a layer of the filter media (e.g., a second layer such as a main filtration layer) may comprise a blend of glass fibers and polymeric staple fibers having a relatively small diameter. In some embodiments, the polymeric staple fibers in a layer may have an average diameter of less than or equal to about 20 microns, less than or equal to about 15 microns, less than or equal to about 10.5 microns, less than or equal to about 10 microns, less than or equal to about 8 microns, less than or equal to about 6 microns, less than or equal to about 4 microns, less than or equal to about 3 microns, less than or equal to about 2 microns, less than or equal to about 1 micron, less than or equal to about 0.9 microns, less than or equal to about 0.8 microns, less than or equal to about 0.6 microns, less than or equal to about 0.5 microns, less than or equal to about 0.4 microns, or less than or equal to about 0.2 microns. In some instances, the average fiber diameter of the polymeric stable fibers within a layer may be greater than or equal to about 0.1 microns, greater than or equal to about 0.2 microns, greater than or equal to about 0.3 microns, greater than or equal to about 0.5 microns, greater than or equal to about 1 micron, greater than or equal to about 2 microns, greater than or equal to about 4 microns, greater than or equal to about 6 microns, or greater than or equal to about 8 microns. Combinations of the above-referenced ranges are also possible. For instance, in certain embodiments, the average diameter of the polymeric staple fibers may be, for example, between about 0.1 microns and about 10.5 microns, between about 0.25 microns and about 10 microns, between about 0.5 microns and about 10 microns, between about 1 micron and about 10 microns, between about 0.1 microns and about 6 microns, between about 0.25 microns and about 6 microns, between about 0.5 microns and about 6 microns, between about 1 micron and about 6 microns, between about 0.1 microns and about 3 microns, between about 0.2 microns and about 3 microns, between about 0.5 micron and about 3 microns, or between about 1 micron and about 3 microns. Average diameters of less than 1 micron are also possible (e.g., between about 0.2 microns to about 1 micron, between about 0.3 microns to about 0.9 microns).

Generally, the polymeric stable fibers are non-continuous fibers. That is, the polymeric staple fibers are generally cut (e.g., from a filament) or formed as non-continuous discrete fibers to have a particular length or a range of lengths. In some embodiments, the polymeric staple fibers may have a length of less than or equal to about 55 mm, less than or equal to about 40 mm, less than or equal to about 20 mm, less than or equal to about 10 mm, less than or equal to about 5 mm, less than or equal to about 3 mm, less than or equal to about 2 mm, less than or equal to about 1 mm, less than or equal to about 0.75 mm, less than or equal to about 0.5 mm, less than or equal to about 0.2 mm, or less than or equal to about 0.1 mm. In some instances, the polymeric staple fibers may have a length of greater than or equal to about 0.02 mm, greater than or equal to about 0.03 mm, greater than or equal to about 0.05 mm, greater than or equal to about 0.1 mm, greater than or equal to about 0.2 mm, greater than or equal to about 0.5 mm, greater than or equal to about 0.75 mm, greater than or equal to about 1 mm, greater than or equal to about 5 mm, greater than or equal to about 10 mm, greater than or equal to about 20 mm, or greater than or equal to about 40 mm. Combinations of the above-referenced ranges are possible (e.g., greater than or equal to about 0.02 mm and less than or equal to about 55 mm, greater than or equal to about 0.03 mm and less than or equal to about 55 mm).

In general, the polymeric staple fibers may have any suitable composition. Non-limiting examples of the polymers include polyester (e.g., polycaprolactone), cellulose acetate, polymethyl methacrylate, polystyrene, polyaniline, polypropylene, polyamide, polyaramid (e.g. para-aramid, meta-aramid), polyimide (e.g., polyetherimide), polyethylene, polyether ketone, polyethylene terephthalate, polyolefin, nylon, polyacrylics, polyvinylalcohol, polyether sulfones, poly(phenylene ether sulfone), polysulfones, polyethylenes, polyacrylonitrile, polyvinylidene fluoride, polybutylene terephthalate, poly(lactic acid), polyphenylene oxide, polycarbonate, polyurethane, polycaprolactone, polypyrrole, zein, and combinations or copolymers (e.g., block copolymers) thereof.

The weight percentage of polymeric stable fibers (e.g., polymeric staple fibers having a relatively small diameter) in a layer, such as a non-woven layer, may vary. As described herein, such a layer may include a blend of the polymeric staple fibers with glass fibers. For instance, in some embodiments, the weight percentage of polymeric staple fibers (e.g., polymeric staple fibers having a relatively small diameter) in a layer may be greater than or equal to about 0.5%, greater than or equal to about 1%, greater than or equal to about 3%, greater than or equal to about 5%, greater than or equal to about 8%, greater than or equal to about 10%, greater than or equal to about 15%, greater than or equal to about 20%, greater than or equal to about 25%, greater than or equal to about 30%, greater than or equal to about 35%, greater than or equal to about 40%, greater than or equal to about 45%, greater than or equal to about 50%, greater than or equal to about 60%, greater than or equal to about 70%, or greater than or equal to about 80%, e.g., based on the total amount of fibers in a layer. In some instances, the weight percentage of polymeric staple fibers in a layer may be less than or equal to about 99.5%, less than or equal to about 99%, less than or equal to about 98%, less than or equal to about 96%, less than or equal to about 92%, less than or equal to about 90%, less than or equal to about 85%, less than or equal to about 80%, less than or equal to about 75%, less than or equal to about 70%, less than or equal to about 60%, less than or equal to about 55%, less than or equal to about 50%, less than or equal to about 45%, less than or equal to about 40%, less than or equal to about 35%, less than or equal to about 30%, less than or equal to about 25%, less than or equal to about 20%, less than or equal to about 15%, less than or equal to about 10%, or less than or equal to about 5%, e.g., based on the total amount of fibers in a layer. Combinations of the above-referenced ranges are possible (e.g., greater than or equal to about 1% and less than or equal to about 99%, or greater than or equal to about 5% and less than or equal to about 96%).

In some embodiments, a fiber web may comprise two or more types of polymeric staple fibers that include at least one differing characteristic (e.g., fiber diameter, fiber length, and/or fiber composition) in a blend with glass fibers. For example, the fiber web may comprise polymeric staple fibers having an average diameter of less than 1 micron and polymeric staple fibers having an average diameter of between 1 micron and about 10 microns (e.g., between 1 micron and about 6 microns). In some such embodiments, the weight percentage of polymeric staple fibers in a layer that have a fiber diameter of less than 1 micron may be greater than or equal to about 1%, greater than or equal to about 3%, greater than or equal to about 5%, greater than or equal to about 8%, greater than or equal to about 10%, greater than or equal to about 15%, greater than or equal to about 20%, greater than or equal to about 25%, greater than or equal to about 30%, greater than or equal to about 35%, greater than or equal to about 40%, greater than or equal to about 45%, greater than or equal to about 50%, greater than or equal to about 60%, greater than or equal to about 70%, or greater than or equal to about 80% e.g., based on the total amount of fibers in a layer. In some instances, the weight percentage of polymeric staple fibers having a fiber diameter of less than 1 micron may be less than or equal to about 99%, less than or equal to about 98%, less than or equal to about 96%, less than or equal to about 92%, less than or equal to about 90%, less than or equal to about 85%, less than or equal to about 80%, less than or equal to about 75%, less than or equal to about 70%, less than or equal to about 60%, less than or equal to about 55%, less than or equal to about 50%, less than or equal to about 45%, less than or equal to about 40%, less than or equal to about 35%, or less than or equal to about 30%, less than or equal to about 25%, less than or equal to about 20%, or less than or equal to about 15%, e.g., based on the total amount of fibers in a layer. Combinations of the above-referenced ranges are possible (e.g., greater than or equal to about 3% and less than or equal to about 98%, greater than or equal to about 5% and less than or equal to about 96%).

In some embodiments involving a fiber web comprising two or more types of polymeric staple fibers, the weight percentage of polymeric staple fibers having an average fiber diameter of between 1 micron and about 10 microns (e.g., between 1 micron and about 6 microns) may be greater than or equal to about 1%, greater than or equal to about 3%, greater than or equal to about 5%, greater than or equal to about 8%, greater than or equal to about 10%, greater than or equal to about 15%, greater than or equal to about 20%, greater than or equal to about 25%, greater than or equal to about 30%, greater than or equal to about 35%, greater than or equal to about 40%, greater than or equal to about 45%, greater than or equal to about 50%, greater than or equal to about 60%, greater than or equal to about 70%, or greater than or equal to about 80%, e.g., based on the total amount of fibers in a layer. In some instances, the weight percentage of polymeric staple fibers having an average fiber diameter of between 1 micron and about 10 microns (e.g., between 1 micron and about 6 microns) may be less than or equal to about 99%, less than or equal to about 98%, less than or equal to about 96%, less than or equal to about 92%, less than or equal to about 90%, less than or equal to about 85%, less than or equal to about 80%, less than or equal to about 75%, less than or equal to about 70%, less than or equal to about 60%, less than or equal to about 55%, less than or equal to about 50%, less than or equal to about 45%, less than or equal to about 40%, less than or equal to about 35%, less than or equal to about 30%, less than or equal to about 25%, less than or equal to about 20%, or less than or equal to about 15%, e.g., based on the total amount of fibers in a layer. Combinations of the above-referenced ranges are possible (e.g., greater than or equal to about 3% and less than or equal to about 98%, greater than or equal to about 5% and less than or equal to about 96%).

In yet other embodiments, a layer of a filter media may include two or more types of polymeric staple fibers in which both types of polymeric staple fibers have an average fiber diameter of between 1 micron and about 10 microns (e.g., between 1 micron and about 8 microns, between 1 micron and about 6 microns). Each type of polymeric staple fiber may independently have a weight percentage in a range described above, and a fiber diameter in a range described above.

In some embodiments, a layer of the filter media (e.g., a second layer, first layer) may have a basis weight of less than or equal to about 500 g/m², less than or equal to about 450 g/m², less than or equal to about 400 g/m², less than or equal to about 350 g/m², less than or equal to about 300 g/m², less than or equal to about 250 g/m², less than or equal to about 200 g/m², less than or equal to about 150 g/m², less than or equal to about 100 g/m², or less than or equal to about 50 g/m². In some embodiments, the basis weight may be greater than or equal to about 5 g/m², greater than or equal to about 10 g/m², greater than or equal to about 25 g/m², greater than or equal to about 50 g/m², greater than or equal to about 100 g/m², greater than or equal to about 150 g/m², greater than or equal to about 200 g/m², greater than or equal to about 250 g/m², greater than or equal to about 300 g/m², greater than or equal to about 350 g/m², greater than or equal to about 400 g/m², or greater than or equal to about 450 g/m². Combinations of the above-referenced ranges are also possible (e.g., greater than or equal to about 5 g/m² and less than or equal to about 500 g/m², greater than or equal to about 10 g/m² and less than or equal to about 400 g/m²). Other values of basis weight are also possible. As determined herein, the basis weight of the filter media is measured according to the Technical Association of the Pulp and Paper Industry (TAPPI) Standard T410. The values are expressed in grams per square meter or pounds per 3,000 square feet. Basis weight can generally be measured on a laboratory balance that is accurate to 0.1 grams.

In some embodiments, a layer of the filter media (e.g., a second layer) may have a relatively high dust holding capacity. In some embodiments, the second layer may have a DHC of greater than or equal to about 5 g/m², greater than or equal to about 10 g/m², greater than or equal to about 20 g/m², greater than or equal to about 40 g/m², greater than or equal to about 60 g/m², greater than or equal to about 80 g/m², greater than or equal to about 100 g/m², greater than or equal to about 125 g/m², greater than or equal to about 150 g/m², greater than or equal to about 175 g/m², greater than or equal to about 200 g/m², greater than or equal to about 225 g/m², greater than or equal to about 250 g/m², greater than or equal to about 275 g/m², or greater than or equal to about 300 g/m². In some instances, the DHC of the second layer may be less than or equal to about 350 g/m², less than or equal to about 325 g/m², less than or equal to about 300 g/m², less than or equal to about 275 g/m², less than or equal to about 250 g/m², less than or equal to about 225 g/m², less than or equal to about 200 g/m², less than or equal to about 180 g/m², less than or equal to about 150 g/m², less than or equal to about 125 g/m², less than or equal to about 100 g/m², or less than or equal to about 75 g/m². Combinations of the above-referenced ranges are also possible (e.g., a DHC of greater than about 10 g/m² and less than or equal to about 350 g/m², a DHC of greater than about 20 g/m² and less than or equal to about 300 g/m², a DHC of greater than about 10 g/m² and less than or equal to about 200 g/m², a DHC of greater than about 10 g/m² and less than or equal to about 200 g/m²). Other values of dust holding capacity are also possible. Dust holding capacity can be measured as described in more detail below.

The air permeability of a layer of the filter media (e.g., a second layer) can also be varied as desired. For instance, in some embodiments, the layer (e.g., a second layer) may have an air permeability of greater than or equal to about 1 cfm/sf, greater than or equal to about 3 cfm/sf, greater than or equal to about 5 cfm/sf, greater than or equal to about 10 cfm/sf, greater than or equal to about 25 cfm/sf, greater than or equal to about 50 cfm/sf, greater than or equal to about 100 cfm/sf, greater than or equal to about 150 cfm/sf, greater than or equal to about 200 cfm/sf, or greater than or equal to about 250 cfm/sf. In some instances, the layer may have an air permeability of less than or equal to about 300 cfm/sf, less than or equal to about 275 cfm/sf, less than or equal to about 250 cfm/sf, less than or equal to about 225 cfm/sf, less than or equal to about 200 cfm/sf, less than or equal to about 175 cfm/sf, less than or equal to about 150 cfm/sf, less than or equal to about 125 cfm/sf, less than or equal to about 100 cfm/sf, less than or equal to about 75 cfm/sf, less than or equal to about 50 cfm/sf, or less than or equal to about 25 cfm/sf. Combinations of the above-referenced ranges are also possible (e.g., greater than or equal to about 1 cfm/sf and less than or equal to about 300 cfm/sf, greater than or equal to about 3 cfm/sf and less than or equal to about 250 cfm/sf). The air permeability can be measured as described in more detail below.

In some embodiments, a layer of the filter media (e.g., a second layer), and/or an overall filter media may have a relatively small pressure drop. For instance, in some embodiments, the pressure drop of may be less than or equal to about 80 kPa, less than or equal to about 70 kPa, less than or equal to about 60 kPa, less than or equal to about 50 kPa, less than or equal to about 40 kPa, less than or equal to about 30 kPa, less than or equal to about 20 kPa, less than or equal to about 10 kPa, less than or equal to about 4.5 kPa, or less than or equal to about 1 kPa. In some instances, the pressure drop may be greater than or equal to about 0.05 kPa, greater than or equal to about 0.1 kPa, greater than or equal to about 0.5 kPa, greater than or equal to about 1 kPa, greater than or equal to about 5 kPa, greater than or equal to about 10 kPa, greater than or equal to about 20 kPa, greater than or equal to about 30 kPa, greater than or equal to about 40 kPa, or greater than or equal to about 50 kPa. Combinations of the above-referenced ranges are also possible (e.g., greater than or equal to about 0.05 kPa and less than or equal to about 80 kPa, greater than or equal to about 0.1 kPa and less than or equal to about 50 kPa). As used herein, the pressure drop refers to a flatsheet pressure drop determined using ISO 3968. The pressure drop value is measured with clean hydraulic fluid at 15 cSt with a face velocity of 0.67 cm/s.

In some embodiments, a layer of the filter media (e.g., a second layer), and/or an overall filter media may have a mean flow pore size of greater than or equal to about 0.1 micron, greater than or equal to about 0.2 microns, greater than or equal to about 0.5 microns, greater than or equal to about 1 microns, greater than or equal to about 10 microns, greater than or equal to about 30 microns, greater than or equal to about 50 microns, greater than or equal to about 70 microns, greater than or equal to about 90 microns, greater than or equal to about 110 microns, or greater than or equal to about 130 microns. In some instances, the second layer and/or the overall filter media may have an average mean flow pore size of less than or equal to about 150 microns, less than or equal to about 140 microns, less than or equal to about 120 microns, less than or equal to about 100 microns, less than or equal to about 80 microns, less than or equal to about 60 microns, less than or equal to about 40 microns, less than or equal to about 20 microns, less than or equal to about 10 microns, less than or equal to about 5 microns, less than or equal to about 1 micron, or less than or equal to about 0.5 microns. Combinations of the above-referenced ranges are also possible (e.g., greater than or equal to about 0.1 micron and less than or equal to about 150 microns, greater than or equal to about 0.2 micron and less than or equal to about 100 microns, greater than or equal to about 0.2 micron and less than or equal to about 10 microns). As used herein, the mean flow pore size refers to the mean flow pore size measured by using a Capillary Flow Porometer manufactured by Porous Materials, Inc. in accordance with the ASTM F316-03 standard.

As described in more detail below, the efficiency of a layer or media can be expressed in terms of a beta ratio, or a micron rating for beta efficiency. In some embodiments, a layer of the filter media (e.g., a second layer), and/or the overall filter media may have a relatively low micron rating for beta efficiency (e.g., beta 200); that is, the minimum particle size for achieving a particular efficiency (e.g., a beta 200 efficiency or an efficiency of 99.5%) may be relatively low. For instance, in some instances, the micron rating for beta efficiency (e.g., beta 200) may be less than or equal to about 30 microns, less than or equal to about 28 microns, less than or equal to about 25 microns, less than or equal to about 24 microns, less than or equal to about 22 microns, less than or equal to about 20 microns, less than or equal to about 18 microns, less than or equal to about 16 microns, less than or equal to about 14 microns, less than or equal to about 12 microns, less than or equal to about 10 microns, less than or equal to about 8 microns, or less than or equal to about 5 microns. In some embodiments, the micron rating for beta efficiency (e.g., beta 200) may be greater than or equal to about 1 micron, greater than or equal to 2 microns, greater than or equal to 3 microns, greater than or equal to about 4 microns, greater than or equal to about 5 microns, greater than or equal to about 6 microns, greater than or equal to about 8 microns, greater than or equal to about 10 microns, greater than or equal to about 12 microns, greater than or equal to about 15 microns, greater than or equal to about 20 microns, or greater than or equal to about 25 microns. Combinations of the above-referenced ranges are possible (e.g., greater than or equal to about 1 micron and less than or equal to about 20 microns, greater than or equal to about 4 microns and less than or equal to about 10 microns). The micron rating for beta efficiency may be determined using the testing described for dust holding capacity and efficiency described herein.

In some embodiments, a layer (e.g., the first layer, and optionally the third layer), may be a pre-filter. In some such embodiments, the pre-filter layer(s) may be wet laid or non-wet laid (e.g., formed of a non-wet laid process such as a dry laid, meltblown, meltspinning, centrifugal spinning, electrospinning, spunbond, or air laid process). In some embodiments, the layer includes fibers formed of a synthetic polymer. Additionally or alternatively, a pre-filter layer may include glass fibers as described herein. It should be understood that the filter media may comprise any suitable number of pre-filter layers (e.g., at least 1, at least 2, at least 3, at least 4, at least 6, at least 8, at least 10 layers).

In certain embodiments, a pre-filter (which may include one or more layers) may have an average fiber diameter of between about 0.1 to about 40 microns, a basis weight of between about 5 gsm to about 450 gsm, a mean flow pore size of between about 4 microns to about 100 microns, and an air permeability of between about 10 cfm/sf to about 800 cfm/sf. Other ranges are also possible, as described in more detail below.

In general, the pre-filter layer(s) may be formed from any suitable fibers. Regardless of the fiber type, the average diameter of the fibers in a pre-filter layer may be, for example, greater than or equal to about 0.1 microns, greater than or equal to about 0.3 microns, greater than or equal to about 0.5 microns, greater than or equal to about 1 micron, greater than or equal to about 5 microns, greater than or equal to about 10 microns, greater than or equal to about 15 microns, greater than or equal to about 20 microns, greater than or equal to about 25 microns, greater than or equal to about 30 microns, or greater than or equal to about 35 microns. In some embodiments, the average diameter of the fibers in the pre-filter layer may be, for example, less than or equal to about 40 microns, less than or equal to about 35 microns, less than or equal to about 30 microns, less than or equal to about 25 microns, less than or equal to about 20 microns, less than or equal to about 15 microns, less than or equal to about 10 microns, less than or equal to about 5 microns, less than or equal to about 3 microns, less than or equal to about 1 micron, or less than or equal to about 0.5 microns. Combinations of the above-referenced ranges are also possible.

In some embodiments, regardless of the fiber content, the basis weight of one or more pre-filter layers may be greater than or equal to about 5 g/m², greater than or equal to about 10 g/m², greater than or equal to about 25 g/m², greater than or equal to about 50 g/m², greater than or equal to about 100 g/m², greater than or equal to about 150 g/m², greater than or equal to about 200 g/m², greater than or equal to about 250 g/m², greater than or equal to about 300 g/m², greater than or equal to about 350 g/m², greater than or equal to about 400 g/m², or greater than or equal to about 450 g/m². In some instances, the basis weight of one or more pre-filter layers may be less than or equal to about 500 g/m², less than or equal to about 450 g/m², less than or equal to about 400 g/m², less than or equal to about 350 g/m², less than or equal to about 300 g/m², less than or equal to about 250 g/m², less than or equal to about 200 g/m², less than or equal to about 150 g/m², less than or equal to about 100 g/m², or less than or equal to about 50 g/m². Combinations of the above-referenced ranges are also possible (e.g., greater than or equal to about 5 g/m² and less than or equal to about 500 g/m², greater than or equal to about 10 g/m² and less than or equal to about 400 g/m²). Other values of basis weight are also possible.

In some embodiments, the dust holding capacity of one or more pre-filter layers, or a combination of pre-filter layers (e.g., a dual-layer pre-filter), may be greater than or equal to about 20 g/m², greater than or equal to about 50 g/m², greater than or equal to about 80 g/m², greater than or equal to about 100 g/m², greater than or equal to about 125 g/m², greater than or equal to about 150 g/m², greater than or equal to about 175 g/m², greater than or equal to about 200 g/m², greater than or equal to about 225 g/m², greater than or equal to about 250 g/m², greater than or equal to about 275 g/m², or greater than or equal to about 300 g/m². In some instances, the DHC may be less than or equal to about 350 g/m², less than or equal to about 325 g/m², less than or equal to about 300 g/m², less than or equal to about 275 g/m², less than or equal to about 250 g/m², less than or equal to about 225 g/m², less than or equal to about 200 g/m², less than or equal to about 180 g/m², less than or equal to about 150 g/m², less than or equal to about 125 g/m², less than or equal to about 100 g/m², or less than or equal to about 75 g/m². Combinations of the above-referenced ranges are also possible (e.g., a DHC of greater than about 20 g/m² and less than or equal to about 300 g/m², a DHC of greater than about 50 g/m² and less than or equal to about 300 g/m²,). Other values of dust holding capacity are also possible.

In some embodiments, one or more pre-filter layers may have a micron rating for beta efficiency (e.g., beta 200) of greater than or equal to about 4 microns, greater than or equal to 5 microns, greater than or equal to about 6 microns, greater than or equal to about 8 microns, greater than or equal to about 10 microns, greater than or equal to about 12 microns, greater than or equal to about 15 microns, greater than or equal to about 20 microns, or greater than or equal to about 25 microns. In some instances, the micron rating for beta efficiency (e.g., beta 200) may be less than or equal to about 30 microns, less than or equal to about 28 microns, less than or equal to about 25 microns, less than or equal to about 24 microns, less than or equal to about 22 microns, less than or equal to about 20 microns, less than or equal to about 18 microns, less than or equal to about 16 microns, less than or equal to about 14 microns, less than or equal to about 12 microns, less than or equal to about 10 microns, or less than or equal to about 8 microns. Combinations of the above-referenced ranges are possible (e.g., greater than or equal to about 4 microns and less than or equal to about 30 microns).

In some embodiments, one or more pre-filter layers may have a mean flow pore size of greater than or equal to about 4 microns, greater than or equal to about 5 microns, greater than or equal to about 6 microns, greater than or equal to about 10 microns, greater than or equal to about 20 microns, greater than or equal to about 30 microns, greater than or equal to about 40 microns, greater than or equal to about 50 microns, greater than or equal to about 65 microns, or greater than or equal to about 80 microns. In some instances, one or more pre-filter layers may have a mean flow pore size of less than or equal to about 100 microns, less than or equal to about 90 microns, less than or equal to about 80 microns, less than or equal to about 70 microns, less than or equal to about 60 microns, less than or equal to about 50 microns, less than or equal to about 40 microns, less than or equal to about 25 microns, or less than or equal to about 10 microns. Combinations of the above-referenced ranges are also possible (e.g., greater than or equal to about 4 microns and less than or equal to about 100 microns, greater than or equal to about 5 microns and less than or equal to about 90 microns).

The air permeability of one or more pre-filter layers can also be varied as desired. For instance, in some embodiments, one or more pre-filter layers, or a combination of pre-filter layers (e.g., a dual-layer pre-filter), may have an air permeability of greater than or equal to about 10 cfm/sf, greater than or equal to about 25 cfm/sf, greater than or equal to about 50 cfm/sf, greater than or equal to about 100 cfm/sf, greater than or equal to about 150 cfm/sf, greater than or equal to about 200 cfm/sf, greater than or equal to about 250 cfm/sf, greater than or equal to about 300 cfm/sf, greater than or equal to about 350 cfm/sf, greater than or equal to about 400 cfm/sf, greater than or equal to about 500 cfm/sf, greater than or equal to about 600 cfm/sf, or greater than or equal to about 700 cfm/sf. In some instances, one or more pre-filter layers, or a combination of pre-filter layers (e.g., a dual-layer pre-filter), may have an air permeability of less than or equal to about 800 cfm/sf, less than or equal to about 700 cfm/sf, less than or equal to about 600 cfm/sf, less than or equal to about 500 cfm/sf, less than or equal to about 400 cfm/sf, less than or equal to about 375 cfm/sf, less than or equal to about 350 cfm/sf, less than or equal to about 325 cfm/sf, less than or equal to about 300 cfm/sf, less than or equal to about 275 cfm/sf, less than or equal to about 250 cfm/sf, less than or equal to about 225 cfm/sf, less than or equal to about 200 cfm/sf, less than or equal to about 175 cfm/sf, less than or equal to about 150 cfm/sf, less than or equal to about 125 cfm/sf, less than or equal to about 100 cfm/sf, less than or equal to about 75 cfm/sf, or less than or equal to about 50 cfm/sf. Combinations of the above-referenced ranges are also possible (e.g., greater than or equal to about 10 cfm/sf and less than or equal to about 800 cfm/sf, greater than or equal to about 10 cfm/sf and less than or equal to about 400 cfm/sf, greater than or equal to about 30 cfm/sf and less than or equal to about 350 cfm/sf).

In some embodiments, filter media 5 of FIG. 1 and/or filter media 10 of FIG. 2 is designed such that the average fiber diameters of each layer are different. For example, the ratio of average fiber diameters between two layers (e.g., between a first layer and a second layer, between a second layer and a third layer, between a first layer and a third layer, or between an upstream layer and a downstream layer, etc.) may be less than 10:1, less than 7:1, less than 5:1, less than 4:1, less than 3:1, less than 2:1, or 1:1. Small differences in average fiber diameters between two layers may, in some instances, lead to relatively low resistance ratios between the layers. In turn, relatively low resistance ratios between the layers can result in the filter media having favorable properties such as high dust holding capacity at relatively low basis weights, as described in more detail below.

Alternatively, two layers may have larger differences in average fiber diameters. For example, the ratio of average fiber diameters between two layers (e.g., between a first layer and a second layer, between a second layer and a third layer, or between a first layer and a third layer, etc.) may be greater than 1:1, greater than 2:1, greater than 3:1, greater than 4:1, greater than 5:1, greater than 7:1, or greater than 10:1.

The first or second layer, can generally have any suitable thickness. In some embodiments, the first or second layer may have a thickness of at least about 5 microns (e.g., at least about 10 microns, at least about 20 microns, at least about 30 microns, at least about 50 microns, at least about 80 microns, at least about 100 microns), and/or less than or equal to about 500 microns (e.g., less than or equal to about 400 microns, less than or equal to about 200 microns, less than or equal to about 180 microns, less than or equal to about 150 microns). For example, the layer may have a thickness from about 5 microns to about 500 microns (e.g., from about 5 microns to about 250 microns, from about 10 microns to about 200 microns, from about 20 microns to about 150 microns, from about 30 microns to about 500 microns, from about 50 microns to about 100 microns). Combinations of the above-referenced ranges are also possible for each layer, and for different layers within a filter media. Thickness, as referred to herein, is determined according to TAPPI T411 using an appropriate caliper gauge (e.g., a Model 200-A electronic microgauge manufactured by Emveco, tested at 1.5 psi). In some cases, if the thickness of a layer cannot be determined using an appropriate caliper gauge, visual techniques such as scanning electron microscopy in cross-section view can be used.

As described herein, in addition to or in place of glass fibers, one or more layers of the filter media may include components such as synthetic fibers (e.g., synthetic polymer fibers). For instance, one or more layers of filter media 5 of FIG. 1 or filter media 10 of FIG. 2 may include a relatively high percentage of synthetic fibers, e.g., at least about 50 wt %, at least about 60 wt %, at least about 70 wt %, at least about 80 wt %, at least about 90 wt %, at least about 95 wt %, at least about 97 wt %, or at least about 99 wt %, or 100 wt % synthetic fibers (e.g., synthetic polymer fibers). In some cases, at least two layers of the filter media, or the entire filter media, includes such percentages of synthetic fibers. Advantageously, synthetic fibers may be beneficial for resistance to moisture, heat, long-term aging, and microbiological degradation. In other embodiments, synthetic fibers comprise a small weight percentage of the filter media. For example, one or more layers of the filter media may include less than or equal to about 25 wt %, less than or equal to about 15 wt %, less than or equal to about 5 wt %, or less than or equal to about 2 wt % of synthetic fibers. In some cases, one or more layers of a filter media do not include any synthetic fiber. It should be understood that it may also be possible for synthetic fibers to be incorporated within the filter media outside of the ranges disclosed. The synthetic fibers may enhance adhesion of the glass fibers within the web during processing. Synthetic fibers may be, for example, binder fibers, bicomponent fibers (e.g., bicomponent binder fibers) and/or staple fibers.

In general, the synthetic fibers in any layer may have any suitable composition. In some cases, the synthetic fibers comprise a thermoplastic. Non-limiting examples of the synthetic polymers that can be used to form fibers include PVA (polyvinyl alcohol), polyester (e.g., polybutylene terephthalate, polybutylene naphthalate, polycaprolactone), polyethylene, polypropylene, acrylic, polyolefin, polyamides (e.g., nylon), rayon, polycarbonates, polyphenylene sulfides, polystyrenes, polybutylene terephthalate, and polyurethanes (e.g., thermoplastic polyurethanes), regenerated cellulose, cellulose acetate, polymethyl methacrylate, polyaniline, polyaramid (e.g. para-aramid, meta-aramid), polyimide (e.g., polyetherimide), polyether ketone, polyethylene terephthalate, polyolefin, polyacrylics, polyether sulfones, poly(phenylene ether sulfone), polysulfones, polyacrylonitrile, polyvinylidene fluoride, poly(lactic acid), polyphenylene oxide, polypyrrole, zein, and combinations or copolymers (e.g., block copolymers) thereof. Optionally, the polymer(s) or copolymer(s) may contain fluorine atoms. Examples of such polymers include PVDF, PVDF-HFP (hexafluoropropylene) and PTFE. It should be appreciated that other appropriate synthetic fibers may also be used. In some embodiments, the synthetic fiber is chemically stable with hydraulic fluids for hydraulic applications and/or with fuel for fuel applications. The synthetic fiber may be formed by any suitable process such as meltblown, meltspun, melt electrospinning and/or solvent electrospinning processes.

In one set of embodiments, the synthetic fibers are bicomponent fibers. Each component of the bicomponent fiber can have a different melting temperature. For example, the fibers can include a core and a sheath where the activation temperature of the sheath is lower than the melting temperature of the core. This allows the sheath to melt prior to the core, such that the sheath binds to other fibers in the layer, while the core maintains its structural integrity. This is particularly advantageous in that it creates a more cohesive layer for trapping filtrate. The core/sheath binder fibers can be concentric or non-concentric, and exemplary core/sheath binder fibers can include the following: a polyester core/copolyester sheath, a polyester core/polyethylene sheath, a polyester core/polypropylene sheath, a polypropylene core/polyethylene sheath, and combinations thereof. Other exemplary bicomponent fibers can include split fiber fibers, side-by-side fibers, and/or “island in the sea” fibers.

Alternatively, one or more layers of the filter media can include other fiber types such as cellulose pulp fibers (e.g., wood pulp fibers) and carbon fibers.

In some embodiments, one or more layers and/or the entire filter media, in addition to a plurality of fibers, may also include other components, such as a resin, surface treatments, and/or additives. In general, any suitable resin may be used to achieve the desired properties. For example, the resin may be polymeric, water-based, solvent-based, dry strength, and/or wet strength.

For instance, the filter media may also include a binder resin. The binder resin typically comprises a small weight percentage of the filter media. For example, the binder may comprise less than or equal to about 10 wt %, or less than or equal to about 5 wt % (e.g., between about 2 wt % and about 5 wt %) of the filter media. In some embodiments, the binder resin may be about 4 wt % of the filter media. As described further below, the binder resin may be added to the fibers in the wet fiber web state. In some embodiments, the binder resin coats the fibers and is used to adhere fibers to each other to facilitate adhesion between the fibers.

Various types of resins that may be used to form a coating on one or more layers (e.g., second layer, third layer) and/or the entire filter media are further described below. The resin may be added to the fibers in any suitable manner including, for example, in a wet state or a non-wet state. In some embodiments, the coating coats the fibers and may be used to adhere fibers to each other to facilitate adhesion between the fibers.

In general, the coating (e.g., binder resin) applied to one or more layers (e.g., second layer, third layer) and/or the entire filter media may have any suitable composition.

A suitable binder resin may comprise a thermoplastic, a thermoset, or a combination thereof. For example, the binder resin may include one or more of the following resins: thermoplastic resin, thermoset resin, acrylic, acrylic resin (e.g., acrylic thermoset resin), epoxy, vinyl acrylic, latex emulsion, nitrile, styrene, styrene-acrylic, styrene butadiene rubber, polyvinyl chloride, ethylene vinyl chloride, polyolefin, polyvinyl halide, polyvinyl ester, polyvinyl ether, polyvinyl sulfate, polyvinyl phosphate, polyvinyl amine, polyamide, polyimide, polyoxidiazole, polytriazol, polycarbodiimide, polysulfone, polycarbonate, polyether, polyarylene oxide, polyester, polyarylate, phenolics, phenolic resin, phenol-formaldehyde resin, polyacrylamide, epichlorohydrin, melamine-formaldehyde resin, formaldehyde-urea, vinyl acetate, ethylene vinyl acetate, polyvinyl acetate, ethyl-vinyl acetate copolymer, and/or other suitable compositions. The resin may be anionic, cationic, or non-ionic in nature. The resin may be provided as an aqueous or non-aqueous solvent-based system.

In some embodiments, the coating includes one or more polymeric resins, for example, polyacrylates, polyurethanes, polycarbonates, polyesters, polyterpenes, furan polymers (e.g., polyfurfural alcohol), epoxies, dicyandiamide, 2-methyl imidazole amines, mercaptan (thiol), phenolic systems using resoles and/or novolacs, terpene phenolics, bismaleimides, cyanate esters, ethylol melamines, methylol ureas, methylol adducts of organic bases, guanidine guanylureas, biurets, triurets, polyphenol, acrylic emulsions, acrylic copolymer binder resins, saturated resins, unsaturated resins, or other compositions.

The coating of one or more layers (e.g., second layer, third layer) and/or the entire filter media may employ any suitable solvent, such as solvent based resins (e.g., thermoplastic, thermoset) or water-based resins. In some embodiments, the solvent of the coating may include, for instance, acetone, water, methanol, aliphatic alcohol (e.g., ethanol, N-propanol, iso-propanol, N-butyl alcohol, iso-butyl alcohol, branched alkyl alcohol, unbranched alkyl alcohol, ethylene glycol, diethylene glycol, higher homologs of diethylene glycol, glycerine, pentaerythritol, diacetone alcohol, etc.), aromatic alcohol (e.g., phenol, benzyl alcohol, alkyl-substituted benzyl alcohol, o-cresol, m-cresol, p-cresol, catechol, alkyl-substituted catechol, resorcinol, alkyl-substituted resorcinol, etc.), aromatic ketone, aliphatic ketone (e.g., acetone, methyl ethyl ketone, cyclohexanone, diethyl ketone, diisopropyl ketone, methyl iso-butyl ketone, methyl amyl ketone, methyl iso-amyl ketone, etc.), ester (e.g., ethyl acetate, methyl acetate, butyl acetate, iso-butyl acetate, amyl acetate, iso-amyl acetate, benzyl acetate, methyl lactate, ethyl lactate, methyl benzoate, dibasic esters, mono-alkyl esters of adipic/glutaric/succinic acid, di-alkyl esters of adipic/glutaric/succinic acid, ethyl benzoate, iso-propyl benzoate, ethyleneglycol ethylether acetate, ethyleneglycol methylether acetate, diethyleneglycol ethylether acetate, diethyleneglycol methylether acetate, propyleneglycol methylether acetate, propyleneglycol ethylether acetate, ethoxyethyl propionate, phenoxyethyl acetate, tripropyleneglycol diacetate, hexanediol acetate, etc.), reactive diluent (e.g., acrylate, methacrylate, etc.), nitrile solvents (e.g., acetonitrile, propionitrile, butyronitrile, etc.), ether (e.g., dimethyl ether, diethyl ether, di-iso-propyl ether, tetrahydrofuran, dioxanes, diphenyl ether, dimethyoxyethane, glycol ether, half ether, ethyleneglycol alkyl ether, diethyleneglycol dialkyl ether, diethyleneglycol monoalkyl ether, propylene glycol dialkyl ether, propylene glycol monoalkyl ether, dipropyleneglycol dialkyl ether, dipropyleneglycol monoalkyl ether, etc.), chlorinated solvent (e.g., chloroform, dichloromethane, dichloroethane, chlorobenxene, P-chloro benzotrifluoride, etc.), aliphatic solvent (e.g., pentane, hexane, heptane, octane, branched isomer, higher homologs, 2-ethylhexane, 2,2,4-trimethylpentane, ligroin, hydrocarbon mixtures, petroleum ether, mineral spirits, white spirits, naptha, terpene, monoterpene, geraniol, limonene, terpineol, sesquiterpenes, humulene, farnesene, farnesol, diterpene, cafestol, kahweol, cembrene, turpentine, terpeneoid), aromatic solvent (e.g., benzene, toluene, xylene, mesitylene, ethyl benzene, pyridine, alkyl-substituted pyridine, etc.), amide solvent (e.g., formamide, methyl formamide, dimethyl formamide, acetamide, methylacetamide, dimethyl acetamide, etc.), lactam solvent (e.g., pyrrolidone, pyrolidinone, N-methyl pyrrolidone, N-methyl pyrolidinone, alkyl N-substituted pyrolidone, etc.), sulfoxide, dimethyl sulfoxide, sulfone solvent, dimethyl sulfone, acid anhydride solvent, acetic acid, acetic anhydride, propionic acid, propionic anhydride, carbon dioxide, carbon disulfide, or others.

In some embodiments, a binder resin used to form a coating on one or more layers (e.g., second layer, third layer) and/or the entire filter media may be a water-based resin (e.g., a water-based polymeric resin). Non-limiting examples of water-based polymer resins include acrylic resins, styrene resins, polyvinyl alcohol resins, and vinyl acetate resins, and combinations thereof. It should be appreciated that any suitable water-based polymeric resin may be utilized. In other embodiments, the binder resin used to form a coating on one or more layers (e.g., second layer, third layer) and/or the entire filter media may be a non-aqueous solvent-based resin (e.g., an organic solvent-based polymeric resin), e.g., including one or more of the organic solvents described herein. In some embodiments, resins including mixtures of water and organic solvents (e.g., water-miscible organic solvents) can be used. Combinations of aqueous-based and non-aqueous based resins are also possible.

In some embodiments, one or more layers (e.g., second layer, third layer) and/or the entire filter media may be coated with a resin (e.g., a pre-cured resin) that includes at least two components (e.g., a first component and a second component). As discussed above, various components in the resin may undergo a chemical reaction with one another (e.g., upon curing) to form a reaction product. Additionally, in some cases, a component in the resin may react with itself. For instance, a component in the form of a monomer (e.g., an epoxy monomer) may polymerize to form a homopolymer (e.g., polyepoxide). In some cases, a component may react with another component in the resin, e.g., to form a copolymer. For example, a first monomer (e.g., an epoxy monomer) in the resin may react with another component in the resin, such as a second monomer or a polymer (e.g., a copolyester), to form a branched polymer, a linear polymer, a copolymer, a crosslinked network, or combinations thereof.

In some embodiments, a component in the resin may undergo more than one chemical reaction. For instance, a component in the resin may react with itself and with a second component in the resin. In one example, a monomer (e.g., an epoxy monomer) in the resin may react with itself to form an oligomer or polymer, which may react with a polymer in the resin to form a copolymer. In some cases, more than one chemical reaction may occur simultaneously and/or sequentially. In some embodiments, after the formation of a reaction product in the resin (e.g., by reaction of a first component with itself, or by reaction of a first component with a second component), the reaction product may undergo a chemical reaction. For example, a copolymer (e.g., a reaction product of a first component such as a copolyester and second component such as an epoxy monomer) may react with a polymer (e.g., a third component, or more of the first component) to form a polymer network (e.g., a cured or crosslinked network). In certain cases, a reaction product in the resin may react with itself to form a longer chained polymer that may be branched or unbranched. For example, an oligomer (e.g., a reaction product of an epoxy monomer) may react with itself to form a polymer. A reaction product may also react with another reaction product in the resin. For instance, a first polymer (e.g., a reaction product of epoxy) may react with a second polymer (e.g., a reaction product of a polymer and a monomer) to form a copolymer.

In some embodiments, a reaction product in the resin may undergo more than one chemical reaction. For instance, a reaction product in the coating may react with itself and with another component in the coating. In one example, a first reaction product (e.g., a polymer such as a polyepoxide) may react with a second polymer in the resin to form a second reaction product (e.g., a copolymer). The first reaction product may optionally undergo another reaction, e.g., crosslinking with other first reaction products or second reaction products in the resin. When more than one chemical reaction takes place, the reactions may occur simultaneously and/or sequentially.

In other embodiments, a first component in the resin may be designed to react with itself but not another component (e.g., a second component) in the resin. Additionally, a second component may be designed to react with itself and not with the first component. Such components can be designed by tailoring the functional groups of the components as known to those of ordinary skill in the art. The two types of polymer chains formed may be intertwined with one another, but not covalently coupled, in the resulting coating.

In some embodiments, a component and/or reaction product in the resin may react to form a particular type of copolymer. Exemplary types of copolymers include alternating copolymers, periodic copolymers, random copolymers, dendrimer, terpolymers, quaterpolymers, graft copolymers, linear copolymer, and block copolymers.

In some embodiments, in general, a fiber web coated with a resin that includes at least two components as described herein may have enhanced mechanical and/or filtration properties compared to a fiber web coated with a resin that includes only a single component (e.g., a first component or a second component). In one example, a fiber web coated with a resin that includes a first component (e.g., a polymer) and a second component (e.g., an epoxy) may be stronger and/or more flexible (e.g., have higher elongation) than a fiber web coated with a resin that only includes one of the components (e.g., an epoxy resin). Other advantages are described herein.

In some embodiments, the first component is a reactive polymer (e.g., a linear polymer, a copolymer). The polymer may be a particular type (e.g., polyester) or in a particular class (e.g., thermoplastic). Non-limiting examples of types of polymers that may be suitable as a first component include polyethers, polyarylethers, polyalkyethers, polysulfone, polyarylsulfone, polyvinylchloride, polyether ether ketones, polyether ketones, polyethersulfones, polyolefins, rubbers, polystyrenes, styrene acrylates, styrene maleic anhydrides, polyvinyl alcohols, polyvinyl acetates, polyvinyl alcohol esters, polyvinyl amines and ammonium salts of polyvinylamines, polyvinyl amides and partially hydrolyzed polyvinylamides and ammonium salts of partially hydrolyzed vinylamides, polyacrylonitriles, polyparalenes, polyphenylenes, polyglycolides, poly(lactic-co-glycolic acid), polylactic acid, polycaprolactam, poly(glycolide-co-caprolactone), poly(glycolide-co-trimethylene carbonate), polysiloxanes, polyarylates, polyaminoacids, polylactams, polyhydantoins, polyketones, polyureas, polystyrene sulfonates, lignins, polyphosphazines, polyethylene chlorinates, polyetherimide, cellulose acetate, carboxymethyl cellulose, alkyds, polyacrylates, polyurethanes, polycarbonates, saturated polyesters, unsaturated polyesters, polyterpenes, furan polymers, polyfurfural alcohol, polyamides, polyimides, polyamidimides, polyamidoamines, copolymers thereof, and combinations thereof. Exemplary classes of polymers include thermoplastics and thermosets. Other types and classes of polymers are also possible.

In some embodiments, the first component is a copolymer. The copolymer may be, for example, an alternating copolymer, a periodic copolymer, a random copolymer, a dendrimer, a terpolymer, a quaterpolymer, a graft copolymer, a linear copolymer, or a block copolymer.

In some embodiments, the first component (e.g., a polymer) may have certain properties, such as number of repeat units (n), number average molecular weight (Mₙ), glass transition temperature (T_{g}), hydroxyl (OH) number, and/or acid number. In certain embodiments, the number of repeat units and number average molecular weight may be selected to impart desirable properties (e.g., enhanced solubility in the resin or resin solution, add flexibility and/or strength to the fiber web). For example, a first component with a relatively high number of repeat units and Mₙ may, in some embodiments, produce a more flexible and stronger (e.g., less brittle) coating than a first component with a relatively low number of repeat units and/or Mₙ. The glass transition temperature of the first component may be selected to enhance certain mechanical properties of the fiber web, such as elongation, strength, flexibility, and/or resistance to deformation.

In certain embodiments in which the first component (e.g., a polymer) includes hydroxyl (—OH) groups and acid groups, the OH number and acid number may be selected to impart reactive functionality for a chemical reaction. In some instances, the OH number and acid number of the first component may influence the number of chemical reactions that the first component (e.g., polymer) undergoes and/or the type of reaction products (e.g., a long chain copolymer, crosslinked network) that are formed. In turn, the number of chemical reactions and the type of reaction products in the coating may influence the mechanical properties of the fiber web. In one example, a first component with a relatively low OH number and/or acid number may undergo fewer chemical reactions than a first component with a relatively high OH number and/or acid number. A first component with a relatively low OH number and/or acid number may enhance the flexibility of the fiber web, whereas a first component with a relatively high OH number and/or acid number may produce a relatively more brittle coating on the fiber web.

In some instance, the first component (e.g., a polymer) may be selected based on a single property. For example, the first component may be selected based on its glass transition temperature. In other instances, the first component may be selected based on more than one property (e.g., T_{g}, Mₙ, and OH number). In certain embodiments, the criteria for selecting a first component may vary based on certain factors, such as other components in the resin and the intended application of the fiber web.

In some embodiments, the first component may be selected based on its number average molecular weight. For instance, the number average molecular weight of the first component may be greater than or equal to about 1,000 g/mol, greater than or equal to about 3,000 g/mol, greater than or equal to about 5,000 g/mol, greater than or equal to about 10,000 g/mol, greater than or equal to about 15,000 g/mol, greater than or equal to about 20,000 g/mol, greater than or equal to about 30,000 g/mol, or greater than or equal to about 40,000 g/mol. In some instances, the number average molecular weight of the first component may be less than or equal to about 50,000 g/mol, less than or equal to about 40,000 g/mol, less than or equal to about 30,000 g/mol, less than or equal to about 25,000 g/mol, less than or equal to about 20,000 g/mol, less than or equal to about 15,000 g/mol, less than or equal to about 10,000 g/mol, or less than or equal to about 5,000 g/mol. Combinations of the above-referenced ranges are also possible (e.g., greater than or equal to about 3,000 g/mol and less than or equal to about 40,000 g/mol). Other values of the number average molecular weight of the first component are also possible. The number average molecular weight may be determined using gel permeation chromatography (GPC), nuclear magnetic resonance spectrometry (NMR), laser light scattering, intrinsic viscosity, vapor pressure osmometry, small angle neutron scattering, laser desorption ionization mass spectrometry, matrix assisted laser desorption ionization mass spectrometry (MALDI MS), electrospray mass spectrometry or may be obtained from a manufacturer's specifications. Unless otherwise indicated the values of number average molecular weight described herein are determined by gel permeation chromatography (GPC).

In some embodiments, the first component may be selected based on its glass transition temperature (T_{g}). For instance, in some embodiments, the glass transition temperature of the first component may be greater than or equal to about −30° C., greater than or equal to about −15° C., greater than or equal to about 0° C., greater than or equal to about 15° C., greater than or equal to about 30° C., greater than or equal to about 45° C., greater than or equal to about 60° C., greater than or equal to about 75° C., or greater than or equal to about 90° C. In some instances, the glass transition temperature of the first component may be less than or equal to about 120° C., less than or equal to about 100° C., less than or equal to about 80° C., less than or equal to about 60° C., less than or equal to about 40° C., less than or equal to about 20° C., less than or equal to about 0° C., or less than or equal to about −20° C. Combinations of the above-referenced ranges are also possible (e.g., greater than or equal to about 15° C. and less than or equal to about 80° C.). Other values of glass transition temperature of the first component are also possible. The glass transition temperature of the first component may be determined using differential scanning calorimetry (DSC), thermomechanical analysis (TMA), dynamic mechanical analysis (DMA), or may be obtained from a manufacturer's specifications. Unless indicated otherwise, the values of glass transition temperature described herein are determined by differential scanning calorimetry (DSC).

In some embodiments, the first component may be selected based on its hydroxyl (OH) number. The OH number is the number of milligrams of potassium hydroxide equivalent, in number of moles, to the hydroxyl content in one gram of the component. The OH number of the first component may be, for example, greater than or equal to about 0, greater than or equal to about 2, greater than or equal to about 5, greater than or equal to about 10, greater than or equal to about 30, greater than or equal to about 50, greater than or equal to about 70, or greater than or equal to about 90. In some instances, the OH number of the first component may be less than or equal to about 100, less than or equal to about 80, less than or equal to about 60, less than or equal to about 40, less than or equal to about 20, or less than or equal to about 10. Combinations of the above-referenced ranges are also possible (e.g., greater than or equal to about 2 and less than or equal to about 60). Other values of the OH number of the first component are also possible. The OH number may be determined by acetylating the hydroxyls with excess acetic anhydride and titrating the acetic acid remaining after by the acetylation reaction.

In some embodiments, the first component may be selected based on its acid number. The acid number is the number of milligrams of potassium hydroxide equivalent, in number of moles, to the free acid content in one gram of the component. The acid number of the first component may be, for example, greater than or equal to about 0, greater than or equal to about 1, greater than or equal to about 3, greater than or equal to about 5, greater than or equal to about 10, greater than or equal to about 15, or greater than or equal to about 20. In some instances, the acid number of the first component may be less than or equal to about 25, less than or equal to about 20, less than or equal to about 15, less than or equal to about 10, less than or equal to about 5, or less than or equal to about 3. Combinations of the above-referenced ranges are also possible (e.g., greater than or equal to about 0 and less than or equal to about 10). Other values of the acid number of the first component are also possible. The acid number may be determined by titrating the acid to the equivalence point with potassium hydroxide.

In some embodiments, the weight percentage of the first component in the resin may be selected as desired. For instance, the weight percentage of the first component in the resin may be greater than or equal to about 1 wt %, greater than or equal to about 15 wt %, greater than or equal to about 20 wt %, greater than or equal to about 40 wt %, greater than or equal to about 55 wt %, greater than or equal to about 70 wt %, or greater than or equal to about 85 wt %. In some instances, the weight percentage of the first component in the resin may be less than or equal to about 99 wt %, less than or equal to about 90 wt %, less than or equal to about 75 wt %, less than or equal to about 60 wt %, less than or equal to about 45 wt %, less than or equal to about 30 wt %, or less than or equal to about 15 wt %. Combinations of the above-referenced ranges are also possible (e.g., greater than or equal to about 20 wt % and less than or equal to about 99 wt %). Other values of weight percentage of the first component in the resin are also possible. The weight percentage of the first component in the resin is based on the dry resin solids and can be determined prior to coating the fiber web.

As described herein, a resin that forms a coating on a fiber web may include a second component. The second component may be a reactive entity such as a polymerizable molecule. In some embodiments, the second component may have fewer than 5 to 20 repeat units (e.g., an oligomer) or no repeat units (e.g., a monomer). For example, the second component may include less than or equal to 20, less than or equal to 15, less than or equal to 10, less than or equal to 5, less than or equal to 3, or less than or equal to 2 repeat units. The second component may include one or more reactive functional groups which can allow the second component to undergo a chemical reaction to form a larger molecule (e.g., a polymer). Non-limiting examples of reactive functional groups include hydroxyl groups, carboxyl groups, amino groups, mercaptan groups, acrylate groups, oxirane groups, bismaleimide groups, isocyanate, methylol groups, alkoxymethylalol groups, and ester groups. In certain embodiments, the second component is capable of undergoing a chemical reaction (e.g., with itself and/or with a first component) to form an oligomer, a polymer, a linear polymer, a branched polymer, a copolymer, a crosslinked network, and/or a cured network.

In some embodiments, the second component may be characterized as a component that is part of a cure system. For example, the cure system may be a formulated resin system (e.g., thermoset resin system) including a second component in the form of a monomer (e.g., epoxy). Other components of the cure system may optionally be present in the resin formulations described herein. For example, in some cases, one or more initiators (e.g., triphenyl phosphine, dicyandiamide and 2-methylimidazole for an epoxy cure system) may be present. In certain cases, one or more reactive curatives (e.g., carboxylic acid monomers, carboxylic acid oligomers, carboxylic acid polymers, phenolic monomers, phenolic oligomers, phenolic polymers, amine curative agents, thiol curative agents, diamines, dithiols, polyimides, amidoamines, agents that are reactive with epoxy) may be present. In some embodiments, an initiator is required for chemical reactivity of the second component. In other cases, an initiator is not required but may accelerate the reaction rate for a reaction involving the second component.

Non-limiting examples of cure systems include epoxies, terpene phenolics, bismaleimides, cyanate esters, aminoplasts, methylol melamine, isocyanate resins, methylol urea, methylol adducts of organic bases, such as dicyandiamide, guanidine guanylurea, biuret, triuret, etc., and combinations thereof. Accordingly, examples of suitable second components may include mono-, di, tri, etc.-epoxides, poly-epoxides, terpene phenolics, bismaleimides, cyanate esters, methylol melamines, methylol ureas, isocyanate resins, methylol adducts of organic bases such as dicyandiamide, guanidine, guanylurea, biuret, triuret, etc., and combinations thereof. Exemplary optional initiators include dicyandiamide, 2-methylimidazole, mercaptan, hexamethylenetetramine, triphenylphosphine, and combinations thereof.

In some embodiments, the second component may have a certain number average molecular weight. For instance, the second component may have a number average molecular weight of less than or equal to about 3,000 g/mol, less than or equal to about 2,000 g/mol, less than or equal to about 1,000 g/mol, less than or equal to about 500 g/mol, less than or equal to about 250 g/mol, or less than or equal to about 100 g/mol. In some instances, the second component may have a number average molecular weight of greater than or equal to about 20 g/mol, greater than or equal to about 100 g/mol, greater than or equal to about 500 g/mol, greater than or equal to about 1,000 g/mol, or greater than or equal to about 2,000 g/mol. Combinations of the above-referenced ranges are also possible (e.g., greater than or equal to about 20 g/mol and less than or equal to about 3,000 g/mol). Other values of the number average molecular weight of the second component are also possible. The number average molecular weight may be determined as described above. The particular method used may depend on the type of second component being measured.

In some embodiments, the weight percentage of the second component in the resin may be selected as desired. For instance, the weight percentage of the second component in the resin may be greater than or equal to about 1 wt %, greater than or equal to about 10 wt %, greater than or equal to about 25 wt %, greater than or equal to about 40 wt %, greater than or equal to about 55 wt %, greater than or equal to about 70 wt %, or greater than or equal to about 85 wt %. In some instances, the weight percentage of the second component in the resin may be less than or equal to about 99 wt %, less than or equal to about 80 wt %, less than or equal to about 60 wt %, less than or equal to about 45 wt %, less than or equal to about 30 wt %, less than or equal to about 15 wt %, or less than or equal to about 5 wt %. Combinations of the above-referenced ranges are also possible (e.g., greater than or equal to about 1 wt % and less than or equal to about 60 wt %). Other values of weight percentage of the second component in the resin are also possible. The weight percentage of the second component in the resin is based on the percentage of the second component in the dry resin solids and can be determined prior to coating the fiber web.

For one or more layers (e.g., second layer, third layer) and/or the entire filter media that is coated with a resin that includes at least two components (e.g., a first component and a second component), the ratio of a first component (e.g., polymer) to a second component (e.g., monomer or oligomer) in the resin may be selected to impart desirable properties (e.g., mechanical properties, chemical reactivity, etc.). For instance, the ratio of a first component to a second component in the resin may be greater than or equal to about 0.01:1, greater than or equal to about 0.1:1, greater than or equal to about 1:1, greater than or equal to about 10:1, greater than or equal to about 20:1, greater than or equal to about 40:1, greater than or equal to about 60:1, or greater than or equal to about 80:1. In some instances, the ratio of a first component to a second component may be less than or equal to about 99:1, less than or equal to about 85:1, less than or equal to about 70:1, less than or equal to about 55:1, less than or equal to about 40:1, less than or equal to about 20:1, or less than or equal to about 5:1. Combinations of the above-referenced ranges are also possible (e.g., greater than or equal to about 1:1 and less than or equal to about 99:1). Other values of ratios of a first component to a second component are also possible. The ratio of a first component to a second component is based on the weight percentage of a first component in the resin to the weight percentage of a second component in the resin.

In some instances, the solvent of a resin may include a reactive diluent. For example, a solvent such as one listed above may be combined with a reactive diluent. In other instances, the solvent may be a reactive diluent. In some embodiments, the reactive diluent may react with a component described herein and may form a part of the coating/resin. Exemplary reactive diluents include (cyclo)aliphatic monoepoxides (e.g., 2-ethylhexyl diglycidyl ether, cyclohexane dimethanol diglycidyl ether), monoglycidyl ethers of fatty alcohols (e.g., stearyl alcohol), unsaturated (cyclo)alkyl monoepoxides (e.g., cyclohexenyl glycidyl ether, allyl glycidyl ether, vinyl glycidyl ether, aryl glycidyl ethers), difunctional aliphatic diglycidyl ethers (e.g., 1,4-butanediol diglycidyl ether, 1,6-hexanediol diglycidyl ether, neopentylglycol diglycidyl ether, dipropylene diglycidyl ether, polypropylene diglycidyl ether), acrylates, methacrylates, glycidyl (meth)acrylate, polyoxyamines, (cyclo)aliphatic amines, mannich bases, low molecular weight diols (e.g., ethylene glycol, propylene glycol), low molecular weight triols (e.g., glycerine), diamines (e.g., ethylene diamine, propylene diamine), dithiols, and combinations thereof.

To form a resin including at least two components, the at least two components may be combined with a predetermined amount of one or more solvents and sufficiently mixed to incorporate each component into the solvent(s). In some instances, incorporating a component into a solvent may involve dissolving the component in the solvent. In other instances, incorporating a component into a solvent may involve forming a suspension of the component in the solvent. A component may also be incorporated into a solvent by forming an emulsion. Other methods of incorporating a component into a solvent are also possible.

Any suitable coating method may be used to form a coating on one or more layers (e.g., second layer, third layer) and/or the entire filter media. In some embodiments, as discussed further below, a coating comprising a binder resin may be added to the fiber web (e.g., second layer, third layer) by a solvent saturation (e.g., by an organic or inorganic solvent) process and/or an aqueous-based (i.e., by a water based solvent) process. In some embodiments, the resin may be applied to a fiber web using a non-compressive coating technique. The non-compressive coating technique may coat the fiber web, while not substantially decreasing the thickness of the web. In other embodiments, the resin may be applied to the fiber web using a compressive coating technique. Non-limiting examples of coating methods include the use of a slot die coater, gravure coating, screen coating, size press coating (e.g., a two roll-type or a metering blade type size press coater), film press coating, blade coating, roll-blade coating, air knife coating, roll coating, foam application, reverse roll coating, bar coating, curtain coating, champlex coating, brush coating, Bill-blade coating, short dwell-blade coating, lip coating, gate roll coating, gate roll size press coating, laboratory size press coating, melt coating, dip coating, knife roll coating, spin coating, spray coating, gapped roll coating, roll transfer coating, padding saturant coating, and saturation impregnation. Other coating methods are also possible.

In some embodiments, one or more layers (e.g., second layer, third layer) and/or the entire filter media may be substantially saturated by the coating. For example, the coating may impregnate substantially all or the entirety of the layer(s).

In certain embodiments, a polymeric material can be impregnated into the fiber web either during or after the fiber web is being manufactured on a papermaking machine. For example, during a manufacturing process described herein, after the fiber web is formed and dried, a polymeric material in a water based emulsion or an organic solvent based solution can be adhered to an application roll and then applied to the article under a controlled pressure by using a size press or gravure saturator.

The amount of the polymeric material impregnated into the fiber web typically depends on the viscosity, solids content, and absorption rate of fiber web. As another example, after the fiber web is formed, it can be impregnated with a polymeric material by using a reverse roll applicator following the just-mentioned method and/or by using a dip and squeeze method (e.g., by dipping a dried filter media into a polymer emulsion or solution and then squeezing out the excess polymer by using a nip). A polymeric material can also be applied to the fiber web by other methods known in the art, such as spraying or foaming.

In some embodiments, the binder resin is precipitated on to the fibers. When appropriate, any suitable precipitating agent (e.g., Epichlorohydrin, fluorocarbon) may be provided to the fibers, for example, by injection into a fiber blend. In some embodiments, upon addition to the fiber blend, the binder resin is added in a manner such that the layer is impregnated with the binder resin (e.g., the binder resin permeates throughout the layer). In a multi-layered web, a binder resin may be added to each of the layers or to only some of the layers separately prior to combining the layers, or the binder resin may be added to the layers after combining the layers. In some embodiments, binder resin is added to the fiber blend while in a dry state, for example, by spraying or saturation impregnation, or any of the above methods. In other embodiments, a binder resin is added to a wet layer.

As discussed above, the binder resin may coat any suitable portion of the fiber web. In some embodiments, the coating of resin may be formed such that the surfaces of the fiber web are coated without substantially coating the interior of the fiber web. In some instances, a single surface of the fiber web may be coated (e.g., single side coating). For example, a top surface or layer of the fiber web may be coated.

As an example, a second layer may be formed on a third layer and the coating may be applied from the second layer side or the third layer side. In other instances, more than one surface of the second layer may be coated (e.g., the top and bottom surfaces or layers, dual side coating). In the example above, the coating may be applied to the second layer side and the third layer side simultaneously. In other embodiments, certain portions of a layer may be coated without substantially coating other portions of the layer. The coating may also be formed such that at least one surface or portion of a layer and the interior of the layer are coated. In some embodiments, the entire web is coated with the resin.

In some embodiments, at least a portion of the fibers of one or more layers (e.g., second layer, third layer) and/or the entire filter media may be coated without substantially blocking the pores of the layer(s) and/or the entire filter media. In some instances, substantially all of the fibers may be coated without substantially blocking the pores. In some embodiments, one or more layers (e.g., second layer, third layer) and/or the entire filter media may be coated with a relatively high weight percentage of resin without blocking the pores of the layer(s) and/or the entire filter media using the methods described herein (e.g., by dissolving and/or suspending one or more components in a solvent to form the resin). Coating the fibers of one or more layers and/or the entire filter media using the resins described herein may add strength and/or flexibility to the layer(s) and/or entire filter media, and leaving the pores substantially unblocked may be important for maintaining or improving certain filtration properties such as air permeability. Accordingly, the coating may be applied to one or more layers (e.g., third layer) and/or the entire filter media such that the pores are imparted with a desirable level of mechanical support (e.g., not prone to collapse upon mechanical compression or clogging).

In some embodiments, one or more layers (e.g., second layer, third layer) and/or the entire filter media may include more than one coating (e.g., on different surfaces of the fiber web). In some cases, the same coating method may be utilized to apply more than one coating. For example, the same coating method may be used to form a first coating on a top surface and a second coating on a bottom surface of the fiber web. In other instances, more than one coating method may be used to apply more than one coating. For example, a first coating method (e.g., dip coating) may be used to form a first coating in the interior of the fiber web and a second coating method (e.g., spray coating) may be used to form a second coating on a bottom surface of the fiber web. When more than one coating exists on a fiber web, in some embodiments the coatings may have the same resin composition. In other embodiments, the resin compositions may differ with respect to certain properties (e.g., first component, second component, ratio of components).

After applying the resin to the fiber web, the resin may be dried to remove most or substantially all of the solvent by any suitable method. Non-limiting examples of drying methods include the use of an infrared dryer, hot air oven steam-heated cylinder, or any other suitable types of dryers familiar to those of ordinary skill in the art.

In various embodiments, after being applied to the fiber web, the resin may undergo at least one chemical reaction to form one or more reaction products as described herein. For example, the components in the resin may be involved in a step-growth polymerization, (e.g., condensation), chain-growth polymerization (e.g., free radical, ionic, etc.), or a crosslinking reaction. The chemical reaction may result in covalent bonding between the components. In some embodiments, external energy (e.g., thermal energy, radiant energy) may be applied to the resin on the fiber web to induce a chemical reaction. In other embodiments, at least one reaction product is formed without the application of external energy. In some embodiments, portions of the resin (or components of the resin) may be polymerized prior to applying the resin to the fiber web.

In certain embodiments, at least one reaction product (e.g., a cured network, a copolymer) may be formed by, for example, heating the coated fiber web at a specific temperature for a suitable amount of time. For instance, in some embodiments, a coated fiber web may be heated at a temperature of greater than or equal to about 90° C., greater than or equal to about 100° C., greater than or equal to about 120° C., greater than or equal to about 150° C., greater than or equal to about 180° C., greater than or equal to about 210° C., greater than or equal to about 240° C., or greater than or equal to about 270° C. In some instances, the temperature may be less than or equal to about 300° C., less than or equal to about 265° C., less than or equal to about 235° C., less than or equal to about 210° C., less than or equal to about 175° C., less than or equal to about 145° C., or less than or equal to about 115° C. Combinations of the above-referenced ranges are also possible (e.g., greater than or equal to about 100° C. and less than or equal to about 210° C.). Other values of temperature are also possible.

In some embodiments, the coated fiber web may be heated to a temperature where the coating cures, yet the fiber web does not shrink. That is, the temperature would be high enough to cause the coating to cure within the fiber web, though, the temperature is insufficient to cause shrinkage of the fiber web.

In some embodiments, a layer (e.g., second layer) may be coated (e.g., saturated, impregnated) with a suitable resin and then adhered to another layer such as a third layer (e.g., including meltblown fibers, cellulose fibers, meltspun fibers, electrospun fibers, etc.), e.g., via thermal bonding, chemical bonding, or mechanical bonding. In some embodiments, the second layer and the third layer are bonded together, and then the composite, is coated (e.g., saturated, impregnated, surface applied) with a suitable resin.

In addition to the resin, glass components, and synthetic components described above, the filter media may include a variety of other suitable additives (typically, in small weight percentages) such as, surfactants, coupling agents, crosslinking agents, amongst others.

The fiber media may have a variety of desirable properties and characteristics which make it particularly well-suited for fuel and/or hydraulic applications. However, it should be understood that the filter media described herein are not limited to fuel and/or hydraulic applications, and that the media can be used in other applications such as for air filtration or filtration of other liquids and gases.

A filter media, including one or more layers of the filter media, can also have varying basis weights, pore sizes, thicknesses, permeabilities, dust holding capacities, efficiencies, and pressure drop, depending upon the requirements of a desired application.

The overall basis weight of a filter media can vary depending on factors such as the strength requirements of a given filtering application, the number of layers in the filter media, the position of the layer (e.g., upstream, downstream, middle), and the materials used to form the layer, as well as the desired level of filter efficiency and permissible levels of resistance or pressure drop. In certain embodiments described herein, increased performance (e.g., lower resistance or pressure drop) is observed when the filter media includes multiple layers having different properties, where each layer has a relatively low basis weight, compared to certain single- or multi-layered media. As a result, some such filter media may also have a lower overall basis weight while achieving high performance characteristics. For example, the overall basis weight of a filter media (or of two or more layers of the filter media) may be less than or equal to about 700 g/m², less than or equal to about 600 g/m², less than or equal to about 500 g/m², less than or equal to about 400 g/m², less than or equal to about 300 g/m², less than or equal to about 200 g/m², less than or equal to about 150 g/m², less than or equal to about 125 g/m², less than or equal to about 100 g/m², less than or equal to about 80 g/m², or less than or equal to about 50 g/m².

Generally, the ratio of basis weights between two different layers of a filter media (e.g., between a first layer and a second layer, between a second layer and a third layer, between a first layer and a third layer, etc.) can vary depending on the desired properties of the filter media. In some embodiments, an upstream layer of a filter media (e.g., a pre-filter layer) has a larger basis weight than that of a downstream layer (e.g., a main filter layer). For example, the ratio of basis weights between an upstream layer and a downstream layer may be greater than 1:1, greater than 1.5:1, or greater than 2:1. In other embodiments, however, an upstream layer of a filter media has a smaller basis weight than that of a downstream layer, e.g., the ratio of basis weights between an upstream layer and a downstream layer may be less than 2:1, less than 1.5:1, or less than 1:1. In certain embodiments, the basis weight ratio of an upstream and a downstream layer is 1:1.

The overall thickness of a filter media may be between about 5 mils and 300 mils, e.g., between about 50 mils and about 200 mils. The thickness of a layer of the filter media may be between about 3 mils and about 100 mils, between about 3 mils and about 70 mils, between about 3 mils and about 60 mils, between about 3 mils and about 50 mils, between about 3 mils and about 40 mils, between about 3 mils and about 30 mils, between about 3 mils and about 20 mils, or between about 3 mils and about 10 mils.

The overall air permeability of a filter media described herein can usually be selected as desired. In some embodiments, the overall permeability of the filter media, may range from between about 2 cubic feet per minute per square foot (cfm/sf) and about 300 cfm/sf, between about 7 cfm/sf and about 200 cfm/sf, between about 15 cfm/sf and about 135 cfm/sf, between about 15 cfm/sf and about 50 cfm/sf, between about 2 cfm/sf and about 50 cfm/sf, or between about 10 cfm/sf and about 40 cfm/sf. The overall permeability of the filter media may be, for example, greater than or equal to about 5 cfm/sf, greater than or equal to about 10 cfm/sf, greater than or equal to about 25 cfm/sf, greater than or equal to about 50 cfm/sf, greater than or equal to about 100 cfm/sf, greater than or equal to about 150 cfm/sf, greater than or equal to about 200 cfm/sf, or greater than or equal to about 250 cfm/sf. In some instances, the air permeability may be, for example, less than or equal to about 300 cfm/sf, less than or equal to about 275 cfm/sf, less than or equal to about 250 cfm/sf, less than or equal to about 225 cfm/sf, less than or equal to about 200 cfm/sf, less than or equal to about 175 cfm/sf, less than or equal to about 150 cfm/sf, less than or equal to about 125 cfm/sf, less than or equal to about 100 cfm/sf, less than or equal to about 75 cfm/sf, less than or equal to about 50 cfm/sf, or less than or equal to about 25 cfm/sf. Combinations of the above-referenced ranges are also possible. As determined herein, the permeability of the filter media is measured according to TAPPI Method T251. The permeability of a filter media is an inverse function of flow resistance and can be measured with a Frazier Permeability Tester. The Frazier Permeability Tester measures the volume of air per unit of time that passes through a unit area of sample at a fixed differential pressure across the sample. Permeability can be expressed in cubic feet per minute per square foot at a 0.5 inch water differential.

Typically, an upstream layer has a larger permeability (lower resistance) and/or a smaller pressure drop than that of a downstream layer, although other configurations are possible.

Certain filter media can have relatively low resistance ratios or certain ranges of resistance ratios between two layers that provide favorable filtration properties. For instance, the resistance ratio between a second layer, which includes fibers having a small average diameter, and a first layer, which includes fibers having a relatively larger average diameter, may be relatively low. In some cases, the second layer is downstream of the first layer as shown in FIG. 2. For example, in one particular embodiment, the second layer is a main filter layer and the first layer is a pre-filter layer. In another embodiment, the second layer is a downstream main filter layer and the first layer is an upstream filter layer. Other combinations are also possible. The resistance ratio between two layers (e.g., between a second layer and a first layer, between a downstream layer and an upstream layer, between a main layer and a pre-filter layer, or between two main layers, etc.), calculated as the resistance of the layer having a relatively smaller average fiber diameter to the resistance of the layer having a relatively larger average fiber diameter, may be, for example, between 0.5:1 and 15:1, between 1:1 and 10:1, between 1:1 and 7:1, between 1:1 and 5:1, or between 1:1 and 3.5:1. In some cases, the resistance ratio between the two layers is less than 15:1, less than 12:1, less than 10:1, less than 8:1, less than 6:1, less than 5:1, less than 4:1, less than 3:1, or less than 2:1, e.g., while being above a certain value, such as greater than 0.01:1, greater than 0.1:1, or greater than 1:1. Advantageously, certain ranges of resistance ratios (including low resistance ratios in some embodiments) can result in the filter media having favorable properties such as high dust holding capacity and/or high efficiency, while maintaining a relatively low overall basis weight. Such characteristics can allow the filter media to be used in a variety of applications.

In one particular set of embodiments, the resistance ratio between a main filter layer and a pre-filter layer adjacent (e.g., directly adjacent) the main filter layer of a filter media is between 0.5:1 and 7:1, between 1:1 and 5:1, or between 1:1 and 3.5:1. If the filter media includes another main filter layer, the resistance ratio between the downstream main filter layer to the upstream main filter layer may be between 1:1 and 12:1, between 1:1 and 8:1, between 1:1 and 6:1, or between 1:1 and 4:1. Additional layers are also possible.

The resistance of a layer may be normalized against the basis weight of the layer to produce a normalized resistance (e.g., resistance of a layer divided by the basis weight of the layer). In some cases, a normalized resistance ratio between two layers, e.g., a second layer, which includes fibers having a small average diameter, and a first layer, which includes fibers having a relatively larger average diameter, is relatively low. For example, in one particular embodiment, the second layer is a main filter layer and the first layer is a pre-filter layer. In another embodiment, the second layer is a downstream main filter layer and the first layer is an upstream filter layer. Other combinations are also possible. The normalized resistance ratio between two layers (e.g., between a second layer and a first layer, between a downstream layer and an upstream layer, between a main layer and a pre-filter layer, between two pre-filter layers, or between two main layers, etc.), calculated as the normalized resistance of the layer having a relatively smaller average fiber diameter to the normalized resistance of the layer having a relatively larger average fiber diameter, may be, for example, between 1:1 and 15:1, between 1:1 and 10:1, between 1:1 and 8:1, between 1:1 and 5:1, between 3:1 and 6:1, or between 1:1 and 3:1. In some cases, the normalized resistance ratio between the two layers is less than 15:1, less than 12:1, less than 10:1, less than 8:1, less than 6:1, less than 5:1, less than 4:1, less than 3:1, or less than 2:1, e.g., while being above a certain value, such as greater than 0.01:1, greater than 0.1:1, greater than 1:1, or greater than 3:1.

In one particular set of embodiments, the normalized resistance ratio between a main filter layer and a pre-filter layer adjacent (e.g., directly adjacent) the main filter layer of a filter media is between 1:1 and 8:1, between 1:1 and 5:1, between 3:1 and 6:1, or between 1:1 and 3:1. If the filter media includes another main filter layer, the resistance ratio between the downstream main filter layer to the upstream main filter layer may be between 1:1 and 10:1, between 1:1 and 8:1, between 1:1 and 6:1, between 1:1 and 4:1, between 3:1 and 6:1, or between 3:1 and 4:1. Additional layers are also possible.

In another particular set of embodiments, a filter media includes a normalized resistance ratio of a second layer to a first layer of 4:1 or greater, and a normalized resistance ratio of a third layer to a second layer of 4:1 or less. In some embodiments, a filter media includes a normalized resistance ratio of a second layer to a first layer of between 4:1 and 6:1, and a normalized resistance ratio of a third layer to a second layer of between 2:1 and 4:1. In some cases, the third layer in such embodiments includes a synthetic polymer fiber having one of the weight percentages described herein.

A filter media described herein can also have good dust holding properties. For example, the dust holding capacity (DHC), as determined by standard ISO 19438 (2003), may be greater than or equal to about 5 g/m², greater than or equal to about 10 g/m², greater than or equal to about 20 g/m², greater than or equal to about 50 g/m², greater than or equal to about 100 g/m², greater than or equal to about 150 g/m², greater than or equal to about 200 g/m², greater than or equal to about 250 g/m², greater than or equal to about 300 g/m², greater than or equal to about 350 g/m², greater than or equal to about 400 g/m², or greater than or equal to about 450 g/m². In some instances, the dust holding capacity may be less than or equal to about 600 g/m², less than or equal to about 550 g/m², less than or equal to about 500 g/m², less than or equal to about 450 g/m², less than or equal to about 400 g/m², less than or equal to about 350 g/m², less than or equal to about 300 g/m², less than or equal to about 250 g/m², less than or equal to about 200 g/m², less than or equal to about 150 g/m², less than or equal to about 100 g/m², less than or equal to about 50 g/m², less than or equal to about 25 g/m², or less than or equal to about 10 g/m². Combinations of the above-referenced ranges are possible (e.g., greater than or equal to about 5 g/m² and less than or equal to about 400 g/m², greater than or equal to about 10 g/m² and less than or equal to about 350 g/m², greater than or equal to about 20 g/m² and less than or equal to about 300 g/m²). Other values of DHC are possible. The dust holding capacity may be determined based on a Multipass Filter Test following the ISO 19438 procedure on a Multipass Filter Test Stand manufactured by FTI. The test may be run under different conditions. The testing uses ISO 12103-A3 medium grade test dust at a base upstream gravimetric dust level (BUGL) of 50 mg/liter. The test fluid is Aviation Hydraulic Fluid AERO HFA MIL H-5606A manufactured by Mobil. The test is run at a face velocity of 0.06 cm/s until a terminal pressure of 100 kPa. Unless otherwise stated, the dust holding capacity values and/or efficiency values described herein are determined at a BUGL of 50 mg/L, a face velocity of 0.06 cm/s, and a terminal pressure of 100 kPa.

In another example, a filter media can have an overall dust holding capacity, as determined by standard ISO 16889, of at least about 10 g/m², at least about 25 g/m², at least about 50 g/m², at least about 100 g/m², at least about 120 g/m², at least about 140 g/m², at least about 150 g/m², at least about 160 g/m², at least about 180 g/m², at least about 200 g/m², at least about 220 g/m², at least about 240 g/m², at least about 260 g/m², at least about 280 g/m², at least about 300 g/m², or at least about 350 g/m². The dust holding capacity may be, for example, less than 500 g/m². The dust holding capacity may be tested based on a Multipass Filter Test following the ISO 16889 procedure (modified by testing a flat sheet sample) on a Multipass Filter Test Stand manufactured by FTI. The testing uses ISO A3 Medium test dust manufactured by PTI, Inc. at an upstream gravimetric dust level of 10 mg/liter. The test fluid is Aviation Hydraulic Fluid AERO HFA MIL H-5606A manufactured by Mobil. The test is run at a face velocity of 0.67 cm/w until a terminal pressure of 500 kPa above the baseline filter pressure drop is obtained. The dust holding capacity can be calculated at 200 kPa by interpolation.

The dust holding capacity (as measured by standard ISO 19438 (2003) or standard ISO 16889) of a filter media can be normalized against the basis weight of the media to produce a specific capacity (e.g., dust holding capacity of the media divided by the basis weight of the media). The specific capacity of the filter media described herein may range, for example, between 0.3 and 3.0, between 1.5 and 3.0, between 1.7 and 2.7, or between 1.8 and 2.5. In certain embodiments, the specific capacity of a filter media is greater than or equal to 0.3, greater than or equal to 0.5, greater than or equal to 0.8, greater than or equal to 1.0, greater than or equal to 1.2, greater than or equal to 1.5, greater than or equal to 1.6, greater than or equal to 1.7, greater than or equal to 1.8, greater than or equal to 1.9, greater than or equal to 2.0, greater than or equal to 2.1, greater than or equal to 2.2, greater than or equal to 2.3, greater than or equal to 2.4, greater than or equal to 2.5, greater than or equal to 2.6, greater than or equal to 2.7, greater than or equal to 2.8, greater than or equal to 2.9, or greater than or equal to 3.0. The specific capacity may be less than or equal to 5.0, less than or equal to 4.0, less than or equal to 3.0, or less than or equal to 2.0 in some embodiments. Combinations of the above-ranges are also possible.

The dust holding capacity of a filter media (as measured by standard ISO 19438 (2003) or standard ISO 16889) may also be normalized against the overall basis weight of the media and the log of the filtration ratio (Beta₍ₓ₎) for certain particle sizes “x” or greater to produce a unitless value, “Absolute specific capacity at x microns”. For example, for a filter media that captures particle sizes of 10 microns or greater and which has a certain Beta₍₁₀₎ value, the “Absolute specific capacity at 10 microns” for that media would be calculated by multiplying the dust holding capacity of the media by the square root of the log of the Beta_{w} value for 10 micron and larger particles, and dividing by the overall basis weight of the media.

In certain embodiments, a filter media having two (or more) layers has an absolute specific capacity at 10 microns (using a DHC measured by standard ISO 19438 (2003) or standard ISO 16889) of greater than or equal to about 0.02, greater than or equal to about 0.1, greater than or equal to about 0.2, greater than or equal to about 0.5, greater than or equal to about 1.0, greater than or equal to about 1.5, greater than or equal to about 2.0, greater than or equal to about 2.5, greater than or equal to about 2.65, greater than or equal to about 2.7, greater than or equal to about 2.75, greater than or equal to about 3.0, greater than or equal to about 3.4, greater than or equal to about 3.5, greater than or equal to about 3.6, greater than or equal to about 3.75, greater than or equal to about 4.0, greater than or equal to about 4.25, greater than or equal to about 4.5, greater than or equal to about 4.75, or greater than or equal to about 5.0. The absolute specific capacity at 10 microns may be, for example, less than or equal to about 6.0, less than or equal to about 5.0, less than or equal to about 4.0, less than or equal to about 3.0 or less than or equal to about 2.0. Combinations of the above-ranges are also possible. The filter media may additionally have a total basis weight of, for example, less than or equal to about 600 g/m², less than or equal to about 500 g/m², less than or equal to about 400 g/m², less than or equal to about 300 g/m², less than or equal to about 200 g/m², less than or equal to about 150 g/m², less than or equal to about 100 g/m², less than or equal to about 90 g/m², less than or equal to about 80 g/m², less than or equal to about 75 g/m², less than or equal to about 70 g/m², less than or equal to about 68 g/m², less than or equal to about 65 g/m², less than or equal to about 60 g/m², or less than or equal to about 50 g/m². Other values and ranges of absolute specific capacity and basis weight are also possible.

In certain embodiments, a filter media having three (or more) layers has an absolute specific capacity at 10 microns (using a DHC measured by standard ISO 19438 (2003) or standard ISO 16889) of greater than about 2.0, greater than about 2.25, greater than about 2.5, greater than about 2.6, greater than about 2.65, greater than about 2.75, greater than about 3.0, greater than about 3.5, greater than about 3.75, greater than about 4.0, greater than about 4.25, or greater than about 4.5. The filter media may additionally have a total basis weight of, for example, less than or equal to about 600 g/m², less than or equal to about 500 g/m², less than or equal to about 400 g/m², less than or equal to about 300 g/m², less than or equal to about 200 g/m², less than or equal to about 190 g/m², less than or equal to about 180 g/m², less than or equal to about 170 g/m², less than or equal to about 160 g/m², less than or equal to about 150 g/m², less than or equal to about 140 g/m², less than or equal to about 130 g/m², less than or equal to about 120 g/m², less than or equal to about 110 g/m², less than or equal to about 100 g/m², less than or equal to about 90 g/m², or less than or equal to about 80 g/m². Other values and ranges of absolute specific capacity and basis weight are also possible.

In some embodiments, a filter media described herein includes a relatively high overall dust holding capacity, such as one of the values described above, and a relatively high overall permeability, such as one of the values described above. For instance, a filter media may have an overall dust holding capacity of at least about 150 g/m² (e.g., at least about 180 g/m², at least about 200 g/m², at least about 230 g/m², at least about 250 g/m²), and an overall permeability of greater than about 25 cfm/sf (e.g., greater than about 30 cfm/sf, greater than about 35 cfm/sf, greater than about 40 cfm/sf, greater than about 45 cfm/sf, or greater than about 50 cfm/sf). In certain embodiments, these performance characteristics are achieved with a filter media including a third layer comprising a blend of polymeric staple fibers and glass fibers.

The filter media described herein may be used for the filtration of various particle sizes, e.g., particles having a size of less than or equal to about 20 microns, less than or equal to about 15 microns, less than or equal to about 10 microns, less than or equal to about 5 microns, less than or equal to about 3 microns, or less than or equal to about 1 micron. In some embodiments, the efficiency of filtering such particle sizes can be measured using a Multipass Filter Test. For instance, the efficiency values can be determined following the ISO 16889 procedure (modified by testing a flat sheet sample) on a Multipass Filter Test Stand manufactured by FTI. The testing uses ISO A3 Medium test dust manufactured by PTI, Inc. at an upstream gravimetric dust level of 10 mg/liter. The test fluid is Aviation Hydraulic Fluid AERO HFA MIL H-5606A manufactured by Mobil. The test can be run at a face velocity of 0.67 cm/s until a terminal pressure of 500 kPa.

Particle counts (particles per milliliter) at the particle sized selected (e.g., 1, 3, 4, 5, 7, 10, 15, 20, 25, or 30 microns) upstream and downstream of the media can be taken at ten points equally divided over the time of the test. The average of upstream and downstream particle counts can be taken at each selected particle size. From the average particle count upstream (injected −C₀) and the average particle count downstream (passed thru-C) the liquid filtration efficiency test value for each particle size selected can be determined by the relationship [(1−[C/C₀])*100%].

Efficiency can also be expressed in terms of a beta value (or beta ratio), where beta₍ₓ₎=y is the ratio of upstream count (C₀) to downstream count (C), and where x is the minimum particle size that will achieve the actual ratio of C₀ to C that is equal to y. The penetration fraction of the media is 1 divided by the beta₍ₓ₎ value (y), and the efficiency fraction is 1−penetration fraction. Accordingly, the efficiency of the media is 100 times the efficiency fraction, and 100*(1−1/beta₍ₓ₎)=efficiency percentage. For example, a filter media having a beta₍ₓ₎=200 has an efficiency of [1−(1/200)]*100, or 99.5% for x micron or larger particles. The filter media described herein may have a wide range of beta values, e.g., a beta₍ₓ₎=y, where x can be, for example, 1, 3, 5, 7, 10, 12, 15, 20, 25, 30, 50, 70, or 100, and where y can be, for example, at least 2, at least 10, at least 75, at least 100, at least 200, or at least 1000. It should be understood that other values of x and y are also possible; for instance, in some cases, y may be greater than 1000. It should also be understood that for any value of x, y may be any number (e.g., 10.2, 12.4) representing the actual ratio of C₀ to C. Likewise, for any value of y, x may be any number representing the minimum particle size that will achieve the actual ratio of C₀ to C that is equal to y.

The efficiency of a media or a layer of media may also be referred to as having a particular micron rating, x, for a certain beta efficiency (e.g., beta 200), meaning that the media or layer has that efficiency (e.g., beta 200=99.5% efficiency) for trapping x micron or larger particles. Generally, a lower micron rating means that the media or layer is able to trap smaller particles or is more “efficient” than a media or layer having a relatively larger micron rating. Unless otherwise stated, a micron rating described herein is determined for a beta 200 efficiency (i.e., the average micron size at a terminal pressure of 500 kPa based on the Multipass Filter Test described above).

In other embodiments, efficiency can be measured according to standard ISO 19438 (2003). The testing uses ISO12103-3 medium grade test dust at a base upstream gravimetric dust level (BUGL) of 50 mg/liter. The test fluid is Aviation Hydraulic Fluid AERO HFA MIL H-5606A manufactured by Mobil. The test is run at a face velocity of 0.06 cm/s until a terminal pressure of 100 kPa. The average efficiency values are determined at a terminal pressure of 100 kPa. The average efficiency is the average of the efficiency values measured at one minute intervals until the terminal pressure is reached. A similar protocol can be used for measuring initial efficiency, which refers to the average efficiency measurements of the media at 4, 5, and 6 minutes after running the test. Unless otherwise indicated, average efficiency and initial efficiency measurements described herein in connection with standard ISO 19438 (2003) are for 1 micron or greater-sized particles measured.

In some embodiments, the average particulate efficiency of the filter media (e.g., for 1 micron or greater-sized particles), as determined by standard ISO 19438 (2003), may be greater than or equal to about 5%, greater than or equal to about 10%, greater than or equal to about 20%, greater than or equal to about 30%, greater than or equal to about 40%, greater than or equal to about 50%, greater than or equal to about 60%, greater than or equal to about 70%, greater than or equal to about 80%, greater than or equal to about 85%, greater than or equal to about 90%, greater than or equal to about 95%, greater than or equal to about 96%, greater than or equal to about 97%, greater than or equal to about 98%, greater than or equal to about 99%, greater than or equal to about 99.9%, greater than or equal to about 99.99%, or greater than or equal to about 99.999%. In some instances, the average particulate efficiency of the filter media may be less than or equal to about 100%, less than or equal to about 99.9999%, less than or equal to about 99.999%, less than or equal to about 99.99%, less than or equal to about 99%, less than or equal to about 98%, less than or equal to about 97%, less than or equal to about 95%, less than or equal to about 90%, less than or equal to about 80%, less than or equal to about 70%, less than or equal to about 60%, less than or equal to about 50%, less than or equal to about 40%, less than or equal to about 30%, less than or equal to about 20%, less than or equal to about 10%. Combinations of the above-referenced ranges are also possible (e.g., greater than or equal to about 85% and less than or equal to about 100%, greater than or equal to about 90% and less than or equal to about 100%). Other values of the average particulate efficiency of the filter media are also possible.

In some embodiments, the filter media may have an initial particulate efficiency (e.g., for 1 micron or greater-sized particles), as determined by standard ISO 19438 (2003), of greater than or equal to about 10%, greater than or equal to about 20%, greater than or equal to about 30%, greater than or equal to about 40%, greater than or equal to about 50%, greater than or equal to about 60%, greater than or equal to about 70%, greater than or equal to about 80%, greater than or equal to about 85%, greater than or equal to about 90%, greater than or equal to about 95%, greater than or equal to about 96%, greater than or equal to about 97%, greater than or equal to about 98%, greater than or equal to about 99%, greater than or equal to about 99.9%, greater than or equal to about 99.99%, greater than or equal to about 99.999%, or greater than or equal to about 99.9999%. In some instances, the initial particulate efficiency of the filter media may be less than or equal to about 100%, less than or equal to about 99.9999%, less than or equal to about 99.999%, less than or equal to about 99.99%, less than or equal to about 99%, less than or equal to about 98%, less than or equal to about 97%, less than or equal to about 95%, less than or equal to about 90%, less than or equal to about 85%, less than or equal to about 70%, less than or equal to about 60%, less than or equal to about 50%, less than or equal to about 40%, less than or equal to about 30%, or less than or equal to about 20%. Combinations of the above-referenced ranges are also possible (e.g., greater than or equal to about 80% and less than or equal to about 100%, greater than or equal to about 90% and less than or equal to about 100%). Other values of initial efficiency of the filter media are also possible.

In some embodiments, the average fluid (e.g., fuel-water) separation efficiency of the filter media may range from about 20% to about 99.99% or higher (e.g., between about 25% to about 99.99%, between about 30% to about 99.99%, between about 60% to about 99.99%). For instance, in certain embodiments, the average fluid separation efficiency of the filter media may be at least about 20%, at least about 25%, at least about 30%, at least about 40%, at least about 50%, at least about 60%, at least about 70%, at least about 80%, at least about 90%, at least about 95%, at least about 98%, at least about 99%, or at least about 99.5%. In some instances, the average fluid separation efficiency of the filter media may be less than or equal to about 99.99%, less than or equal to about 99.95% less than or equal to about 99.9%, less than or equal to about 99%, less than or equal to about 98%, less than or equal to about 95%, less than or equal to about 90%, less than or equal to about 80%, less than or equal to about 70%, less than or equal to about 60%, less than or equal to about 50%, less than or equal to about 40%, or less than or equal to about 30%. Combinations of the above-referenced ranges are possible (e.g., at least about 60% and less than or equal to about 99.99%). Other ranges are also possible.

In certain embodiments, the initial fluid separation efficiency may be at least about 20%, at least about 25%, at least about 30%, at least about 40%, at least about 50%, at least about 60%, at least about 70%, at least about 80%, at least about 90%, at least about 95%, at least about 98%, at least about 99%, at least about 99.9%, or at least about 99.99%. In some instances, the initial fluid separation efficiency may be less than or equal to about 99.99%, less than or equal to about 99.9%, less than or equal to about 99%, less than or equal to about 98%, or less than or equal to about 95%. Combinations of the above-referenced ranges are possible (e.g., at least about 60% and less than or equal to about 99.99%). Other ranges are also possible.

As used herein, average and initial fluid separation efficiency is measured using the SAEJ1488 test. The test involves sending a sample of fuel (ultra-low sulfur diesel fuel) with controlled water content (2500 ppm) through a pump across the media at a face velocity of 0.069 cm/sec. The water is emulsified into fine droplets and sent to challenge the media. The water is either coalesced, or shed or both, and collects at the bottom of the housing. The water content of the sample is measured both upstream and downstream of the media, via Karl Fischer titration. The efficiency is the amount of water removed from the fuel-water mixture. The fluid separation efficiency is calculated as (1−C/2500)*100, where C is the downstream concentration of water. The initial efficiency is calculated at the first 10 minutes of the test and the average efficiency is calculated as the average of the efficiency at the end of 150 minutes. To measure average fluid separation efficiency as described herein, the first measurement of the sample upstream and downstream of the media is taken at 10 minutes from the start of the test. Then, measurement of the sample downstream of the media is taken every 20 minutes.

In some embodiments, higher average and initial fluid separation efficiencies may be achieved by using multiple layers of media described herein by including multiple stages of filter media (e.g., multiple alternating hydrophobic and hydrophilic stages), and/or by controlling the pore size, basis weight, thickness, and/or surface chemistries of the layers and/or stages.

In some embodiments, the filter media may have an improved lifetime relative to certain conventional filter media. The lifetime, as referred to herein, is measured according to the standard ISO 4020 (2001). The testing can be performed using mineral oil, 4-6 cST at 23° C. as the test fluid. The test fluid contains a mixture of carbon black and Mira 2 aluminum oxide as the organic and inorganic contaminants, respectively. The flow rate of the test fluid is 36.7 Lpm/m² and the terminal differential pressure is a 70 kPa rise over the clean filter media. The test fixture has a 90 mm diameter. The inorganic contaminant is 20 grams of Mira 2 aluminum oxide per 20 liters of mineral oil, 4-6 cST, and the organic contaminant is 1.25 grams of carbon black per 20 liters of mineral oil, 4-6 cST. The lifetime is determined to be the time, in minutes, required to reach a terminal differential pressure of 70 kPa over the clean filter media with no contaminants.

In some embodiments, the filter media may have a lifetime of greater than or equal to about 3 minutes, greater than or equal to about 5 minutes, greater than or equal to about 6 minutes, greater than or equal to about 8 minutes, greater than or equal to about 10 minutes, greater than or equal to about 25 minutes, greater than or equal to about 50 minutes, greater than or equal to about 75 minutes, greater than or equal to about 100 minutes, greater than or equal to about 125 minutes, greater than or equal to about 150 minutes, greater than or equal to about 175 minutes, greater than or equal to about 200 minutes, or greater than or equal to about 225 minutes. In some instances, the lifetime may be less than or equal to about 250 minutes, less than or equal to about 240 minutes, less than or equal to about 225 minutes, less than or equal to about 200 minutes, less than or equal to about 175 minutes, less than or equal to about 150 minutes, less than or equal to about 125 minutes, less than or equal to about 100 minutes, less than or equal to about 75 minutes, less than or equal to about 50 minutes, less than or equal to about 25 minutes, less than or equal to about 15 minutes, or less than or equal to about 5 minutes. Combinations of the above-referenced ranges are possible (e.g., greater than or equal to about 3 minutes and less than or equal to about 250 minutes, greater than or equal to about 6 minutes and less than or equal to about 200 minutes).

The filter media described herein may be produced using processes based on known techniques. In some cases, one or more layers of the filter media is produced using a wet laid process. In general, a wet laid process involves mixing together the fibers; for example, glass fibers (e.g., chopped strand and/or microglass) may be mixed together, optionally with any synthetic fibers, to provide a glass fiber slurry. In some cases, the slurry is an aqueous-based slurry. In certain embodiments, the microglass fibers, and optionally any chopped strand and/or synthetic fibers, are stored separately in various holding tanks prior to being mixed together. These fibers may be processed through a pulper before being mixed together. In some embodiments, combinations of chopped strand glass fibers, microglass fibers, and/or synthetic fibers are processed through a pulper and/or a holding tank prior to being mixed together. As discussed above, microglass fibers may include fine microglass fibers and coarse microglass fibers.

It should be appreciated that any suitable method for creating a glass fiber slurry may be used. In some cases, additional additives are added to the slurry to facilitate processing. The temperature may also be adjusted to a suitable range, for example, between 33° F. and 100° F. (e.g., between 50° F. and 85° F.). In some embodiments, the temperature of the slurry is maintained. In some cases, the temperature is not actively adjusted.

In some embodiments, the wet laid process uses similar equipment as a conventional papermaking process, which includes a hydropulper, a former or a headbox, a dryer, and an optional converter. For example, the slurry may be prepared in one or more pulpers. After appropriately mixing the slurry in a pulper, the slurry may be pumped into a headbox, where the slurry may or may not be combined with other slurries or additives may or may not be added. The slurry may also be diluted with additional water such that the final concentration of fiber is in a suitable range, such as for example, between about 0.1% to 0.5% by weight.

In some cases, the pH of the fiber slurry may be adjusted as desired. For instance, the pH of the fiber slurry may range between about 1 to about 8 depending on the particular amounts of glass and/or polymeric staple fibers used.

Before the slurry is sent to a headbox, the slurry may be passed through centrifugal cleaners for removing unfiberized glass or shot. The slurry may or may not be passed through additional equipment such as refiners or deflakers to further enhance the dispersion of the fibers. Fibers may then be collected on a screen or wire at an appropriate rate using any suitable machine, e.g., a fourdrinier, a rotoformer, a cylinder, or an inclined wire fourdrinier. In some embodiments, the wet-laid layer(s) can be formed on a scrim or other suitable substrate directly.

In some embodiments, the process involves introducing binder (and/or other components) into a pre-formed layer. In some embodiments, as the fiber layer is passed along an appropriate screen or wire, different components included in the binder, which may be in the form of separate emulsions, are added to the fiber layer using a suitable technique. In some cases, each component of the binder resin is mixed as an emulsion prior to being combined with the other components and/or fiber layer. In some embodiments, the components included in the binder may be pulled through the fiber layer using, for example, gravity and/or vacuum. In some embodiments, one or more of the components included in the binder resin may be diluted with softened water and pumped into the fiber layer.

As noted above, different layers of glass and/or other fibers may be combined to produce filter media based on desired properties. For example, in some embodiments, a relatively coarse pre-filter layer may be combined with a relatively finer fiber layer (i.e., a main filter layer) to form a multi-layered filter media. Optionally, the filter media can include one or more additional fine fiber layers as described above.

Multi-phase filter media may be formed in an appropriate manner. As an example, a filter media or a portion thereof may be prepared by a wet laid process where a first fiber slurry (e.g., fibers in an aqueous solvent such as water) is applied onto a wire conveyor to form a first layer. A second fiber slurry (e.g., fibers in an aqueous solvent such as water) is then applied onto the first layer either simultaneously or downstream in the manufacturing process of where the first fiber slurry is placed on the wire. Vacuum may be continuously applied to the first and second slurries during the above process to remove solvent from the fibers, resulting in the simultaneous formation of the first and second layers into a composite article. The composite article is then dried. Due to this fabrication process, at least a portion of the fibers in the first layer can be intertwined with at least a portion of the fibers from the second layer (e.g., at the interface between the two layers). Additional layers can also be formed and added using a similar process or a different process such as lamination, co-pleating, or collation (i.e., placed directly adjacent one another and kept together by pressure). For example, in some cases, two layers (e.g., two fine fiber layers) are formed into a composite article by a wet laid process in which separate fiber slurries are laid one on top of the other as water is drawn out of the slurry, and the composite article is then combined with a third layer (e.g., a pre-filter layer) by any suitable process (e.g., lamination, co-pleating, or collation). It can be appreciated that filter media or composite article formed by a wet laid process may be suitably tailored not only based on the components of each fiber layer, but also according to the effect of using multiple fiber layers of varying properties in appropriate combination to form filter media having the characteristics described herein.

In one set of embodiments, at least two layers of a filter media (e.g., a layer and a composite article comprising more than one layer, or two composite articles comprising more than one layer) are laminated together. For instance, a first layer (e.g., a prefilter layer including relatively coarse fibers) may be laminated with a second layer (e.g., a main filter layer including relatively fine fibers), where the first and second layers face each other to form a single, multilayer article (e.g., a composite article) that is integrally joined in a single process line assembly operation to form the filter media. If desired, the first and second layers can be combined with another main filter layer (e.g., a third layer) using any suitable process before or after the lamination step. In other embodiments, two or more layers (e.g., main filter layers) are laminated together to form a multilayer article. After lamination of two or more layers into a composite article, the composite article may be combined with additional layers via any suitable process.

Different layers may be adhered together by any suitable method. Non-limiting examples include mechanical bonding (e.g., needlepunch), thermal bonding (e.g., calendering, sonic bonding, point bonding), chemical bonding (e.g. saturation, spray, print, foam), hydroentangling, and combinations thereof. For instance, layers may be adhered by an adhesive and/or melt-bonded to one another on either side. Lamination and calendering processes may also be used. In some embodiments, an additional layer may be formed from any type of fiber or blend of fibers via an added headbox or a coater and appropriately adhered to another layer.

In other embodiments, a non-wet laid process, such as an air laid or dry-laid process, is used. In an air laid process, glass fibers are chopped and dispersed in air that is blown onto a conveyor, and a binder is then applied. Air laid processing is typically more suitable for the production of highly porous media including bundles of fibers (e.g., glass fibers).

For some embodiments, one or more layers (e.g., a first layer or third layer, such as a pre-filter layer) of a filter media described herein may be produced from a meltblown process. For example, meltblown processes and manufacturing methods described in U.S. Patent Publication No. 2009/0120048, entitled “Meltblown Filter Medium,” which is incorporated herein by reference in its entirety for all purposes, may be used, including the lamination techniques described therein. Electrospinning processes, melt spun processes, centrifugal spinning processes, or spun bond processes may also be used to form one or more layers described herein. Other processes are also possible. A synthetic polymer layer may be manufactured and adhered on to a single-phase or multi-phase layer in any appropriate manner. In some embodiments, a layer including a synthetic polymer may be positioned downstream with respect to a single-phase or multi-phase layer or vice versa.

During or after formation of a layer, a composite article including two or more combined layers, or a final filter media, the layer, composite article or final filter media may be further processed according to a variety of known techniques. For example, the filter media or portions thereof may be pleated and used in a pleated filter element. For instance, two layers may be joined by a co-pleating process. In some embodiments, filter media, or various layers thereof, may be suitably pleated by forming score lines at appropriately spaced distances apart from one another, allowing the filter media to be folded. It should be appreciated that any suitable pleating technique may be used. The physical and mechanical qualities of the filter media can be tailored to provide, in some embodiments, an increased number of pleats, which may be directly proportional to increased surface area of the filter media. The increased surface area may allow the filter media to have an increased filtration efficiency of particles from fluids. For example, in some cases, the filter media described herein includes 2-12 pleats per inch, 3-8 pleats per inch, or 2-5 pleats per inch. Other values are also possible.

In some embodiments, further processing may involve corrugation of one or more layers of the filter media (e.g., a third layer). For instance, in one example, a third layer is corrugated and laminated to another layer (e.g., a second layer) such that one side of the peaks are joined to portions of the surface of the other layer. The corrugation may be performed in the machine direction or cross direction. In some embodiments, corrugation may result in waves within the layer having an amplitude and/or frequency as described herein.

In embodiments in which one or more layers (e.g., third layer) is corrugated, the frequency of the waves in the corrugated layer(s) may be less than or equal to about 10, less than or equal to about 9, less than or equal to about 8, less than or equal to about 7, less than about 6, less than or equal to about 5, or less than or equal to about 4, or less than or equal to about 3 cycles per inch. In some instances, the frequency may be greater than or equal to about 2, greater than or equal to about 3, greater than or equal to about 4, greater than or equal to about 5, greater than or equal to about 6, greater than or equal to about 7, or greater than or equal to about 8 cycles per inch. Combinations of the above-referenced ranges are possible (e.g., greater than or equal to about 2 and less than or equal to about 10, greater than or equal to about 4 and less than or equal to about 8). As used herein, cycle per inch has its ordinary meaning in the art and may refer to the cycles in a layer or filter media per unit inch. One cycle corresponds to one peak to the next adjacent peak.

In some embodiments, further processing may involve embossing one or more layers (e.g., the third layer) and/or the filter media. Several different techniques may be used to emboss a layer and/or the filter media. In certain embodiments, the plurality of indentations in an embossed layer may be arranged to form a pattern. In some embodiments, the pattern of indentations may be simple, such as a checkerboard pattern, or more complex like a honeycomb pattern. In other cases, for example, the pattern may be cubic, hexagonal, and/or polygonal. The pattern of indentations may be regular or irregular.

In embodiments in which one or more layers and/or the entire filter media described herein is embossed, the frequency of the indentations in the layer(s) and/or entire filter media may vary. In some embodiments, a layer described herein (e.g., an embossed layer) may have at least 1 indentation/100 mm², at least 2 indentations/100 mm², at least 5 indentations/100 mm², at least 10 indentations/100 mm², at least 20 indentations/10 mm², at least 30 indentations/100 mm², at least 40 indentations/100 mm², at least 50 indentations/100 mm², at least 60 indentations/100 mm², at least 70 indentations/100 mm², at least 80 indentations/100 mm², or at least 90 indentations/100 mm². In certain embodiments, a layer described herein (e.g., an embossed layer) may have less than or equal to 100 indentations/100 mm², less than or equal to 90 indentations/100 mm², less than or equal to 80 indentations/100 mm², less than or equal to 70 indentations/100 mm², less than or equal to 60 indentations/100 mm², less than or equal to 50 indentations/100 mm², less than or equal to 40 indentations/100 mm², less than or equal to 30 indentations/100 mm², less than or equal to 20 indentations/100 mm², less than or equal to 10 indentations/100 mm², less than or equal to 5 indentations/100 mm², or less than or equal to 2 indentations/100 mm². Combinations of the above-referenced ranges are also possible (e.g., at least 10 indentations/100 mm² and less than or equal to 100 indentations/100 mm²). Other ranges are also possible.

It should be appreciated that the filter media may include other parts in addition to the two or more layers described herein. In some embodiments, further processing includes incorporation of one or more structural features and/or stiffening elements. For instance, the media may be combined with additional structural features such as polymeric and/or metallic meshes. In one embodiment, a screen backing may be disposed on the filter media, providing for further stiffness. In some cases, a screen backing may aid in retaining the pleated configuration. For example, a screen backing may be an expanded metal wire or an extruded plastic mesh.

As previously indicated, the filter media disclosed herein can be incorporated into a variety of filter elements for use in various applications including hydraulic and non-hydraulic filtration applications (e.g., fuel applications). Exemplary uses of hydraulic filters (e.g., high-, medium-, and low-pressure filters) include mobile and industrial filters. Exemplary uses of non-hydraulic filters include fuel filters (e.g., automotive fuel filters), oil filters (e.g., lube oil filters or heavy duty lube oil filters), chemical processing filters, industrial processing filters, medical filters (e.g., filters for blood), air filters, and water filters. In some cases, filter media described herein can be used as coalescer filter media.

In some cases, the filter element includes a housing that may be disposed around the filter media. The housing can have various configurations, with the configurations varying based on the intended application. In some embodiments, the housing may be formed of a frame that is disposed around the perimeter of the filter media. For example, the frame may be thermally sealed around the perimeter. In some cases, the frame has a generally rectangular configuration surrounding all four sides of a generally rectangular filter media. The frame may be formed from various materials, including for example, cardboard, metal, polymers, or any combination of suitable materials. The filter elements may also include a variety of other features known in the art, such as stabilizing features for stabilizing the filter media relative to the frame, spacers, or any other appropriate feature.

In one set of embodiments, the filter media described herein is incorporated into a filter element having a cylindrical configuration, which may be suitable for hydraulic and other applications. The cylindrical filter element may include a steel support mesh that can provide pleat support and spacing, and which protects against media damage during handling and/or installation. The steel support mesh may be positioned as an upstream and/or downstream layer. The filter element can also include upstream and/or downstream support layers that can protect the filter media during pressure surges. These layers can be combined with filter media 10, which may include two or more layers as noted above.

In one set of embodiments, a filter media described herein is incorporated into a fuel filter element. Fuel filter elements can be of varying types, e.g., fuel filter elements to remove particulates, fuel-water separators to remove water from diesel fuel, and fuel filter elements that perform both particulate separation and water separation. The fuel filter element may be a single stage element or multiple stage element. In some cases, the media can be pleated or wrapped, supported or unsupported, cowrapped/copleated with multiple media. In some designs, the media is pleated with a wrapped core in the center.

In some embodiments, a filter media described herein is incorporated into a fuel-water separator. A fuel-water separator may have a bowl-like design which collects water at the bottom. Depending on the water collection, the water may be collected upstream, downstream, or on both sides of the collection bowl. The water can then be drained off by opening a valve at the bottom of the bowl and letting the water run out, until the bowl contains only fuel/diesel. In some embodiments, the fuel-water separator may include a water sensor to signal the engine control unit, or to signal the driver directly, if the water reaches a warning level. The fuel-water separator may also include a sensor, which can alert the operator when the filter needs to be drained. In some cases, a heater may be positioned near the filter to help avoid the forming of paraffin wax (in case of low temperatures) inside the filter which can stop fuel flow to the engine.

The filter element may also have any suitable dimensions. For example, the filter element may have a length of at least 15 inches, at least 20 inches, at least 25 inches, at least 30 inches, at least 40 inches, or at least 45 inches. The surface area of the filter media may be, for example, at least 220 square inches, at least 230 square inches, at least 250 square inches, at least 270 square inches, at least 290 square inches, at least 310 square inches, at least 330 square inches, at least 350 square inches, or at least 370 square inches.

The filter elements may have the same property values as those noted above in connection with the filter media. For example, the above-noted resistance ratios, basis weight ratios, dust holding capacities, efficiencies, specific capacities, and fiber diameter ratios between various layers of the filter media may also be found in filter elements.

During use, the filter media mechanically trap particles on or in the layers as fluid flows through the filter media. The filter media need not be electrically charged to enhance trapping of contamination. Thus, in some embodiments, the filter media are not electrically charged. However, in some embodiments, the filter media may be electrically charged.

The following examples are intended to illustrate certain embodiments of the present invention, but are not to be construed as limiting and do not exemplify the full scope of the invention.

### Example 1

This example shows that a composite filter media including a pre-filter containing two glass fiber layers and a main filtration layer formed of a blend of glass fibers and polymeric staple fibers had a lower micron rating for beta 200 efficiency and a similar dust holding capacity compared to a composite filter media including pre-filter containing two glass fiber layers and a main filtration layer that contained only glass fibers.

In the main filtration layers containing a blend of glass fibers and polymeric staple fibers, polyester staple fibers having a diameter between 1-3 microns and/or 4-7 microns and a length of about 1.5 mm were used in the amounts specified in Table 1. The glass fibers had an average diameter between 2-6 microns. The main filtration layers were formed using a wet laid handsheet process. A total mass of about 4.16 grams of fibers was used to make each fiber web. The handsheet process was performed by acidifying the entire volume of the handsheet mold and pulping the fibers in acidified water to form a fiber slurry. The fiber slurry was then added to the top of the handsheet mold, the slurry was agitated, and the slurry was allowed to drain through the forming wire. The remaining wet fiber web was vacuumed and dried on a photodryer.

The pre-filter contained two layers (e.g., primary layer and a secondary layer) formed by a wet laid papermaking process. The wet laid papermaking process involved forming a primary fiber slurry comprising glass fibers having a diameter between about 2-6 microns and forming a secondary fiber slurry comprising glass fibers having a diameter between about 6-9 microns. The primary and secondary slurries were held in a first and a second holding chest, respectively. HYCAR 26120 resin was formed and held in a storage tank. Slurry from the first holding chest was pumped to the main headbox of a fourdrinier paper machine. The slurry was allowed to flow onto the forming wire of the paper machine and was drained by gravity, as well as by a series of vacuum slots eventually forming a wet, loosely bonded web of fibers which was carried away by the forming wire. To make the second layer, fiber from the second holding chest was pumped, along with dilution water, to a secondary headbox also located on the fourdrinier paper making machine. The secondary headbox was positioned so that the forming wire carrying the drained fibers from the main headbox passed underneath the secondary headbox. The second slurry laid on top of, and then drained through, the already formed web from the main headbox. The water was then removed by another series of vacuum slots resulting in a combined single web including fibers from the main headbox as a bottom layer and fibers from the secondary headbox as a top layer. In some cases, the combined single web was then sprayed with a resin solution to add binder. The web was then dried by passing over a series of steam filled dryer cans. The total basis weight of the pre-filter was 85 gsm. The pre-filter had an air permeability of 85 cfm/sf. The pre-filter and the main filtration layer were combined by collation to form the composite media.

After the composite filter media were dried, the dust holding capacity and efficiency of each filter media was determined using the ISO 16889 procedure that was modified by testing each filter media sample on a Multipass Filter Test Stand manufactured by FTI. The test used ISO A3 Medium test dust manufactured by PTI, Inc. at an upstream gravimetric dust level of 10 mg/liter. The test fluid was Aviation Hydraulic Fluid AERO HFA MIL H-5606A, manufactured by Mobil. The tests were run at a face velocity of 0.67 cm/s until a terminal pressure of 500 kPa absolute. The dust holding capacity was measured at 200 kPa after the completion of the test.

Prior to beginning of each Multipass test, the pressure drop (clean flatsheet DP) across each filter media was determined. The pressure drop was measured using the ISO 3968 standard. The pressure drop value was measured when clean hydraulic fluid at 15 cSt with a face velocity of 0.67 cm/s was passing through the filter media.

The weight percentage of glass fibers and polymeric staple fibers and basis weight for the main filtration layers are shown in Table 1. The dust holding capacity, pressure drop, and efficiency of the overall composite including the pre-filter layer and main filtration layer are also shown in Table 1.

TABLE 1
Structural and performance characteristics of composite filter media

| | | | | | Micron | | |
|---|---|---|---|---|---|---|---|
| | | | | | rating | | |
| | | Poly- | Poly- | | for | | |
| | | meric | meric | | Beta | | Clean |
| | | Staple | Staple | | 200 | | Flat |
| | Glass | Fibers | Fibers | Basis | effi- | | sheet |
| | Fibers | (1-3 μm) | (4-7 μm) | weight | ciency | DHC | DP |
| Media | wt. %* | wt. %* | wt. %* | (g/m²)* | (μm)** | (g/m²)** | (kPa)** |
| 1 | 100 | 0 | 0 | 39.6 | 17.8 | 191.5 | 0.7 |
| 2 | 50 | 0 | 50 | 36.0 | 16 | 172.2 | 0.9 |
| 3 | 50 | 50 | 0 | 38.9 | 10.1 | 199 | 2.9 |
| 4 | 67 | 17 | 17 | 39.2 | 13.8 | 187.2 | 1.0 |
| 5 | 17 | 17 | 67 | 34.8 | 13.4 | 191.7 | 1.4 |
| 6 | 17 | 67 | 17 | 37.6 | 8.8 | 187.9 | 3.2 |
| 7 | 33 | 33 | 33 | 22.6 | 11.2 | 203.8 | 1.8 |

*Values refer to those for main filtration layer only
**Values refer to those for the overall composite including the pre-filter layer and main filtration layer

This example shows that the micron rating for beta 200 efficiency for composite filter media containing a blend of glass fibers and polymeric staple fibers (i.e., media 2-7) was lower by about 10% to 50% compared to a composite filter media including a pre-filter containing two glass fiber layers and a main filtration layer that contained only glass fibers (i.e., media 1). A lower micron rating means that the main filtration layers containing a blend of glass fibers and polymeric staple fibers were able to trap smaller particles, e.g., compared to the main filtration layer in media 1. For example, media 6 was 99.5% efficient for trapping 8.8 micron-sized or larger particles, whereas media 1 was 99.5% efficient for only 17.8 micron-sized or larger particles. The efficiency for trapping particles smaller than 17.8 microns would be lower than 99.5% in media 1. All composite media had similar dust holding capacity values and basis weights.

### Example 2

This example shows that a composite filter media including a pre-filter containing two glass fiber layers and a main filtration layer formed of a blend of glass fibers and polymeric staple fibers having a diameter of less than 1 micron and/or between 1-3 microns had a lower micron rating for beta 200 efficiency and a similar dust holding capacity compared to a composite filter media including a main filtration layer that contained only glass fibers.

Main filtration layers containing glass fibers and polymeric staple fibers were formed using the method described in Example 1, except polymeric staple fibers having a diameter of less than 1 micron and a length of about 40 microns were used in some main filtration layers in the amounts specified in Table 2. Pre-filter layers were formed using the method described in Example 1, and collated to the main filtration layer.

The dust holding capacity, pressure drop, and efficiency of the overall composite including the pre-filter layer and main filtration layer are shown in Table 2. The dust holding capacity and efficiency of composite media were measured using the methods described in Example 1.

The weight percentage of glass and polymeric staple fibers and basis weight for the main filtration layers are also shown in Table 2.

TABLE 2
Structural and performance characteristics of composite filter media

| | | | | | Micron | | |
|---|---|---|---|---|---|---|---|
| | | Poly- | Poly- | | rating | | |
| | | meric | meric | | for Beta | | Clean |
| | | Staple | Staple | | 200 | | Flat |
| | Glass | Fibers* | Fibers* | Basis | efficien- | | sheet |
| | Fibers* | (1-3 μm) | (<1 μm) | weight* | cy** | DHC** | DP** |
| Media | wt. % | wt. % | wt. % | (g/m²) | (μm) | (g/m²) | (kPa) |
| 1 | 100 | 0 | 0 | 39.6 | 17.8 | 191.5 | 0.7 |
| 8 | 75 | 0 | 25 | 40.0 | 8.6 | 168 | 5.1 |
| 9 | 75 | 25 | 0 | 42.0 | 11.2 | 193 | 2.2 |
| 10 | 80 | 10 | 10 | 40.0 | 12.0 | 189 | 2.2 |
| 11 | 75 | 12.5 | 12.5 | 37.0 | 12.2 | 193 | 2.5 |
| 12 | 80 | 20 | 0 | 41.0 | 12.5 | 195 | L6 |

*Values refer to those for main filtration layer only
**Values refer to those for the overall composite including the pre-filter layer and main filtration layer

This example shows that composite filter media including a pre-filter containing two glass fiber layers and a main filtration layer formed of a blend of glass fibers and polymeric staple fiber having a diameter of less than 1 micron and/or between 1-3 microns (e.g., media 8-12) had a lower micron rating for beta 200 efficiency and similar dust holding capacity compared composite filter media including pre-filter containing two glass fiber layers and a main filtration layer of similar basis weight that contained glass only (e.g., media 1).

Additionally, composite media having a main filtration layer containing glass fibers and polymeric staple fibers having a diameter of less than 1 micron (e.g., media webs 8, 10, 11) had a lower micron rating for beta 200 efficiency than composite media having a main filtration layer containing only glass fibers (e.g., media 1) and composite media having a main filtration layer containing glass fibers and staple fibers having a diameter between 1-3 microns (e.g., media 9, 12). The most dramatic difference was observed with media 8, which showed a micron rating for beta 200 efficiency that was lower by about 52% compared to a composite media having a main filtration layer that contained only glass fibers (i.e., media 1).

### Example 3

This example shows that a composite filter media including a pre-filter containing two glass fiber layers and a main filtration layer formed of a blend of glass fibers and polymeric staple fiber had a higher dust holding capacity and similar low micron rating for beta 200 efficiency and pressure drop, compared to a composite filter media including a pre-filter containing two glass fiber layers and a main filtration layer formed of meltblown fibers.

The pre-filter contained two layers (e.g., primary layer and a secondary layer) formed by a wet laid papermaking process as described in Example 1.

The main filtration layers in media 13-17 were formed of a blend of glass fibers and polymeric staple fiber in the amounts specified in Table 3 using the wet laid papermaking process described in Example 1 for the pre-filter, except only one layer was formed. Some filter media were sprayed with 5% Hycar 26120 binder resin saturant to add binder. The glass fibers and 1-3 micron polyester staple fibers described in Example 1 were used to form the main filtration layer.

The main filtration layer in media 18 was formed by forming meltblown fibers on a scrim. The meltblown fibers had an average diameter of 1.5 microns. The meltblown fibers formed a layer having a basis weight of about 21 g/m². The scrim had a basis weight of 15 g/m².

The weight percentage of glass and polymeric staple fibers and basis weight in the main filtration layers are also shown in Table 3. The dust holding capacity, pressure drop, and efficiency of the overall composites including the pre-filter layer and main filtration layer are also shown in Table 3. These values were measured according to the methods described in Example 1.

TABLE 3
Structural and performance characteristics of filter media

| | | Poly- | | | Micron | | |
|---|---|---|---|---|---|---|---|
| | | meric | | | rating | | Clean |
| | | Staple | Basis | | for | | Flat |
| | Glass | Fibers* | weight | | Beta | | sheet |
| | Fibers | (1-3 μm) | (lb/ | Binder | 200 | DHC | DP |
| Media | wt. %* | wt. % | ream)* | Resin | (μm)** | (g/m²)** | (kPa)** |
| 13 | 80 | 20 | 46.1 | Yes | 12.6 | 201 | 1.8 |
| 14 | 70 | 30 | 45.1 | Yes | 11.8 | 199 | 2.2 |
| 15 | 75 | 25 | 46.1 | Yes | 12.1 | 206 | 1.9 |
| 16 | 80 | 20 | 43.0 | No | 12.6 | 196 | 1.8 |
| 17 | 75 | 25 | 43.0 | No | 12.3 | 193 | 1.9 |
| 18 | 0 | 0 | 38 | | 11.5 | 150 | 2.0 |

*Values refer to those for main filtration layer only
**Values refer to those for the overall composite including the pre-filter layer and main filtration layer

This example shows that composite filter media including a pre-filter containing two glass fiber layers and a main filtration layer comprising a blend of glass fibers and polymeric staple fibers (e.g., media 13-17) had comparable micron ratings for beta 200 efficiency and pressure drop compared to a composite media of similar basis weight but having a meltblown main filtration layer (e.g., media 18). The dust holding capacities of media 13-17 were higher than the dust holding capacity of media 18.

Having thus described several aspects of at least one embodiment of this invention, it is to be appreciated various alterations, modifications, and improvements will readily occur to those skilled in the art. Such alterations, modifications, and improvements are intended to be part of this disclosure, and are intended to be within the spirit and scope of the invention. Accordingly, the foregoing description and drawings are by way of example only.

What is claimed is:

1. A filter media comprising:
a first layer;
a second layer comprising glass fibers and polymeric staple fibers,
wherein the polymeric staple fibers have an average fiber diameter of less than or equal to about 10 microns,
wherein the glass fibers are present in the second layer in an amount of at least about 0.5 wt % to about 99.5 wt % of the fibers in the second layer,
wherein the polymeric staple fibers are present in the second layer in an amount of at least about 0.5 wt % to about 99.5 wt % of the fibers in the second layer, and
wherein the first layer has a mean flow pore size greater than a mean flow pore size of the second layer; and
a third layer having a mean flow pore size that is less than a mean flow pore size of the second layer.

2. A filter media comprising:
a non-woven layer comprising a blend of glass fibers and polymeric staple fibers,
wherein the polymeric staple fibers have an average fiber diameter of less than or equal to about 6 microns; and
a layer having a mean flow pore size that is less than a mean flow pore size of the non-woven layer.

3. A filter media comprising:
a non-woven layer comprising a blend of glass fibers and polymeric staple fibers, wherein the polymeric staple fibers have an average fiber diameter of less than or equal to about 10 microns, and wherein the polymeric staple fibers are present in an amount of greater than or equal to about 10 wt % of the fibers in the non-woven layer; and
a layer having a mean flow pore size that is less than a mean flow pore size of the non-woven layer.

4. The filter media of claim 1, wherein the polymeric staple fibers have an average fiber diameter of less than or equal to about 6 microns.

5. The filter media of claim 1, wherein the first layer comprises glass fibers.

6. The filter media of claim 1, wherein the polymeric staple fibers have an average length of less than or equal to about 500 microns.

7. The filter media of claim 1, wherein the first layer is a non-wet laid layer.

8. The filter media of claim 1, wherein the first layer is a wet laid layer.

9. The filter media of claim 1, wherein the first layer comprises meltblown fibers, melt spun fibers, and/or centrifugal spun fibers.

10. The filter media of claim 1, wherein the polymeric staple fibers are present in the second layer in an amount of at least about 10 wt %.

11. The filter media of claim 1, wherein the filter media has a dust holding capacity of between about 5 gsm and about 300 gsm measured according to standard ISO 19438 (2003).

12. The filter media of claim 1, wherein the filter media has an average particulate efficiency and/or initial efficiency of greater than or equal to about 99% measured according to standard ISO 19438 (2003).

13. The filter media of claim 1, wherein the glass fibers in the second layer have an average diameter of less than or equal to about 11 microns.

14. The filter media of claim 1, wherein the second layer has a mean flow pore size of between about 0.1 microns and about 10 microns.

15. The filter media of claim 1, wherein the filter media has a basis weight of less than or equal to about 600 gsm.

16. The filter media of claim 1, comprising a layer comprising glass fibers positioned between the first and second layers.

17. A filter media as in claim 1, wherein at least one of the first layer and the second layer comprises at least about 80 wt % glass fibers.

18. A fuel filter element comprising the filter media of claim 1.

19. The filter media of claim 1, wherein the third layer has a basis weight of between 5 g/m² and 1,000 g/m² and a dry Mullen burst strength between 0.5 psi and 200 psi.

20. The filter media of claim 1, wherein the second layer is upstream of the third layer.

21. The filter media of claim 1, wherein the entire filter media is modified to be hydrophilic or hydrophobic.

22. The filter media of claim 1, wherein at least one layer of the filter media is impregnated in a resin.

23. The filter media of claim 1, wherein the filter media has a fuel:water separation efficiency of greater than or equal to about 20%.

24. The filter media of claim 1, wherein the second layer is modified to be hydrophobic or hydrophilic.
